(19) United States
(12) Patent Application Publication
(10) Pub. No.: US 2007/0231671 A1
(43) Pub. Date: Oct. 4, 2007

(54) Catalyst Material For Use In Fuel Cell, Catalyst Membrane, Membrane Electrode Assembly and Fuel Cell

(75) Inventors: Takeshi Inasaki, Kanagawa (JP); Kimiatsu Nomura, Kanagawa (JP)

Correspondence Address: BRINKS HOFER GILSON & LIONE, P.O. BOX 10395, CHICAGO, IL, 60610, US

(73) Assignee: FUJIFILM Corporation

(21) Appl. No.: 11/689,799

(22) Filed: Mar. 22, 2007

(30) Foreign Application Priority Data
Mar. 24, 2006 (JP) 084041/2006

(51) Int. Cl. H01M 4/00; H01M 4/88; H01M 4/86; H01M 4/96; H01M 4/90

(52) U.S. Cl. 429/40; 502/101

(57) ABSTRACT

A catalyst for a fuel cell comprising one or more hydrophilic segments and one or more hydrophobic segments jointly or separately connected to the surface of the carbon material by a single bond or a connection group having a solvolysis resistance and a heat resistance on a surface of a carbon material, wherein the hydrophilic segment has the solvolysis resistance and the heat resistance and has an ionic functional group, and the hydrophobic segment has the solvolysis resistance and the heat resistance and has no ionic functional group.

### BACKGROUND OF THE INVENTION

1. Field of the Invention

The present invention concerns a fuel cell directly using, as a fuel, pure hydrogen, methanol, ethanol, dimethylether, methanol or reformed hydrogen from fossil fuels and using air or oxygen as an oxidizing agent and it particularly relates to a catalyst material, a membrane electrode assembly, and a fuel cell used in a solid polymer fuel cell.

2. Description of the Related Art

A solid polymer fuel cell is a fuel cell having a feature in that an ion conductor, that is, an electrolyte is a solid and polymeric material, in which an ion exchange resin is used specifically as a solid polymer electrolyte, both negative electrode and positive electrode are disposed sandwiching the electrolyte therebetween, and electrochemical reaction is taken place by supplying, for example, hydrogen as a fuel to the negative electrode and oxygen or air to the positive electrode to generate electric power.

That is, in a case of using hydrogen as a fuel, the following reaction is taken place on the negative electrode:
H₂→2H⁺+2e⁻

Further, in a case of using oxygen as an oxidizing agent, the following reaction is taken place on the positive electrode to form water.
½O₂+2H⁺+2e⁻→H₂O

For proceeding the reaction smoothly and attaining the performance of the fuel cell to an utmost degree, it is necessary that a catalyst (platinum, etc.) is present at the three phase boundary where an ion exchange resin as the proton conductor, a carbon support as an electron conductor, and a reaction gas are in contact with each other in the electrode catalyst membrane. For this purpose, it has been attempted to improve the function of the catalyst membrane structure thereby Increasing the amount of the catalyst present at the three phase boundary.

As such an attempt, methods of effectively utilizing catalyst particles present in pores of small size (for example, with a diameter of 0.04 μm or less) in which intrusion of the solid polymer electrolyte is difficult have been studied variously. For example, it has been disclosed a method of grafting a sulfonic acid portion or a sulfonic acid group comprising polymer on the surface of a carbon black as a catalyst carrier thereby introducing a proton conduction portion also in the primary pore to form a three phase boundary to the catalyst particle in the primary pore (refer to JP-A No. 2004-22346 and Journal of Power Sources Vol 138, p 25 (2004)). However, when the inventors have studied on those described in the examples of JP-A No. 2004-22346, it has been found that the sulfonic acid group introduced by the methods of preparation 1, 2 and 5 for the carbon material is instable to heat and involves a problem of dissociation with lapse of time and the sulfonic acid group introduced by the methods of preparation 3 and 5 for the carbon material involves a problem that the sulfonic acid group portion is dissociated with lapse of time due to solvolysis of an ester groups since the ester bond is contained at a connection portion with a carbon black. Further, in the Journal of Power Sources, when a great amount of sulfonic acid group comprising polymer is introduced, the permeability of the reaction gas is lowered to result in a problem that the performance is deteriorated in a high current density region.

### SUMMERY OF THE INVENTION

The present invention has an aim of improving the utilization efficiency of catalyst particles, improving the permeability of a reaction gas near catalyst particles and preventing flooding of a catalyst membrane and it intends to provide a catalyst material for use in a fuel cell having high durability and activity (particularly, catalyst material for use in a fuel cell electrode), as well as provide a membrane electrode assembly and a fuel cell using the electrode.

The present inventors have made an earnest study and, as a result, have found that the foregoing subject can be solved by the means described below to accomplish the present invention.
(1) A catalyst material for use in a fuel cell comprising;

a carbon material, and

one or more hydrophilic segments and one or more hydrophobic segments jointly or separately connected to the surface of the carbon material by a single bond or a connection group having a solvolysis resistance and a heat resistance, wherein:

the hydrophilic segment has the solvolysis resistance and the heat resistance and has an ionic functional group, and

the hydrophobic segment has the solvolysis resistance and the heat resistance and has no ionic functional group.
(2) The catalyst material for use in a fuel cell according to (1), wherein the hydrophilic segment comprises one or more structures represented by the following formula (1), formula (6) or formula (10) , and the hydrophobic segment comprises one or more structures represented by the following formula (2), formula (7) or formula (11): 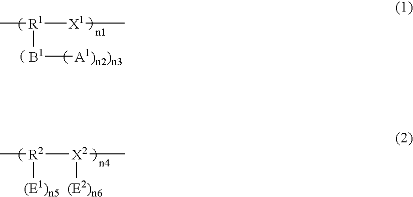
   in the formula (1) and the formula (2), R¹ and R² each represents a group comprising an aromatic ring, X¹ and X² each represents a single bond or a bivalent connection group, B¹ represents a single bond or a bivalent to hexavalent connection group, A¹ represents an ionic functional group, E¹ and E² each represents a substituent of high oxygen permeability, n1 and n4 each represents an integer of 8 or greater, n2 represents an integer of from 1 to 5, n3, n5 and n6 each represents an integer of from 0 to 4, 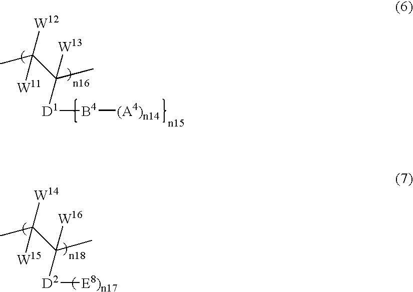
   in the formula (6) and the formula (7), wherein W¹¹, W¹², W¹³ W¹⁴, W¹⁵, and W¹⁶ each represents a hydrogen atom, halogen atom, alkyl group, aryl group, or heterocyclic ring, D¹ and D² each represents a single bond or a group comprising a substituted or not-substituted aromatic ring, B⁴ represents a single bond or a bivalent to hexavalent connection group, A⁴ represents an ionic functional group. E⁶ each represents a substituent of high oxygen permeability, n16 and n18 each represents an integer of 2 or greater, and n14, n15, and n17 each represents an integer of from 1 to 5, 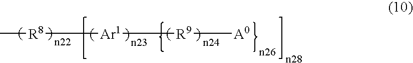
   in the formula (10), R⁸ and R⁹ each represents a bivalent to tetravalent connection group, Ar¹ represents a bivalent to hexavalent connection group comprising an aromatic hydrocarbon group or a heterocyclic group, A⁶ represents an ionic functional group, n22, n23, and n24 each represents an integer of 0 or greater, the sum for n22, n23, and n24 represents an integer of 1 or greater, n25 represents an integer of from 1 to 10 and n26 represents an integer of from 1 to 3, 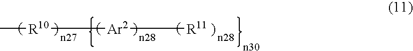
   in the formula (11), R¹⁰ each represents a bivalent to tetravalent connection group, R¹¹ represents a monovalent group not comprising an aromatic ring, Ar² represents a bivalent to hexavalent connection group comprising an aromatic hydrocarbon group or heterocyclic group, n27 and n28 each represents an integer of 0 or greater, n29 represents an integer oft or greater, and n30 represents an integer of from 1 to 3.
(3) A catalyst material for use in a fuel cell according to (1) or (2) above, wherein the carbon material is a carbon black or carbon nanotube.
(4) A catalyst material for use in a fuel cell according to any one of (1) to (3) above, wherein the hydrophilic segment and the hydrophobic segment are connected by way of an identical connection group.
(5) A catalyst material for use in a fuel cell according to any one of (1) to (4) above, wherein the hydrophilic segment and hydrophobic segment form as an alternately repeating block copolymer that is connected to the surface of the carbon material.
(6) A catalyst material for use in a fuel cell according to (4) or (5) above, wherein the hydrophilic segment comprises a structure represented by the following formula (1) and the hydrophobic segment comprises a structure represented by the following formula (2): 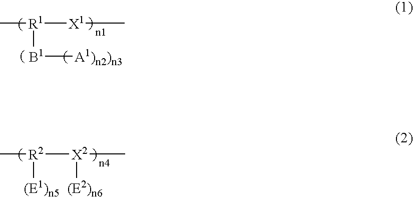
   in the formula (1) and the formula (2), R¹ and R² each represents a group comprising an aromatic ring, X¹ and X² each represents a single bond or a bivalent connection group, B¹ represents a single bond or a bivalent to hexavalent connection group, A¹ represents an ionic functional group, E¹ and E² each represents a substituent of high oxygen permeability, n1 and n4 each represents an integer of 8 or greater, n2 represents an integer of from 1 to 5, n3, n5 and n6 each represents an integer of from 0 to 4.
(7) A method of manufacturing a catalyst material for use in a fuel cell according to (6) above, comprising forming the main chain structure represented by —(R¹—X¹)ₙ₁— and then bonding the group represented by —B¹-(A¹)ₙ₂ to the main chain structure, and forming the main chain structure represented by —(R²—X²)ₙ₄— and then bonding the group represented by -E¹ and/or -E² to the main chain structure.
(8) A method of manufacturing a catalyst material for use in a fuel cell according to (6) above, comprising polymerizing a compound represented by the formula (3) and a compound represented by the formula (4), and polymerizing the compound represented by the formula (4) and the compound represented by the formula (5): 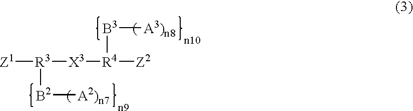
   in the formula (3), X³ represents a single bond or a bivalent connection group, R³ and R⁴ each represents a group comprising an aromatic ring, B² and B³ each represents a single bond or a bivalent to hexavalent connection group, A² and A³ each represents an ionic functional group, n7 and n8 each represents an integer of from 1 to 5, n9 and n10 each represents an integer of from 0 to 4, the sum for n9 and n10 is 2 or greater, Z¹ and Z² each represents a hydroxyl group, halogen group, alkyl sulfonate group, or nitro group,
   Z³-R⁵-Z⁴ (4)
   in the formula (4), Z³ and Z⁴ each represents a hydroxyl group, halogen group, alkyl sulfonate group, nitro group, and R⁵ represents a group comprising an aromatic ring, 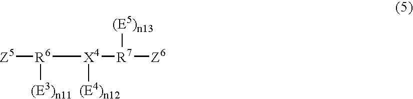
   in the formula (5), X⁴ represents a single bond or a bivalent connection group, R⁶ and R⁷ each represents a group comprising an aromatic ring, E³, E⁴, and E⁵ each represents a substituent of high oxygen permeability, n11, n12, and n13 each represents an integer of from 0 to 4, the sum for n11, n12, and n13 is 1 or greater, Z⁵ and Z⁶ each represents a hydroxyl group, halogen group, alkyl sulfonate group, or nitro group.
(9) A catalyst material for use in a fuel cell according to (4) or (5) above, wherein the hydrophilic segment comprises a structure represented by the following formula (6) and the hydrophobic segment comprises a structure represented by the following formula (7): 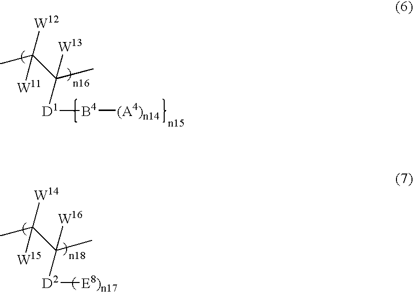
   in the formula (6) and the formula (7), W¹¹, W¹², W¹³, W¹⁴, W¹⁵, and W¹⁶ each represents a hydrogen atom, halogen atom, alkyl group, aryl group, or heterocyclic ring. D¹ and D² each represents a single bond or a group comprising a substituted or not-substituted aromatic ring, B⁴ represents a single bond or a bivalent to hexavalent connection group, A⁴ represents an ionic functional group. E⁶ each represents a substituent of high oxygen permeability, n16 and n18 each represents an integer of 2 or greater, and n14, n15, and n17 each represents an integer of from 1 to 5.
(10) A method of manufacturing a catalyst material for use in a fuel cell according to (9) above, comprising polymerizing the compound represented by the formula (8) and polymerizing a compound represented by the formula (9): 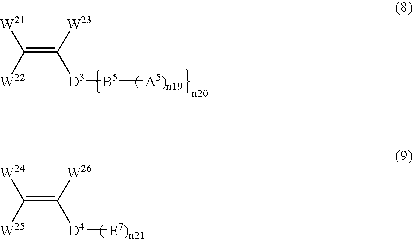
   in the formula (8) and the formula (9), W²¹, W²², W²³, W²⁴, W²⁵, and W²⁶ each represents a hydrogen atom, halogen atom, alkyl group, aryl group, or heterocyclic ring. D³ and D⁴ each represents a single bond or a group comprising a substituted or not substituted aromatic ring, B⁵ represents a single bond or a bivalent to hexavalent connection group, A⁵ represents an ionic functional group or an ionic functional group precursor, E⁷ represents a substituent of high oxygen permeability. n19, n20, and n21 each represents an integer of from 1 to 5.
(11) A catalyst material for use in a fuel cell according to (4) or (5) above, wherein a side chain comprising a hydrophilic segment is grafted on a main chain comprising a hydrophobic segment.
(12) A catalyst material for use in a fuel cell according to (11) above, wherein the hydrophobic segment comprises a structure represented by the following formula (2) and the hydrophilic segment comprises a structure represented by the following formula (6): 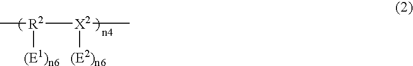
   in the formula (2), R² represents a group comprising an aromatic ring, X² represents a single bond or a bivalent connection group, E¹ and E² each represents a substituent of high oxygen permeability. n4 represents an integer of 8 or greater, and n5 and n6 each represents an integer of from 0 to 4, 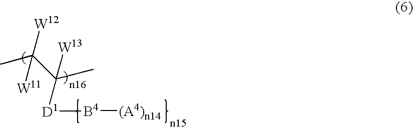
   in the formula (6), W¹¹, W¹², and W¹³ each represents a hydrogen atom, halogen atom, alkyl group, aryl group or heterocyclic ring, D¹ represents a single bond or a group comprising a substituted or not-substituted aromatic ring, B⁴ represents a single bond or a bivalent to hexavalent connection group, A⁴ represents an ionic functional group, n16 represents an integer of 2 or greater, and n14 and n15 each represents an integer of from 1 to 5.
(13) A method of manufacturing a catalyst material for use in a fuel cell according to (12) above, comprising chloromethylating the aromatic ring possessed by the main chain structure represented by —(R²—X²)ₙ₄— in the formula (2), and graft polymerizing at least the compound represented by the formula (8) with the chloromethylated portion being as a polymerization initiation point: 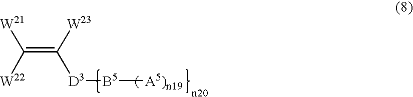
   in the formula (8), W²¹, W²², and W²³ each represents a hydrogen atom, halogen atom, alkyl group, aryl group, or a heterocyclic ring, D³ represents a single bond or a group comprising a substituted or not-substituted aromatic ring, B⁵ represents a single bond or a bivalent or hexavalent connection group, A⁵ represents an ionic functional group or an ionic functional group precursor, and n19 and n20 each represents an integer of 1 to 5.
(14) A catalyst material for use in a fuel cell according to (4) or (5) above wherein a side chain comprising a hydrophobic segment is grafted on a main chain comprising a hydrophilic segment.
(15) A catalyst material for use in a fuel cell according to (14) above, wherein the hydrophilic segment comprises a structure represented by the following formula (1) and the hydrophobic segment comprises a structure represented by the following formula (7): 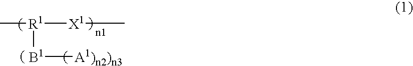
   in which R¹ represents a group comprising an aromatic ring, X¹ represents a single bond or a bivalent connection group, B¹ represents a single bond or a bivalent to hexavalent connection group, A¹ represents an ionic functional group, n1 represents an integer of 8 or greater, n2 represents an integer of from 1 to 5, and n3 represents an integer of from 0 to 4, 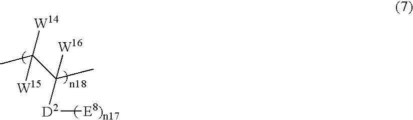
   in the formula (7), W¹⁴, W¹⁵, and W¹⁶ each represents a hydrogen atom, halogen atom, alkyl group, aryl group, or a heterocyclic ring. D² represents a single bond or a group comprising a substituted or not-substituted aromatic ring. E⁶ each represents a substituent of high oxygen permeability, n18 represents an integer of 2 or greater, and n17 represents an integer of from 1 to 5.
(16) A method of manufacturing a catalyst material for use in a fuel cell according to (15) above, comprising chloromethylating the aromatic ring possessed by the main chain structure represented by —(R¹—X¹)ₙ₁— in the formula (1), and graft polymerizing at least the compound represented by the formula (9) with the chloromethylated portion being as a polymerization initiation point: 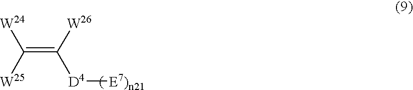
   in the formula (9), W²⁴, W²⁵, and W²⁶ each represents a hydrogen atom, a halogen atom, alkyl group, aryl group, or a heterocyclic ring, D⁴ represents a single bond or a group comprising a substituted or not-substituted aromatic ring, E⁷ represents a substituent of high oxygen permeability and n21 represents an integer of from 1 to 5.
(17) A catalyst material for use in a fuel cell according to any one of (1) to (3) above, wherein the hydrophilic segment and the hydrophobic segment are connected respectively by way of different connection groups to the surface of the carbon material.
(18) A catalyst membrane comprising a catalyst material for use in a fuel cell according to any one of (1) to (6), (9), (11), (12), (14), (15), and (17), and a solid electrolyte.
(19) A catalyst membrane according to (18) above, further comprising a catalyst material for use in a fuel cell having neither the hydrophilic segment nor the hydrophobic segment on the carbon surface.
(20) A membrane electrode assembly comprising a porous conductive sheet and a catalyst layer disposed in contact with the porous conductive sheet wherein the catalyst layer is a catalyst membrane according to (18) or (19).
(21) A fuel cell comprising the membrane electrode assembly according to (20) above.

The catalyst material for use in the fuel cell of the invention has a high catalyst activity and a high durability which are compatible to each other. Thus, the membrane electrode assembly can be manufactured easily making it possible to manufacture a fuel cell having a high performance.

### BRIEF DESCRIPTION OF THE DRAWINGS

FIG. 1 is a schematic cross sectional view showing the constitution of a catalyst membrane electrode assembly (MEA) using a polymer electrolyte of the invention; and

FIG. 2 is a schematic cross sectional view showing an example of a structure of a fuel cell of the invention.

### BEST MODE FOR CARRYING OUT THE INVENTION

The present invention is to be described specifically. In the present specification, “ . . . to . . . ” It is used in the meanings including numerical values described before and after thereof as a lower limit value and an upper limit value.

Various physical property values in the invention show those in the state at a room temperature (for example, 25° C.) unless otherwise specified. Further, polymerization in the invention includes also so-called copolymerization. Accordingly, a polymer referred to in the invention includes also a copolymer. Further, in the present specification, abbreviations are sometimes used as Ac for acetyl group, Ft for ethyl group, Me for methyl group, and Ph for phenyl group or phenylene group.

In addition, “membrane” in the invention includes those of plate shape or flat-plate shape.

The electrode catalyst material for use in the fuel cell of the invention includes a carbon material and one or more hydrophilic segments and one or more hydrophobic segments jointly or separately connected to the surface of the carbon material by a single bond or a connection group having a solvolysis resistance and a heat resistance in which the hydrophilic segment has a solvolysis resistance and a heat resistance and has an ionic functional group, and the hydrophobic segment has solvolysis resistance and heat resistance and has no ionic functional group. The hydrophilic segments and the hydrophobic segments may be joined and connected by way of a single bond or an identical connection group. The hydrophilic segments and the hydrophobic segments may be separately connected by way of a single bond or different connection groups. Cases where they are connected by way of the identical connection group include, for example, a case in which a block copolymer comprising hydrophilic segments and hydrophobic segments alternating repetitively is connected by way of a connection group to a carbon material as in the following type 1-1:

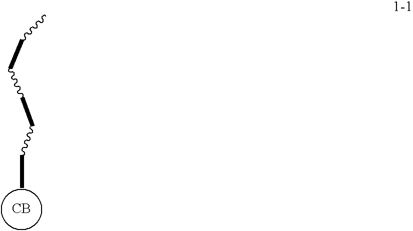

a case in which a main chain comprising hydrophobic segments grafted with hydrophilic segments as side chains is connected by way of a connection group to a carbon material as in the following type 1-2:

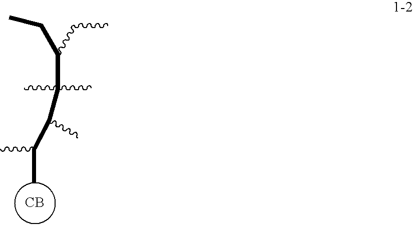

a case in which a main chain comprising hydrophilic segments grafted with hydrophobic segments as side chains is connected by way of a connection group to a carbon material as in the following type 1-3:

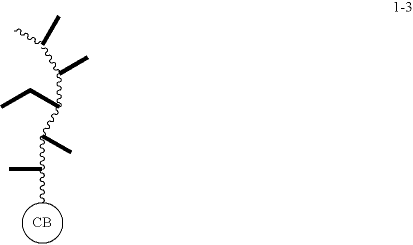

CB represents the carbon material, fat solid lines represent hydrophobic segments, and wave lines represent hydrophilic segments, with the connection group being omitted.

Further, the cases in which the hydrophilic segments and the hydrophobic segments are joined also include a case in which they are connected directly to the surface of the carbon material not by way of the connection group in the type 1-1 to the type 1-3. A case in which they are connected not by way of the connection group, the carbon material, the hydrophilic segment, or the hydrophobic segment contains a portion corresponding to the connection group at the connection portion. That is, the connection group may also serve as a portion of the carbon material, the hydrophilic segment or the hydrophobic segment (such portions are sometimes referred to inclusively as a connection group).

Further, those in which the portion comprising the hydrophilic segment and the hydrophobic segment of the type 1-1 to the type 1-3 is connected in plurality to the surface of the carbon material are also included in the example where they are jointly connected by way of a single bond or the connection group.

On the other hand, cases where they are connected by way of different connection groups also include a case where the hydrophilic segments and the hydrophobic segments are connected with the carbon material by way of the connection groups as represented by the following type 2.

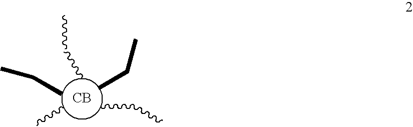

Further, a case in which they are separately connected by a single bond include a case in which they are directly connected to the surface of the carbon material not by way of the connection groups in the above type 2.

The connection group having the solvolysis resistance means a group not comprising easily solvolyzable bond under high temperature and strongly acidic condition under actual working circumstance of a fuel cell (for example, solvolyzed by 10% or more under the condition at 100° C., pH 2 or less) and, more specifically, those groups not comprising ester bond, amide bond, or siloxane bond. The connection group having the solvolysis resistance described above includes, those groups, for example, aliphatic hydrocarbon groups, aromatic hydrocarbon groups, heterocyclic groups, and those groups comprising one or a combination of two or more members selected from the group consisting of:

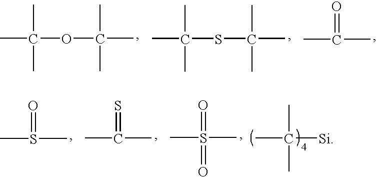

The aliphatic hydrocarbon group may be of a saturated hydrocarbon or unsaturated hydrocarbon, or may be any of linear, branched or cyclic hydrocarbon. Further, a hydrogen atom may be substituted by a substituent (for example, halogen atom, preferably, fluorine atom, etc.) within a range not departing the gist of the invention. The number of carbon atoms of the aliphatic hydrocarbon group is, preferably, from 1 to 12 and, more preferably, from 1 to 6. Preferred aliphatic hydrocarbon groups are, specifically, methylene group, ethylene group, propylene group, butylene group, hexylene group, octylene group, decylene group, isobutylene group, —(CH₂)ₙCH═CH— (where n is an integer of 1 or greater and, preferably, an integer of from 1 to 6), —CH₂CH₂CH═CH—, C((CH₂)ₙ—)₄ (where n is an inter of 1 or greater and, preferably, an integer of from 1 to 6), CH((CH₂)ₙ—)₃ (where n is each an integer of from 1 or greater, preferably, an integer of from 1 to 6, CH₃C((CH₂)ₙ—)₃ (where n is an integer of 1 or greater and, preferably, an integer of from 1 to 6), EtC (CH₂)ₙ—)₃ (where n is an integer of 1 or greater and, preferably, an integer of from 1 to 6). Et represents an ethyl group (here and hereinafter)), —C((CH₂)ₙ—)₃ (where n is an integer of 1 or greater and preferably, an integer of from 1 to 6), —CH((CH₂)ₙ—)₂— (where n is an integer of 1 or greater and, preferably, an integer of from 1 to 6).

The number of carbon atoms of the aromatic hydrocarbon group is, preferably, from 6 to 25, more preferably, from 6 to 16 and, further preferably, from 6 to 12. The hydrogen atom on the ring of the aromatic hydrocarbon group may be substituted by a substituent (for example, halogen atom and, preferably, fluorine atom) within a range not departing from the gist of the invention. As the aromatic hydrocarbon group, those groups comprising triphenylene ring, pyrene ring, anthracene ring, naphthalene ring, biphenylene ring, and benzene ring are preferred and those groups comprising the naphthalene ring, biphenylene ring, and benzene ring are more preferred, and those groups comprising the benzene ring are further preferred.

As the heterocyclic group, those comprising any of sulfur atom, nitrogen atom, and oxygen atom are preferred and those comprising the sulfur atom or nitrogen atom are more preferred. Further, the number of carbon atoms of the heterocyclic group is, preferably, from 3 to 16 and, more preferably, from 3 to 12. The hydrogen atom on the ring of the heterocyclic group may be substituted by a substituent, (for example, halogen atom, preferably, fluorine atom) within a range not departing from the gist of the invention. As the heterocyclic group, specifically, those groups comprising a pyridine ring, furan ring, or thiethene ring and triazine ring are preferred and groups comprising the triazine ring are more preferred.

Preferred examples of the group having the solvolysis resistance include methylene group, ethylene group, propylene group, butylenes group, hexylene group, octylene group, decylene group, phenylene (-Ph-)group, —CH₂—O—(CH₂)ₙ— (where n is an integer of 1 or greater and, preferably, an integer of 1 to 6). —CH₂-Ph-, —CH₂CH₂OCH₂CH₂—, —(CH₂CH₂O)₂CH₂CH₂—, —CH₂CH═CH—, —CH₂CH₂CH═CH—, C((CH₂)ₙ—)₄ (where n is an integer of 1 or greater and, preferably, an integer of from 1 to 6), CH((CH₂)ₙ—)₃ (where n is an integer of 1 or greater, and preferably, an integer of 1 to 6), CH₃C((CH₂)ₙ—)₃ (where n is an integer of 1 or greater and, preferably, an integer of 1 co 6), EtC(CH₂)ₙ—)₃ (where n is an integer of 1 or greater and, preferably, an integer of 1 to 6), —C((CH₂)ₙ—)₃ (where n each represents an integer of 1 or greater and, preferably, each is an integer of 1 to 6), —CH(((CH₂)ₙ—)₂ (where n is an integer of 1 or greater and, preferably, an integer of 1 to 6), as well as those groups comprising combination of them (including groups comprising two or more of the group described above) and —CO—, —CO—, —CS—, —SO₂— and

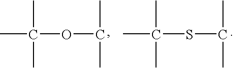

The connection group having the heat resistance means those groups which are present stably even under a high temperature condition (for example, 100° C. or higher) in the actual working circumstance of a fuel cell. For example, it has been known that, in a case where the ionic functional group is a sulfo group, when the sulfo group is bonded directly to the aromatic ring, since the sulfo group is in a dissociation equilibrium state, it dissociates with lapse of time at a high temperature (Coll. Czech. Chem. Commun. Vol. 9, 465 pp (1937)), and the single bond to the aromatic ring can not be said to have a heat resistance. Accordingly, the group having the heat resistance means herein all organic groups except for the single bond to the aromatic ring. However, it has been known that the heat resistance of the sulfo group is improved also even in a case where the sulfo group is connected by way of the single bond to the aromatic ring, when an electron attracting group is present on the aromatic ring (NEDO result Report 100004243 “Reports for the Result in Heisei 15, Development Work for the Solid Polymer Fuel Cell System Technology, Work for the Development of Technology for Solid Polymer Fuel Cell Elements, Research and Development for Highly Durable Hydrocarbon Electrolyte Membrane for Use in Solid Polymer Fuel Cell”). Accordingly, also in a case where the sulfo group is connected by way of a single bond to the aromatic ring, the sulfo group can be regarded to have the heat resistance providing that the sum for the substituent constant σ of substituents excluding the sulfo group on the aromatic ring is at a value or more. The sum for the substituent constants a for having the heat resistance, is preferably, 0.3 or more, more preferably, 0.35 or more and, most preferably, 0.4 or more. The substituent constant of the substituent situated at the ortho position to the sulfo group is substituted for the value at the para position.

Preferred examples of the connection group having the heat resistance include those preferred examples for the connection group having the solvolysis resistance described above except for the case where the ionic functional group is bonded by way of the single bond to the aromatic group (not including those satisfying the conditions regarding the substituent constant a described above).
(2) The carbon material used for the catalyst material for use in the fuel cell of the invention (catalyst-supporting carbon material) is not particularly restricted but known carbon materials can be used. For example, carbon black, carbon nanotube (CNT), carbon nanohorn (CNH) and fullerene are used preferably. Carbon black and carbon nanotube can be used particularly preferably since ionic function group can be introduced with the functional group present on the surface being as an initiation point.
   Carbon Black

The carbon black used in the invention is in the form of a fine powder formed by gas phase heat decomposition or incomplete combustion of a natural gas or hydrocarbon gas, which is spherical or chained carbon and includes depending on the manufacturing method, for example, channel black, furnace black, thermal black, and lamp black. They are different respectively in view of the particle size, oxygen content, volatile ingredient, specific surface area, fine structure, which are disclosed in Modern Carbon Black Technology Collected Works, Chapter 4, (published from Technical Information Association, 2005) . In the invention, one or more of carbon blacks described above can be used and commercial products such as ketchen black and Vulcan XC-72 can also be used.

Oxygen-containing functional groups such as phenolic hydroxyl group, carboxyl group, quinone type carbonyl group, and lactone group are present on the surface of the carbon black and hydrophilic segments and hydrophobic segments can be introduced to the surface of the carbon black by utilizing such functional groups. The number of the functional groups can be increased by applying an oxidizing treatment in addition to those present originally on the surface of the carbon black. The oxidizing method includes, for example, corona discharge, plasma treatment, gas phase oxidation, and liquid phase oxidation. It is preferred to increase the number of the functional groups on the surface of the carbon black by conducting the oxidizing treatment using one or more of the methods described above. The oxidizing agent in the gas phase oxidation includes molecular oxygen, atomic oxygen, ozone, dry air and humid air, and two or more of them may be used in combination so long as it is possible. The oxidizing agent in the liquid phase oxidation includes nitric acid, potassium permanganate, sodium salt of each of chlorous acid, chloric acid, and perchloric acid, oxygen-saturated water, aqueous ozone solution, aqueous bromine solution, an aqueous mixed solution of sodium hypochlorate, potassium chromate, and phosphoric acid, a mixture of silver dichromate and sulfuric acid.

For the carboxyl group and the lactone group on the surface of the carbon black, in the form as they are, since the hydrophilic segment and the hydrophobic segment can be introduced only by way of the ester bond or the amide bond having less heat resistance and solvolysis resistance, it is preferred to reduce them into a hydroxymethyl group and introducing the segments by utilizing the hydroxymethyl group.

Further, it has been known that the carbon black functions as a strong radical scavenger (for example, research report by N. Tsubokawa, et. al, J. Polym. Sci., Part A: Polym. Chem., Vol 36, 3165 pp (1998) et. al), and it scavenges a carbon radicals formed, for example, by heat decomposition of an azo group to form a carbon-carbon bond or carbon-oxygen bond excellent in the solvolysis resistance and the heat resistance. Accordingly, the hydrophilic segments and the hydrophobic segments can also be introduced by using such radical scavenging property.

Carbon Nanotube

The carbon nanotube used in the invention has carboxyl groups on the surface thereof and ionic functional groups can be introduced to the surface of the carbon nanotube with the carboxyl groups being as the initiation points. Further, since the number of the carboxyl groups on the surface can be increased by the oxidizing treatment, it is preferred to apply an oxidizing treatment in a case of use in the invention. As the oxidizing method, oxidizing reaction by nitric acid is used preferably.

For the carboxyl group on the surface of the carbon nanotube, in the form as they are, since the ionic functional groups can be introduced only by way of the ester bond or the amide bond having less heat resistance and solvolysis resistance, it is preferred to reduce them into a hydroxymethyl group and introduce the ionic functional group by utilizing the hydroxymethyl group.

Further, it has been known that the carbon nanotube functions as a radical scavenger (for example, research report of A. Adronov, et. al Macromolecules, Vol. 38, 1172 pp (2005)), and it scavenges carbon radicals formed, for example, by heat decomposition of an azo group to form a carbon-carbon bond or carbon-oxygen bond excellent in the solvolysis resistance and the heat resistance. Accordingly, hydrophilic segments and hydrophobic segments can also be introduced by using such radical scavenging property.

(3) Connection Portion between Carbon Material and Connection Group

The connection group connecting the carbon material and the hydrophilic segment or the hydrophobic segment has a solvolysis resistance and a heat resistance. The connection group is connected preferably by way of a carbon atom or an oxygen atom and it is preferably constituted with a chemical bond having the solvolysis resistance and the heat resistance. As the chemical bond having the solvolysis resistance and the heat resistance, carbon-carbon single bond, ether bond, thioether bond, carbon-SO₂ bond, carbon-carbon double bond, and carbon-carbon triple bond are preferred, and the carbon-carbon single bond, ether bond, thioether bond, and carbon-SO₂ bond are more preferred.

More specifically, in the case where the carbon material is a carbon black, an ether bond formed with an oxygen atom derived from a phenolic hydroxyl group present on the surface of the carbon black and a carbon atom derived from the connection group, a single bond formed with a carbon atom at the ortho position to the phenolic hydroxyl group and the carbon atom of the connection group, and an ether bond formed with the oxygen atom derived from the hydroxymethyl group obtained by reducing the carboxyl group on the carbon black and the carbon atom of the connection group are particularly preferred. In a case where the carbon material is a carbon nanotube, an ether bond formed with the oxygen atom derived from the hydroxymethyl group obtained by reducing the carboxyl group on the carbon nanotube and the carbon atom of the connection group is particularly preferred.

Further, oxygen atoms derived from the functional groups present on the surface are also present in addition to the carbon atom as the main ingredient in the carbon material. Accordingly, when the carbon material and the connection group are connected, there are two methods, that is, a method of connecting the connection group by way of the carbon atom present in the carbon material, and a method of connecting the connection group by way of the oxygen atom present in the carbon material, and any of the methods can be used preferably in the invention.

Examples of the connection groups having the solvolysis resistance and the heat resistance are shown below, but the invention is not restricted to them. Lc is a symbol indicative of a connection portion between the connection group and the carbon material but no actual group is present. In the same manner, Lp is a symbol indicative of a connection portion between the connection group and the hydrophilic segment and/or hydrophobic segment at which no actual group is present. Further, the connection group may be contained only by one kind, or two or more of the group may be contained in the catalyst material for use in the fuel cell of the invention. 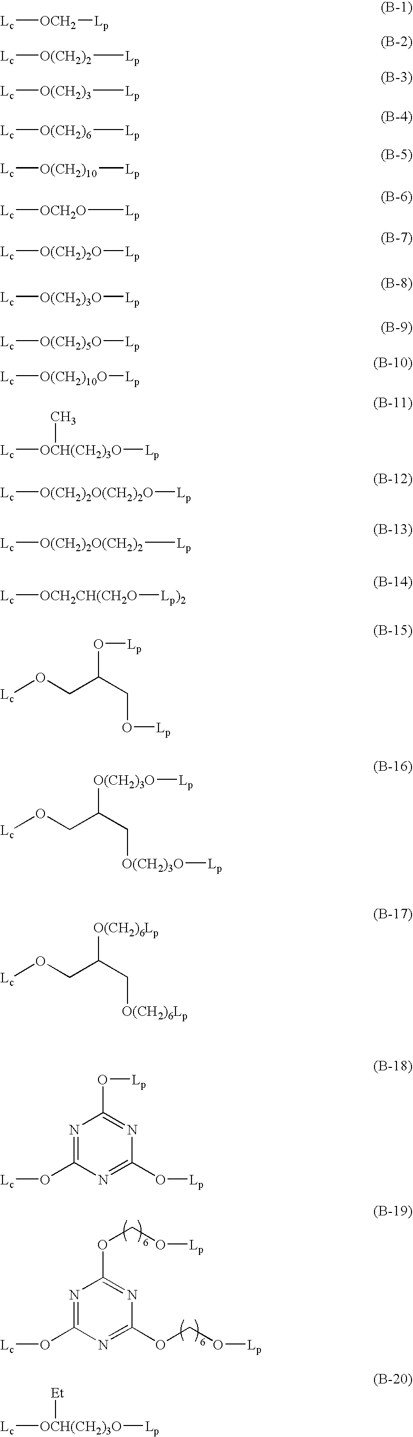 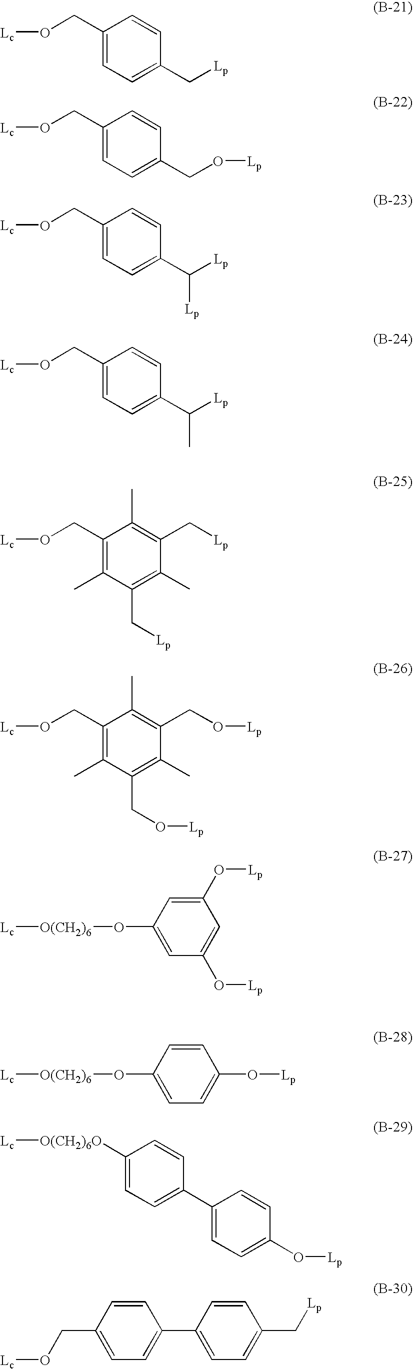 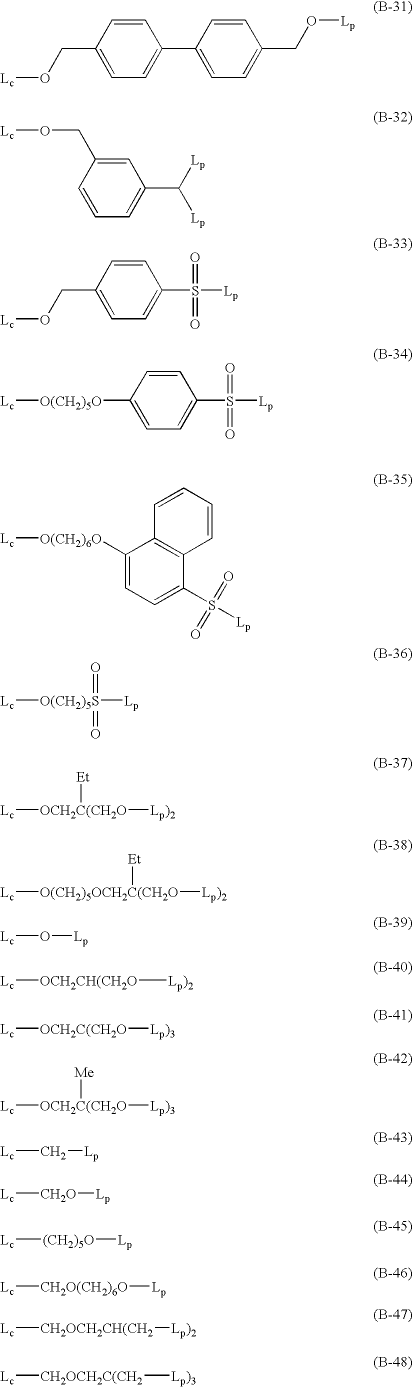 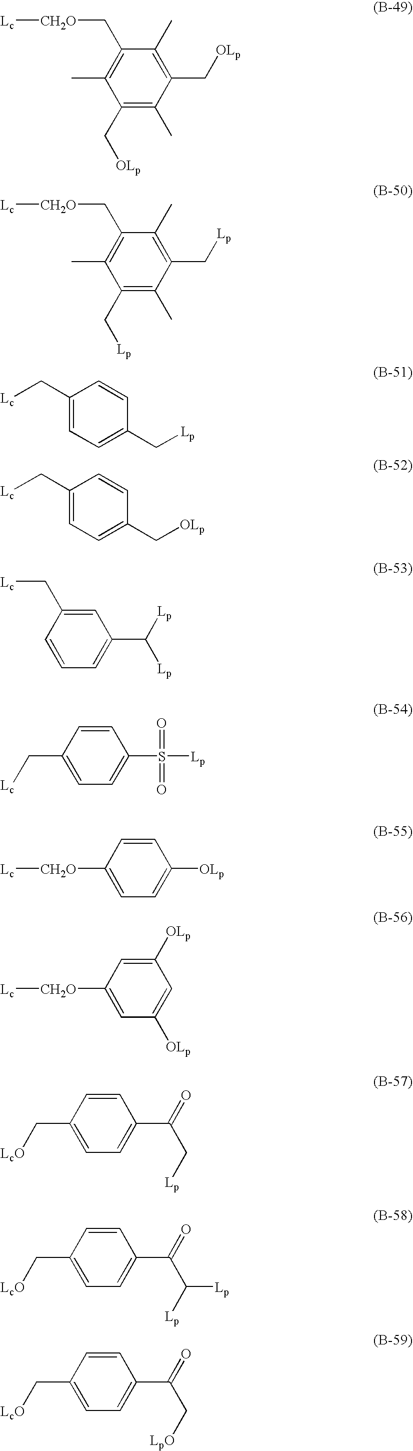 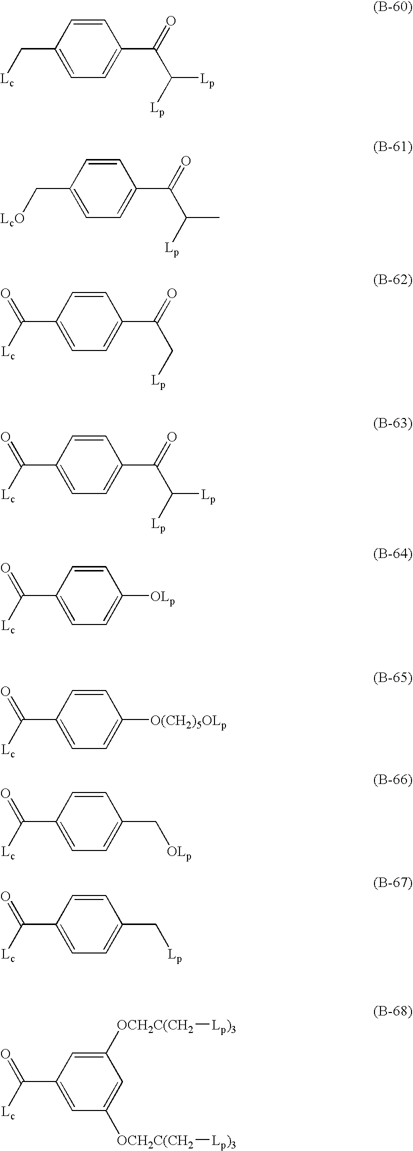
Hydrophilic Segment and Hydrophobic Segment

The hydrophilic segment of the invention has the solvolysis resistance and the heat resistance, and has an ionic functional group. Further, the hydrophobic segment of the invention has the solvolysis resistance and the heat resistance, and has no ionic functional group.

The solvolysis resistance and the heat resistance have the same meanings as those for the connection group described above and specific examples and the like are also identical. Further, for the hydrophilic segment and the hydrophobic segment, any of low molecular compounds or polymers may be used preferably.

In the invention, the skeleton of the hydrophilic segment excluding the ionic functional group portion and the hydrophobic segment skeleton are preferably those groups comprising one or a combination of two or more members selected from the group consisting of aliphatic hydrocarbon group, aromatic hydrocarbon group, heterocyclic group, and

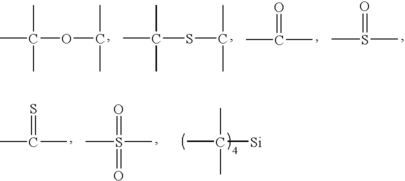

The aliphatic hydrocarbon group may be a saturated hydrocarbon or unsaturated hydrocarbon, or may be any of linear, branched, or cyclic group. Further, a hydrogen atom may be substituted for a substituent (for example, halogen atom, preferably, fluorine atom) within a range not departing from the gist of the invention. The number of carbon atoms in the aliphatic hydrocarbon group is, preferably, from 1 to 24 and, more preferably, from 1 to 6.

The number of carbon atoms in the aromatic hydrocarbon group is, preferably, from 6 to 25, more preferably, from 6 to 16 and, further preferably, from 6 to 12. A hydrogen atom on the ring of the aromatic hydrocarbon group may be substituted for a substituent (for example, halogen atom, preferably, fluorine atom, etc.) within a range not departing from the gist of the invention. Pyrenyl group, anthranyl group, fluorenyl group, and phenanthronyl group are preferred, naphtyl group and biphenyl group are more preferred, and phenyl group is particularly preferred.

The heterocyclic group preferably contains any of sulfur atom, nitrogen atom, and oxygen atom, and those containing the sulfur atom or nitrogen atom are preferred. Further, the number of carbon atoms of the heterocyclic group is, preferably, from 2 to 12 and, more preferably, from 3 to 8. A hydrogen atom on the ring of the heterocyclic group may be substituted for a substituent (for example, halogen atom, preferably, fluorine atom) within a range not departing from the gist of the invention.

The heterocyclic ring group is, preferably, a pyridyl group, furyl group, and thienyl group, with the triazinyl group being more preferred.

The ionic functional group in the hydrophilic segment of the invention may be either cationic or anionic and it is preferably an anionic functional group.

The cationic ionic functional group is, preferably, sulfonium group, iodonium group, thiorhonium group, phosphonium group, pyridyl group, and ammonium group, and the pyridyl group and ammonium group are more preferred. Specific examples of the pyridyl group and ammonium group include, preferably, -(dimethylcetyl)ammonium group, -(benzyldibutyl)ammonium group, -(benzyldiethyl)ammonium group, -(dimethyldodecyl)ammonium group, -(didecylmethyl)ammonium group, -(stearyldimethyl)ammonium group, -(lauryldimethyl)ammonium group, -(trimethyl)ammonium group, -(triethyl)ammonium group, -(tri-n-butyl)ammonium group, -(triheptyl)ammonium group, -(butyldiethyl)ammonium group, -(phenyldiethyl)ammonium group, -(2-methyl)pyridyl group, -(3-methyl)pyridyl group, and -(4-methyl)pyridyl group, more preferably, -(stearyldimetyl)ammonium group, -(lauryldimethyl)ammonium group, -(trimethyl)ammonium group, -(triethyl)ammonium group, -(tri-n-butyl)ammonium groups, -(triheptyl)ammonium group, -(butyldiethyl)ammonium group, -(phenyldiethyl)ammonium group, -(2-methyl)pyridyl group, -(3-methyl)pyridyl group, and -(4-methyl)pyridyl group and, particularly preferably, -(trimethyl)ammonium group, -(triethyl)ammonium group, and -(tri-n-butyl)ammonium group.

Further, as the counter anion, chloride ions, bromide ions, iodide ions, hydroxide ions are preferred and the hydroxide ions are more preferred.

As the anionic functional group, perfluorosulfo group, sulfo group, phosphonic acid group, and carboxylic acid group are preferred, and perfluorosulfo group, sulfo group, and phosphonic acid group are more preferred.

Further, as the counter cations, calcium ions, barium ions, quaternary ammonium ions, lithium ions, sodium ions, potassium ions, and protons are preferred, lithium ions, sodium ions, potassium ions, and protons are further preferred, and the protons are particularly preferred.

It is preferred that the ionic functional group is present by at least one per one repepetitive unit of the hydrophilic segment and it is further preferred that the group is present by two or more per one repetitive unit.

The concentration of the ionic functional groups in the hydrophilic segment can be measured as an exchange capacity. It is, preferably, from 0.1 to 7 meq/g, more preferably, from 0.5 to 5 meq/g and, further preferably, from 1 to 3 meq/g. By defining the concentration of the ionic functional groups in the hydrophilic segment to 0.1 meq/g or more, the proton conductivity can be increased further. By defining it to 7 meq/g or less, the durability and the mechanical strength can be improved further.

For the hydrophobic segment, permacall value thereof is, preferably, from 0 to 20, more preferably, from 0 to 15 and, particularly preferably, from 0 to 10. The permacall value is used as an index of a gas permeability and can be calculated, for example, from the table described in ACS Polymer Preprints, written by M. Salame, in Vol. 8, 137 (1967).

Method of Connecting Hydrophilic Segment and Hydrophobic Segment to Carbon Material

Method of connecting the hydrophilic segment and the hydrophobic segment to the carbon material of the invention includes two methods, that is, (1) a method of connecting both the hydrophilic segment and the hydrophobic segment by way of an identical connection group on the surface of the carbon material (that is, by an identical connection group) (hereinafter the method is referred to as a method A), and (2) a method of connecting the hydrophilic segment and the hydrophobic segment by way of different connection groups respectively on the carbon surface (that is, by different connection groups) (hereinafter, the method is referred to as method B). In the invention, any of the methods can be used preferably. A preferred structure of the hydrophilic segment and the hydrophobic segment introduced to the surface of the carbon material is different between the case of using the method A and the case of using the method B. The structures of the hydrophilic segment and the hydrophobic segment in a case of using the respective methods of method A and the method B are to be described specifically.

Method A

The method A is a method of connecting both the hydrophilic segment and the hydrophobic segment by an identical connection point on the surface of the carbon material. That is, this means that both the hydrophilic segment and the hydrophobic segment are introduced to the carbon surface by way of one connection point on the surface of the carbon material in the type 1-1 to the type 1-3. Such connection methods includes, specifically, (1) a method of connecting a block copolymer in which hydrophilic segments and hydrophobic segments are repeated alternately by way of a connection group on the surface of the carbon material (hereinafter the method is referred to as a method C), (2) a method of connecting a graft polymerized polymer in which at least side chain comprising the hydrophilic segments is grafted on the main chain comprising hydrophobic segments by way of a connection group on the surface of the carbon material (hereinafter, the method is referred to as a method D), and (3) a method of connecting a graft polymerized polymer in which at least a side chain comprising the hydrophobic segments is grafted on the main chain comprising hydrophilic segments by way of a connection group on the surface of the carbon material (hereinafter, the method is referred to as a method E). Any of the methods can be used preferably. Structures of preferred hydrophilic segment and hydrophobic segment upon using the methods are to be described.

Method C

The method C is a method of connecting a block copolymer in which hydrophilic segments and hydrophobic segments are repeated alternately by way of a connection point on the surface of the carbon material. For example, the type 1-1 can be obtained. The block copolymer preferably contains hydrophilic segments comprising repetitive units in which an ionic functional group represented by —B¹-(A¹)ₙ₂ is introduced to the main chain structure represented by —R¹—X¹— in the formula (1) and hydrophobic segments comprising repetitive units in which a substituent of high oxygen permeability represented by -E¹ and/or -E²is introduced to the main chain structure represented by —R²—X²— in the formula (2). Hereinafter, such a polymer is referred to as the polymer series F.

The polymer series F is obtained, for example, by a method of forming a main chain structure represented by —R¹—X¹— or —R²—X²— and then introducing an ionic functional group represented by —B¹-(A¹)ₙ₂, or a substituent of high oxygen permeability represented by -E¹ and/or -E² to the main chain (hereinafter, the method is referred to as a “post-addition method”), a method of connecting hydrophilic segments obtained by polymerizing the compound represented by the formula (3) and the compound represented by the formula (4) and a hydrophobic segment obtained by polymerizing the compound represented by the formula (4) and the compound represented by the formula (5) (hereinafter, the method is referred to as “monomer introduction method”), or a method of forming one of the hydrophilic segments or the hydrophobic segments by the post-addition method and forming the other of them by the monomer introduction method (hereinafter, the method is referred to as “mixing method”).

Further, as the block copolymer, a polymer in which the hydrophilic segment comprises the formula (6) and the hydrophobic segment comprises the formula (7) is also preferred. Hereinafter such a polymer is referred to as a polymer series G.

The polymer series G is obtained, for example, by connecting a hydrophilic segment obtained by polymerizing the compound represented by the formula (8) and a hydrophobic segment obtained by polymerizing the compound represented by the formula (9) .

The repetitive structures for both of the polymer series and the compounds for forming them are to be described in details.

Structure of Polymer Series F 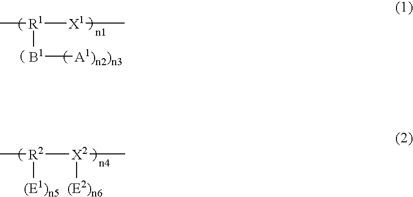
(in the formula (1) and the formula (2), R¹ and R² each represents a group comprising an aromatic ring, X¹ and X² each represents a single bond or a bivalent connection group, B¹ represents a single bond or a bivalent to hexavalent connection group, A¹ represents an ionic functional group, E¹ and E² each represents a substituent of high oxygen permeability, n1 and n4 each represents an integer of 8 or greater, n2 is an integer of from 1 to 5, and n3, n5, and n6 each represents an integer of from 0 to 4).

The hydrophilic segment comprising the formula (1) may be a repetitive unit of one structure or may comprise two or more structures. Particularly, it sometimes contains a repetitive unit at n3=0 depending on the content of the ionic functional group, etc. That is, it may suffice that the ionic functional group is contained as the entire segment comprising the formula (1). This is considered in the same manner also for the formula (2), formula (6), formula (7), etc.

The total number of carbon atoms constituting the aromatic ring in each of R¹ and R² in the formula (1) and the formula (2) is, preferably, from 6 to 50, more preferably, from 6 to 30 and, further preferably, from 6 to 15. Further, a hydrogen atom on the aromatic ring may be substituted for a substituent (for example, halogen atom, preferably, fluorine atom) within a range not departing from the gist of the invention. Further, the aromatic ring each for R¹ and R² preferably comprises a benzene ring or a condensed benzene ring.

Examples of preferred structures for R¹ and R² are shown below. Among them, (C-1), (C-2), (C-4), (C-5), (C-8), and (C-12) are preferred, and (C-1) and (C-4) are more preferred.

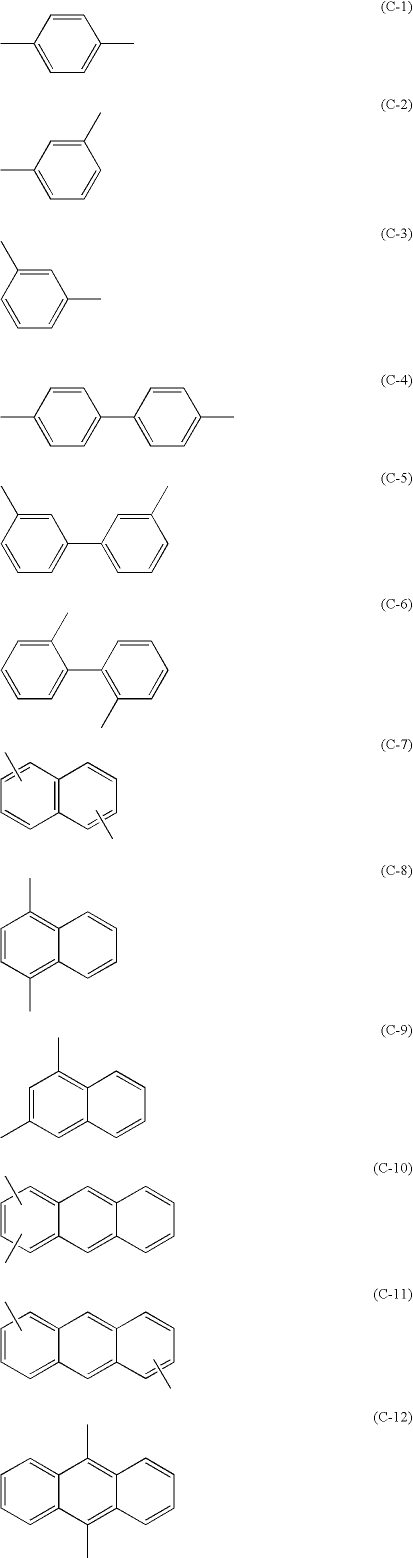

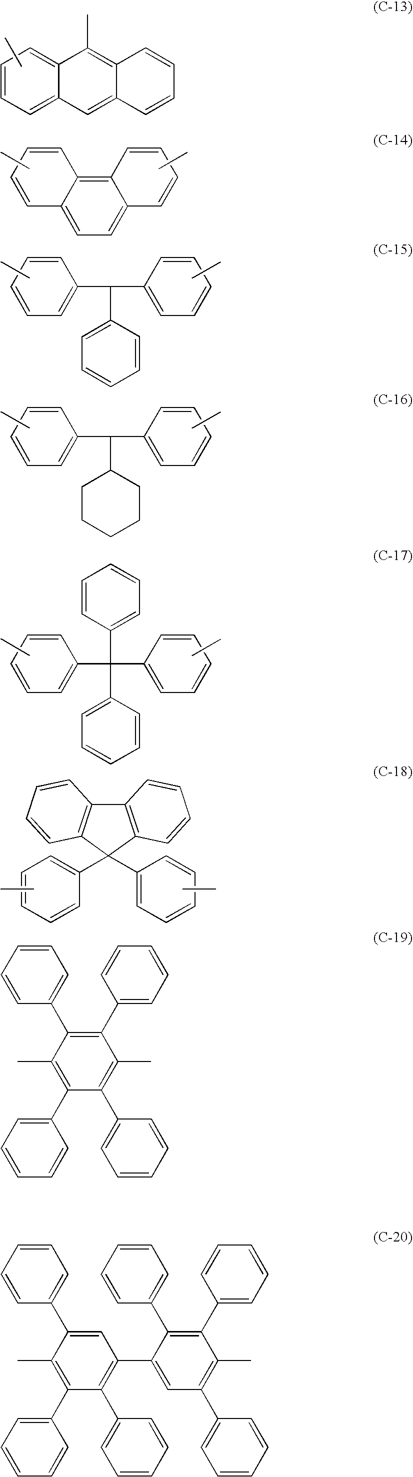

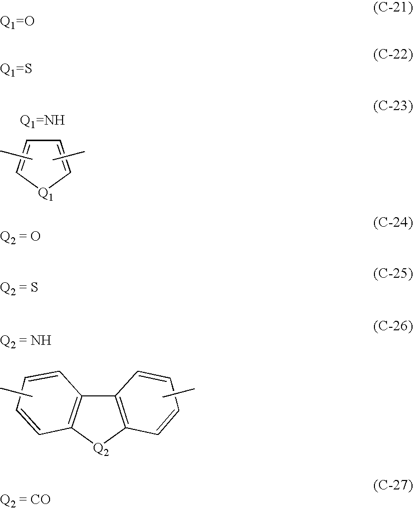

X¹ and X² each represents preferably a bivalent connection group comprising one or more groups selected from the group consisting of —C(R⁹¹R¹⁰¹)—, —O—, —S—, —CO—, —SO—, and —SO₂—. R⁹¹ and R¹⁰¹ each represents a hydrogen atom, alkyl group (preferably of 1 to 20 carbon atoms, for example, methyl group, ethyl group, propyl group, n-butyl group, isobutyl group, tert-butyl group, isopropyl group, n-pentyl group, neopentyl group, methoxyethyl group), alkenyl group (preferably of 2 to 20 carbon atoms, for example, vinyl group and allyl group), aryl group (preferably of 6 to 26 carbon atoms, for example, phenyl group and 2-naphthyl group), in which a hydrogen atom contained in them may be substituted for a substituent (for example, halogen atom, preferably, fluorine atom) within a range not departing from the gist of the invention.

R⁹¹ and R¹⁰¹ is, preferably, methyl group, ethyl group, isopropyl group, neopentyl group, trifluoromethyl group, tert-butyl group, propyl group, n-butyl group (Bu), n-pentyl group, or phenyl group, more preferably, methyl group, ethyl group, isopropyl group, neopentyl group, trifluoromethyl group, tert-butyl group, or phenyl group and, further preferably, methyl group, trifluoromethyl group, or tert-butyl group.

Preferred examples of X¹ and X² include —C(t—Bu)₂-, —C(CH₃)₂—, —C(CF₃)₂—, —O—, —S—, —CO—, and —SO₂—.

The formula (1) or the formula (2) preferably comprises a polyether sulfone compound, polyether ether sulfone compound, polyether ether ketone compound, polyphenylene sulfide compound, polyphenylene ether compound, polysulfone compound, or polyether ketone compound. Among them, it is more preferred that the formula comprises polyether sulfone compound, polyether ether sulfone compound, and polysulfone compound of excellent oxidation resistance.

In the formula (1) and the formula (2), n1 and n4 each represents an integer of 8 or greater, an integer of from a to 800 is preferred, an integer of from 8 to 400 is further preferred and an integer of from 16 to 120 is particularly preferred.

In the polymer series F, a main chain of a hydrophilic segment comprising the formula (1) and a main chain of a hydrophobic segment comprising the formula (2) are preferably connected alternately. The total number for the hydrophilic segments and the hydrophobic segments is, preferably, from 2 to 100, more preferably, from 2 to 50 and, particularly preferably, from 4 to 30.

Preferred examples for the main chain portion of the segments comprising the formula (1) or the formula (2) (—R²—X²—, —R²—X²—) are shown below but the invention is not restricted to them.

In the polymer series F, the main chain portion of the segment comprising the formula (1) and the main chain portion of the segment comprising the formula (2) may be constituted each with only one type, or may be constituted by two or more of types.

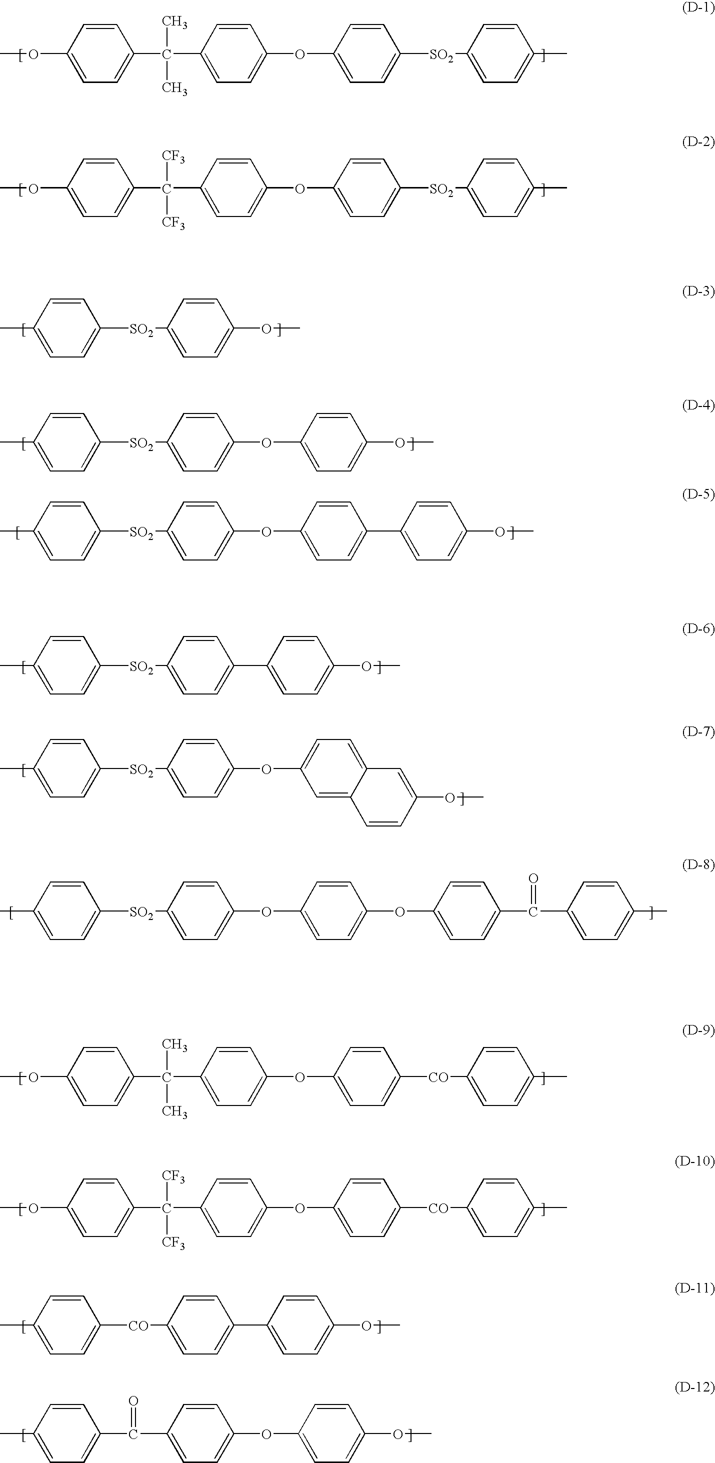

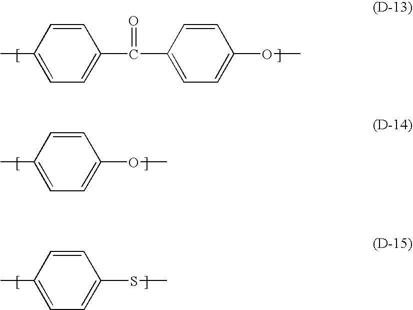

In the formula (1), B¹ includes preferably a single bond or those groups comprising one or a combination of two or more members selected from the group consisting of aliphatic hydrocarbon group, aromatic hydrocarbon group, heterocyclic group, and

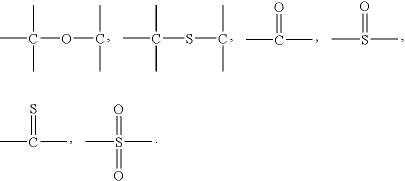

The aliphatic hydrocarbon group may be a saturated hydrocarbon or unsaturated hydrocarbon, and a hydrogen atom may be substituted for a substituent (for example, a halogen atom, preferably, fluorine atom) within a range not departing from the gist of the invention. The number of carbon atoms in the aliphatic hydrocarbon group is, preferably, from 1 to 12 and, more preferably, from 1 to 6. In the aromatic hydrocarbon group, a hydrogen atom on the ring may be substituted for a substituent (for example, a halogen atom, preferably, fluorine atom) within a range not departing from the gist of the invention and it is, preferably, a pyrenyl group, anthranyl group, naphthyl group, biphenyl group, and phenyl group, more preferably, naphthyl group, biphenyl group, and phenyl group, and further preferably, phenyl group. In the heterocyclic group, a hydrogen atom on the ring may be substituted for a substituent (for example, a halogen atom, preferably fluorine atom) within a range not departing from the gist of the invention and it is preferably, a pyridyl group, furyl group, thienyl group, and triazinyl group and, more preferably, triazinyl group.

Preferred examples of B¹ includes a single bond, methylene group, ethylene group, propylene group, butylene group, hexylene group, octylene group, decylene group, phenylene (-Ph-) group, —CH₂—O—(CH₂)ₙ— (where n is an integer of 1 or greater, preferably, an integer of from 1 to 6), —CH₂-Ph-, —CH₂CH₂OCH₂CH₂—, —(CH₂CH₂O)₂CH₂CH₂—, —CH₂CH═CH—, —CH₂CH₂CH═CH—, and C((CH₂)ₙ—)₄ (where n is an integer of 1 or greater, preferably, an integer of from 1 to 6), CH((CH₂)ₙ—)₃ (n is an integer of 1 or greater, preferably, an integer of from 1 to 6), and CH₃C((CH₂)ₙ—)₃ (where n is an integer of 1or greater, preferably, an integer of from 1 to 6), EtC((CH₂)ₙ—)₃ (where n is an integer of 1 or greater, preferably, an integer of from 1 to 6), —C((CH₂)ₙ—)₃ (where n is an integer of 1 or greater, preferably, an integer of from 1 to 6) , —CH((CH₂)ₙ—)₂ (where n is an integer of 1 or greater, preferably, an integer of from 1 to 6), and those groups comprising a combination of them (including those groups described above combined by two or more), and one or more of —CO—, —SO—, —CS—, —SO₂—, and

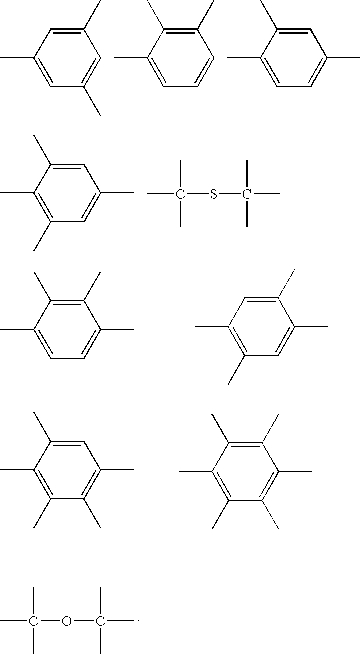

In the formula (1) , the introduction amount of the ionic functional groups in the hydrophilic segment main chain is such an amount that the content of the ionic functional groups introduced in the hydrophilic segment is from 0.1 meq/g to 7 meq/g, more preferably, from 0.5 meq/g to 4 meq/g and, further preferably, from 1 meq/g to 3 meq/g. Accordingly, it is necessary to control the value for n2 and n3 such that the content of the ionic functional groups is within the range described above.

Preferred examples for the side chain portion —(B¹-(A¹)ₙ₂)ₙ₃ in the formula (1) are shown below, but the invention is not restricted to them.

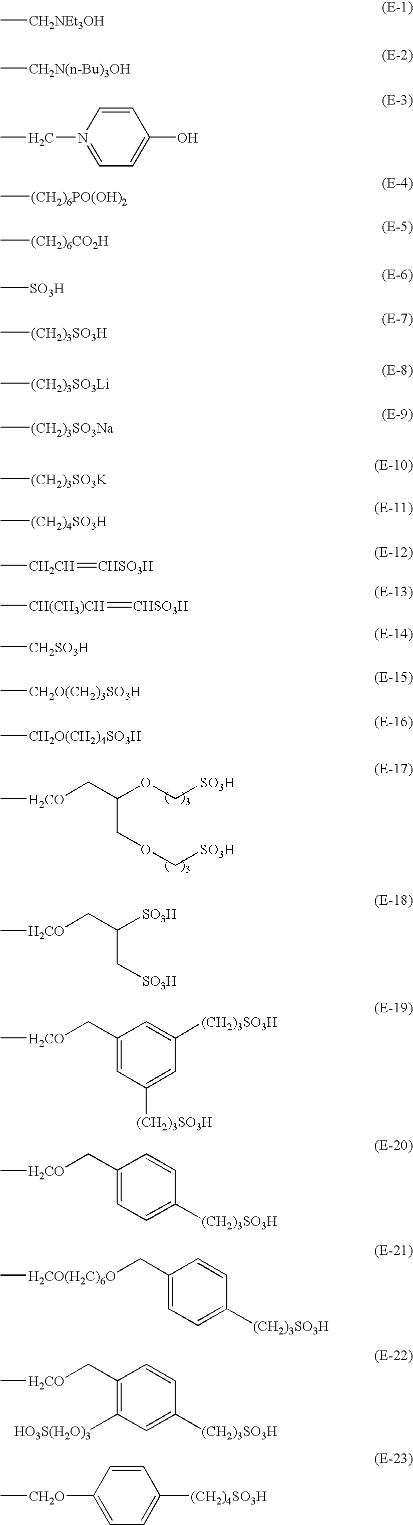

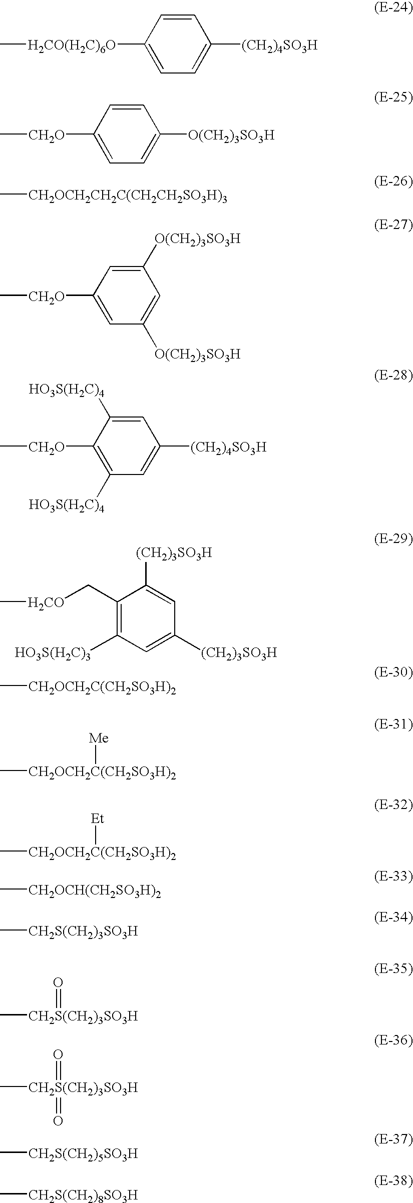

In the formula (2), E¹ and E² each represents a substituent of high oxygen permeability. The substituent of high oxygen permeability means a substituent in which the permacall value of the substituent is negative. The permacall value of the substituent is described, for example, in ACS Polymer Preprints written by M. Salame, in Vol. 8, 137 (1967). The permacall value for E¹ or E² is preferably −10/N or less, more preferably, −20/N or less and, particularly preferably, −50/N or less. In this case, N represents the total number of constituent units that constitute the polymer main chain, which has the same meaning as N described in the literature above. More specifically, E¹ and E² each preferably comprises three or more carbon atoms and E¹ and E² each preferably has a substituent of low polarity and those comprising silicon atoms or fluorine atoms are particularly preferred. E¹ and E² each has, preferably, from 3 to 60 carbon atoms, more preferably, from 5 to 40 carbon atoms and, particularly preferably, from 6 to 30 carbon atoms.

E¹ and E² each includes, for example, alkyl group (n-propyl group, isopropyl group, n-butyl group, n-pentyl group, benzyl group, 3-sulfopropyl group, 4-sulfobutyl group, carboxymethyl group, carboxypentyl group), alkoxy group (ethoxy group, n-propoxy group, n-butoxy group, tert-butoxy group, pentyloxy group, neopentyloxy group), alkenyl group (allyl group, 2-butenyl group, 1,3-butadienyl group), cycloalkyl group (cyclopentyl group, cyclohexyl group), aryl group (phenyl group, 2-chlorophenyl group, 4-methoxyphenyl group, 3-methylphenyl group, 1-naphthyl group, 2-nitrophenyl group), heterocyclic group (pyridyl group, thienyl group, furyl group, thiazolyl group, imidazolyl group, pyrazolyl group, pyrrolidino group, piperidino group, morpholino group), alkynyl group (2-propynyl group, 1,3-butadiinyl group, 2-phenylethynyl group), as well as those groups comprising one or more of combinations of them and methylol group, preferably, alkyl group, alkenyl group, cycloalkyl group, methyloxyalkyl group, methyloxyalkenyl group, methyloxycycloalkyl group, more preferably, alkyl group, cycloalkyl group, methyloxyalkyl group, methyloxycycloalkyl group and, further preferably, those comprising an ether structure or silicon atom in the methylene chain of the substituents (ethoxymethyl group, propoxymethyl group, butoxymethyl group, hexyloxymethyl group, trimethylsilyl group, triethylsilyl group, tributylsilyl group, 3-trimethylsilyl propyl group, 2-trimethyl silylethyl group, 6-triethylsilyl hexyl group, and triethylsilyl propyl group).

The substituent may have a substituent within a range not departing from the gist of the invention. The substituent includes a halogen atom (for example, a fluorine atom, chlorine atom, bromine atom, and iodine atom), amino group (preferably having from 0 to 20 carbon atoms, for example, amino group, dimethylamino group, diethylamino group, dibutylamino group, and anilino group), cyano group, nitro group, hydroxyl group, mercapto group, carboxyl group, sulfo group, phosphonic acid group, acyl group (having preferably from 1 to 20 carbon atoms, for example, acetyl group), alkoxy group (having preferably from 1 to 20 carbon atoms, for example, methoxy group, butoxy group, and cyclohexyloxy group), aryloxy group (having preferably from 6 to 26 carbon atoms, for example, phenoxy group, 1-naphthoxy group), alkylthio group (having preferably from 1 to 20 carbon atoms, for example, methylthio group, and ethylthio group), arylthio group (having preferably from 6 to 20 carbon atoms, for example, phenylthio group and, 4-chlorophenylthio group), alkylsulfonyl group (having preferably from 1 to 20 carbon atoms, for example, methane sulfonyl group, and butane sulfonyl group), and arylsulfonyl group (having preferably from 6 to 20 carbon atoms, for example, benzene sulfonyl group and paratoluene sulfonyl group).

n5 and n6 each is an integer of from 0 to 4, more preferably, from 0 to 2 and, further preferably, 0 or 1.

The permacall value of the hydrophobic segment, is preferably, within a range from 0 to 20, more preferably, from 0 to 15 and, particularly preferably, from 0 to 10. Accordingly, n5 and n6 are preferably determined optionally such that the permacall value of the hydrophobic segment is within the range described above.

The weight average molecular weigh: of the polymer of the polymer series F is, preferably, from 500 to 200,000, more preferably, from 1,000to 100,000 and, particularly preferably, from 1,500 to 50,000.

Manufacturing Method of Polymer Series F and Introduction Method to Carbon Material

Post-Addition Method

The post-addition method is a method comprising forming a main chain structure represented by —(R¹—X¹)ₙ₁— and then bonding a group represented by —B¹-(A¹)ₙ₂ to the main chain structure, and forming a main chain structure represented by —(R²—X²)ₙ₄— and then bonding the group represented by -E¹ and/or -E² to the main chain structure. That is, this is a method of forming the main chain structure and then introducing an ionic functional group or a substituent of high oxygen permeability to the main chain. For the method of forming the main chain portion, a known method as described in “4th edition, Experimental Chemical Cource, Vol. 29, 4.1 Heat Resistant Material” is used preferably. Further, commercially available polymers can also be utilized for the main chain.

The method of introducing the ionic functional group represented by —B¹-(A¹)—n2 to the main chain includes, for example, in a case where the ionic functional group is a sulfo group, a method of forming a halogenomethylated polymer by using a halogenomethylating agent such as a chloromethyl methyl ether to be described later, then acetylthionating the halogen portion and then oxidizing the portion into a sulfo group, a method of reacting a halogenomethylated polymer and sodium sulfite to form a sulfo group, or a method of reacting a halogenomethylated polymer and a sulfoalkyl thiol to introduce a sulfo group, etc. Further, in a case of a sulfoalkyl group having more carbon atoms, it includes, for example, a method of introducing a chloro-substituted acyl group through a known method, for example, by chloro-substituted acid chloride represented by Cl—(CH₂)ₙ—COCl (n is, for example, from 2 to 6) by way of Friedel-Crafts reaction using a Lewis acid such as aluminum chloride or iron chloride, then transforming a chlorine atom into a sulfo group with dimethyl thioether and sodium thiosulfate and then reducing the carbonyl group by hydrazine, or a method of lithiating hydrogen on the aromatic ring and then halogenoalkylating the same with dihalogeno alkane and, subsequently, transforming the chlorine atom into a sulfo group by the method described above in accordance with the method described in J. Org. Chem. 45. 2717 (1980).

For introducing a preferred halogenomethyl group into the aromatic ring (halogenomethylating reaction for aromatic ring) in the invention, known reactions can be used generally. For example, the chloromethyl group can be introduced into the aromatic ring by conducting a chloromethylating reaction using, for example, chloromethylmethyl ether, 1,4-bis(chloromethoxy)butane, 1-chloromethoxy-4-chlorobutane, etc., as the chloromethylating agent and using a Lewis acid such as tin chloride, zinc chloride, aluminum chloride or titanium chloride, or a hydrofluoric acid as a catalyst. It is preferred to conduct reaction in a homogeneous system by using dichloroethane, trichloroethane, tetrachloroethane, chlorobenzene, dichlorobenzene, nitrobenzene, or the like for the solvent. Further, the halogenomethylating reaction can be conducted also by using paraformaldehyde and hydrogen chloride or hydrogen bromide.

Further, as a method of introducing the sulfa group, a Friedel-Crafts reaction using sultones and Lewis acid (for example, AlCl₃) as described below can be used as a general method (Journal of Applied Polymer Science, Vol. 36, 1753 to 1767, 1988).

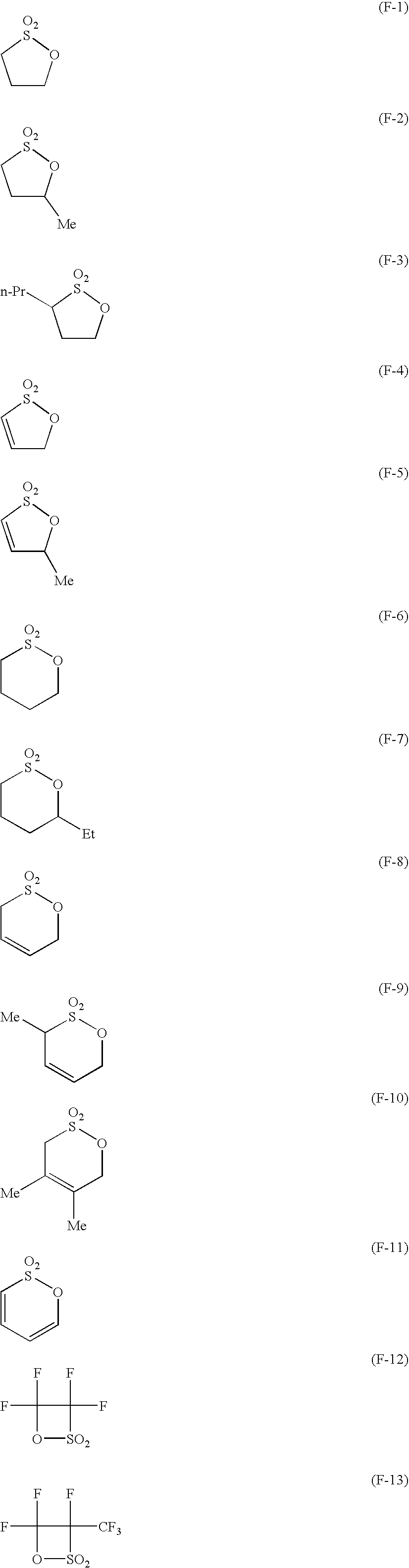

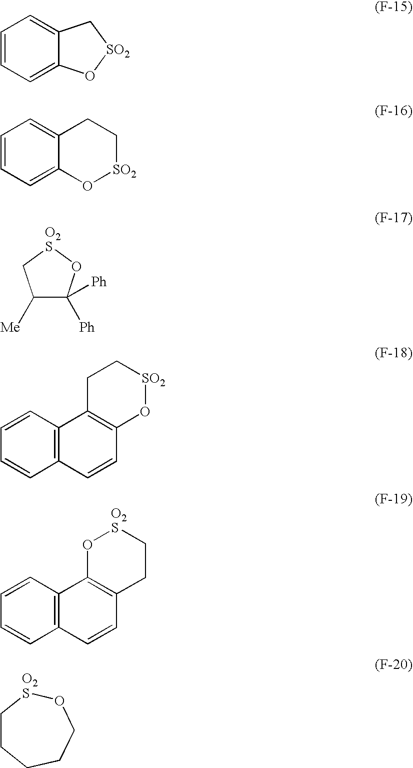

In a case of conducting the Friedel-Crafts reaction, hydrocarbons (benzene, toluene, nitrobenzene, acetophenone, etc.), halogenated alkyl (methylene chloride, chloroform, dichloroethane, carbon tetrachloride, trichloroethane, dichloroethane, tetrachloroethane, chlorobenzene, trichlorobenzene, etc.) can be used as the solvent. The reaction temperature may be selected in a range from a room temperature (for example, 18° C.) to 250° C. In the reactions, two or more solvents may be used in admixture.

The structure of the sulfone group-containing polymer compound of the invention, in a case where the main chain is polysulfone, can be confirmed by IR absorption spectrum from S═O absorption at 1,030 to 1,045 cm₋₁, 1,160 to 1,190 cm⁻¹, C—O—C absorption at 1,130 to 1,250 cm⁻¹, and C═O absorption at 1,640 to 1,660 cm⁻¹, etc, and the composition ratio thereof can be determined by naturalizing titration or elemental analysis of sulfonic acid. Further, the structure can be confirmed by nuclear magnetic resonance spectrum (¹H-NMR) from the peak of aromatic proton at 6.8 to 8.0 ppm.

For the method of introducing the ionic functional group represented by —B¹-(A¹)ₙ₂, in a case where the ionic functional group is other than the sulfo group, a known method of forming a halogenomethylated polymer by using a halogenomethylating agent such as chloromethylmethyl ether and introducing each of ionic functional group comprising ingredients by way of an etheric bond using Williamson ether synthesis is used preferably.

As a method of introducing a partial structure represented by E¹ and/or E², a known method of using Williamson ether synthesis after halomethylation of the main chain aromatic ring can be utilized.

In a case of synthesizing the polymer series F by using the post-addition method, the polymer introduction method to the carbon material includes, for example, five methods represented by (method F 1-1) to (method F 1-5), and any of the methods can be used preferably. (method F 1-1) to (method F 1-5) are to be described specifically.

(Method F 1-1)

The method F 1-1 is a method of forming each of the segment main chains and introducing an ionic functional group represented by —B¹-(A¹)ₙ₂ or a substituent of high oxygen permeability represented by -E¹ and/or -E², by the post-addition method connecting each of the segments to form a polymer series F and then connecting the polymer to the carbon material.

(Method F 1-2)

The method F 1-2 is a method of forming each of the segment main chains and introducing an ionic functional group represented by —B¹-(A¹)ₙ₂ or a substituent of high oxygen permeability represented by -E¹ and/or -E² to the main chain by the post-addition method, and then conducting formation of the polymer series F by the connection of each of the segments and connection to the carbon material simultaneously.

(Method F 1-3)

The method F 1-3 is a method of forming the main chain of each of the segments, connecting each of the segments, then connecting the same to the carbon material, and then introducing the ionic functional group represented —B¹-(A¹)ₙ₂, or a substituent of high oxygen permeability represented by -E¹ and/or -E².

(Method F 1-4)

The method F 1-4 is a method of forming a main chain for each of segments, conducting connection of each of the segment main chains and connection to the carbon material simultaneously, and then introducing an ionic functional group represented by —B¹-(A¹)ₙ₂ or a substituent of high oxygen permeability represented by -E¹ and/or -E².

(Method F 1-5)

The method F 1-5 is a method of forming the main chain for each of segments, connecting each of the segments, then introducing an ionic functional group represented by —B¹-(A¹)ₙ₂ or a substituent of high oxygen permeability represented by -E¹ and/or -E², and then connecting the same to the carbon material.

Monomer Introduction Method

The monomer introduction method is a method of connecting a hydrophilic segment obtained by polymerizing the compound represented by the formula (3) and the compound represented by the formula (4), and a hydrophobic segment obtained by polymerizing the compound represented by the formula (4) and the compound represented by the formula (5). The compound represented by the formula (3), the compound represented by the formula (4), and the compound represented by the formula (5) may be used each alone, or two or more of them may be used. The compounds are to be described. 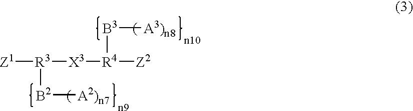
(in the formula (3), X³ represents a single bond or a bivalent connection group, R³ and R⁴ each represents a group comprising an aromatic ring. B² and B³ each represents a single bond or a bivalent to hexavalent connection group, A² and A³ each is an ionic functional group, n7 and n8 each is an integer of 1 to 5, n9 and n10 each represents an integer of from 0 to 4, the sum for n9 and n10 is 2 or greater, and Z¹ and Z² each represents a hydroxyl group, halogen group, alkylsulfonate group, or nitro group).

In the formula (3), X³ preferably represents a single bond or a bivalent group comprising one or a combination of two or more members selected from the group consisting of —C (Q¹⁰¹Q²⁰²)-, —O—, —CO—, —S—, —SO— and —SO₂—. Q¹⁰¹ and Q²⁰² each represents a hydrogen atom or a substituent and the substituent includes, as preferred examples, a fluorine atom, methyl group, ethyl group, propyl group, trifluoromethyl group and phenyl group. Q¹⁰¹ and Q²⁰² are preferably identical.

R³ and R⁴ is, preferably, a group comprising an aromatic ring, the total number of the carbon atom constituting the aromatic ring is, preferably, from 1 to 50, more preferably, from 1 to 30 and, further preferably, from 1 to 15. Further, a hydrogen atom on the aromatic ring may be substituted with a substituent (for example, a halogen atom, preferably, fluorine atom) within a range not departing from the gist of the invention.

Examples of preferred structure for R³ and R⁴ are to be shown. While the connection positions with —B²-(A²)ₙ₇ and —B³-(A³)ₙ₈ are not particularly described in the structural formula but they may be connected by a desired number at optional positions on the aromatic ring and they are shown as the structure of bivalent connection groups in the following structural formulae. For —B²-(A²)ₙ₇ or —B³-(A³)ₙ₈, (A-2), (A-5), (A-8), and (A-12) are more preferred, respectively, and (A-1) and (A-4) are particularly preferred, among them.

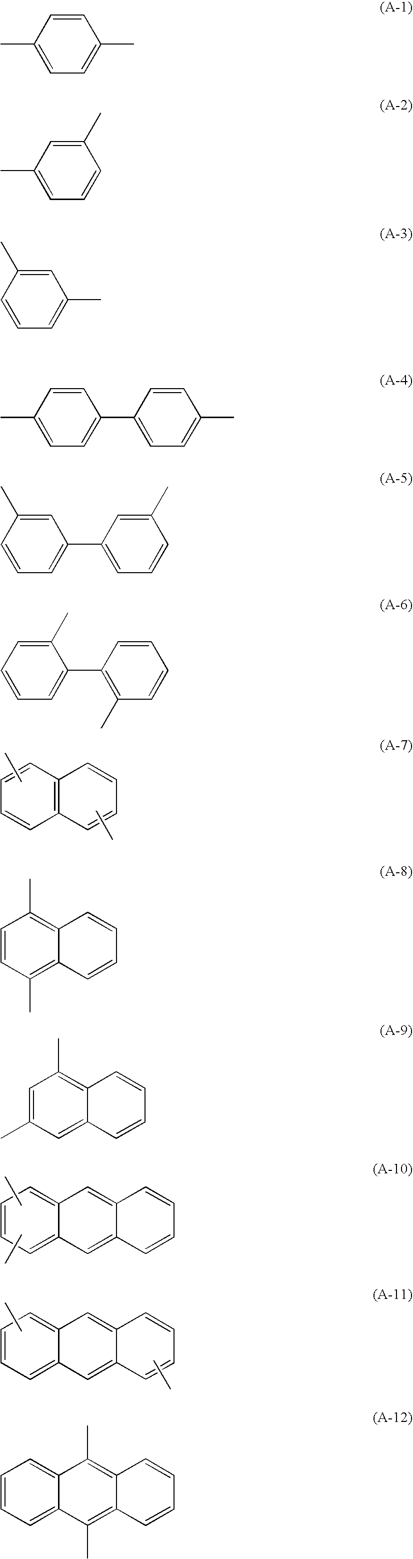

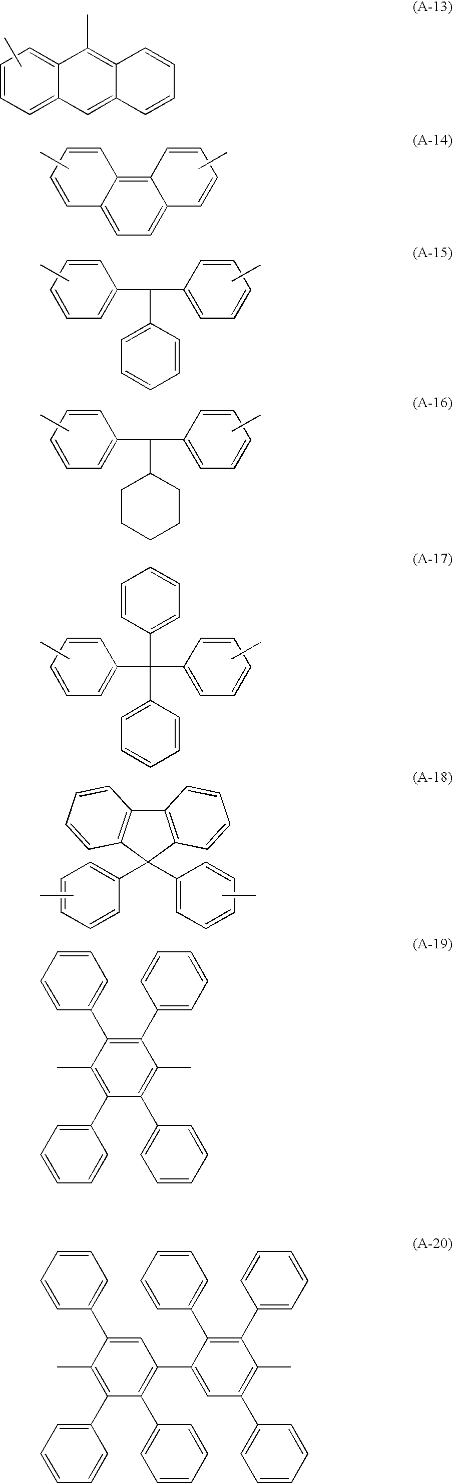

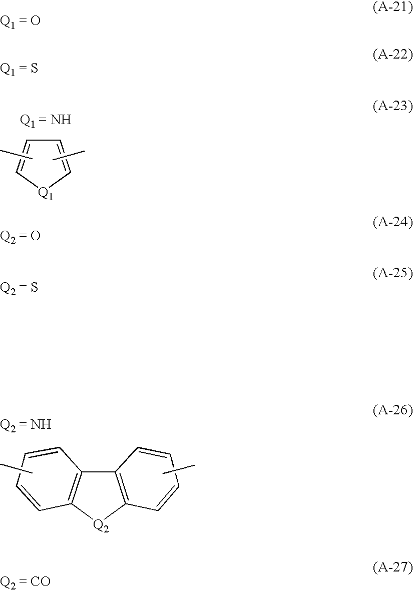

Each of Z¹ and Z² is preferably a hydroxyl group, fluorine atom, chlorine atom, methanesulfonate group, p-toluene sulfonate group, and the hydroxyl group, fluorine atom, chlorine atom are more preferred.

B² and B³ each have the same meanings as B¹ in the formula (1), and a preferred range also has the same meanings.

A² and A³ each has the same meanings as A¹ in the formula (1), and a preferred range also has the same meanings.

n7 and n8 each preferably represents an integer of from 1 to 5, and n9 and n10 each represents an integer of from 1 to 3. The sum for n9 and n10 is preferably from 2 to 4.

n7 to n10 each represents 2 or greater, and B², B³, A²and/or A³ is present by 2 or more, B², B³, A² and/or A³ described above may be identical or different with each other.

Preferred examples of the formula (3) are to be shown below, but the invention is not restructured to them.

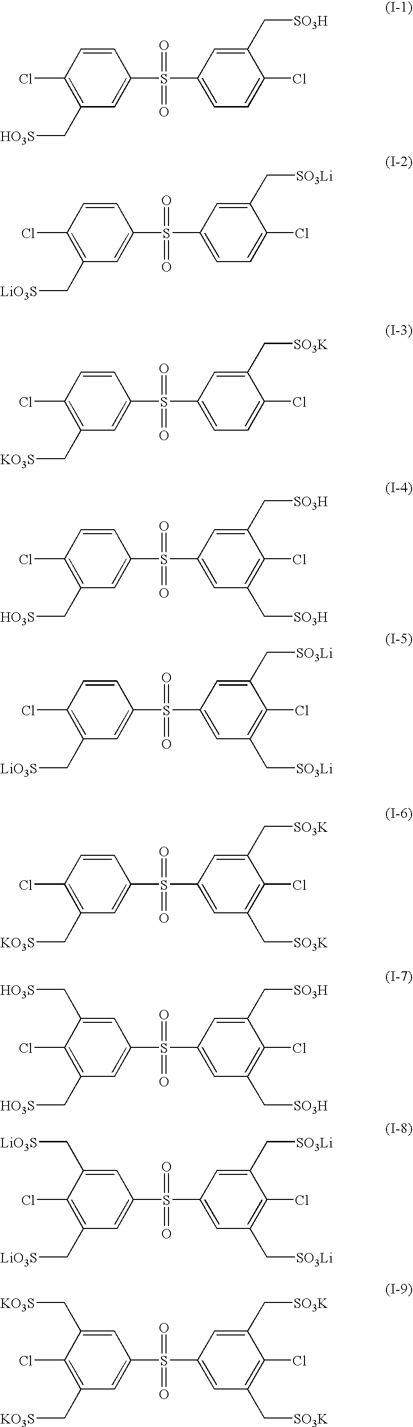

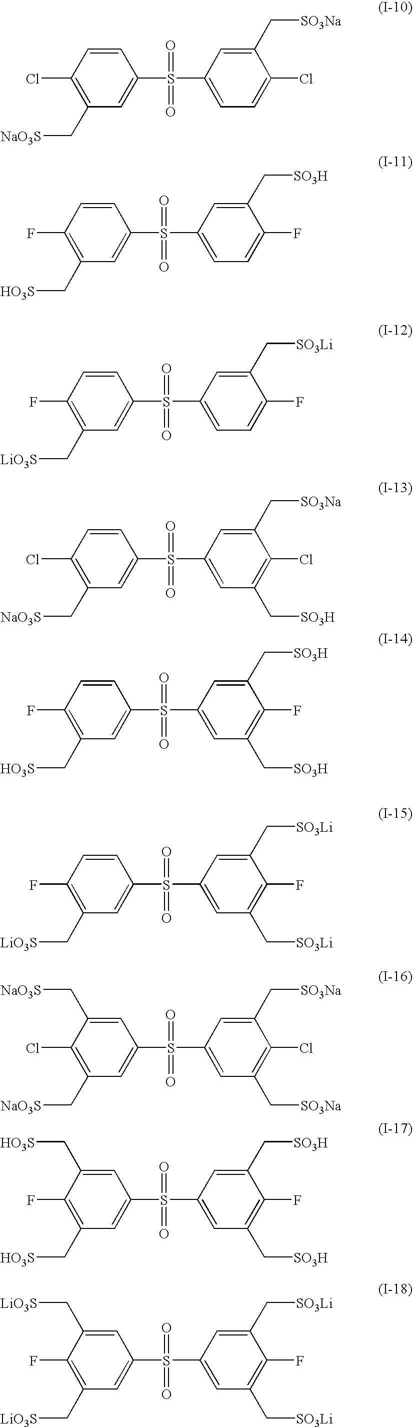

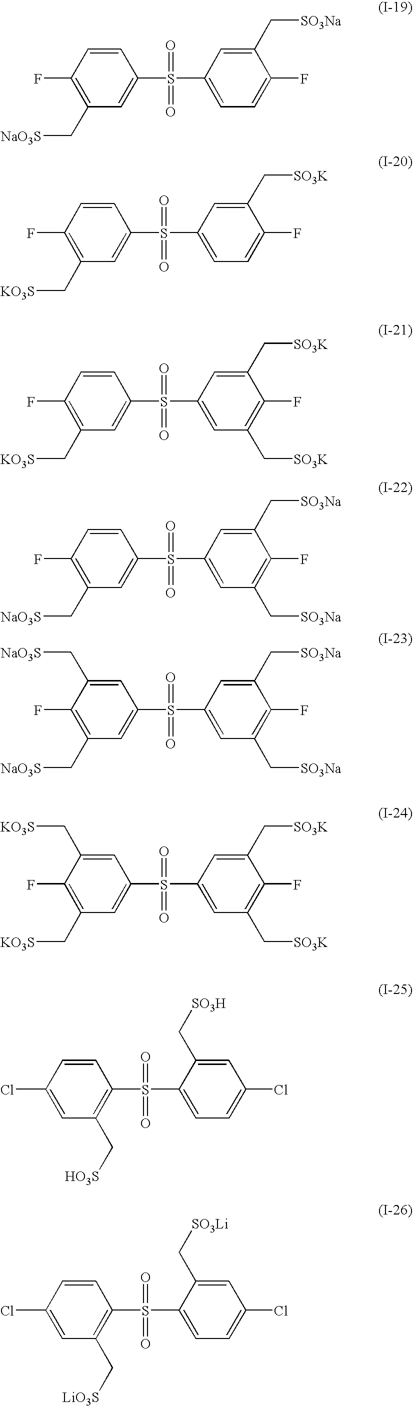

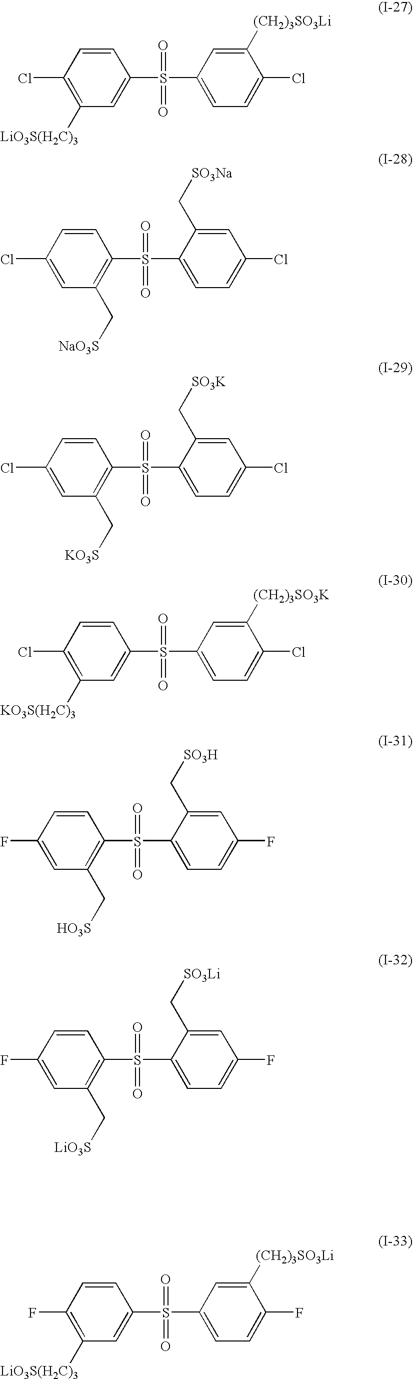

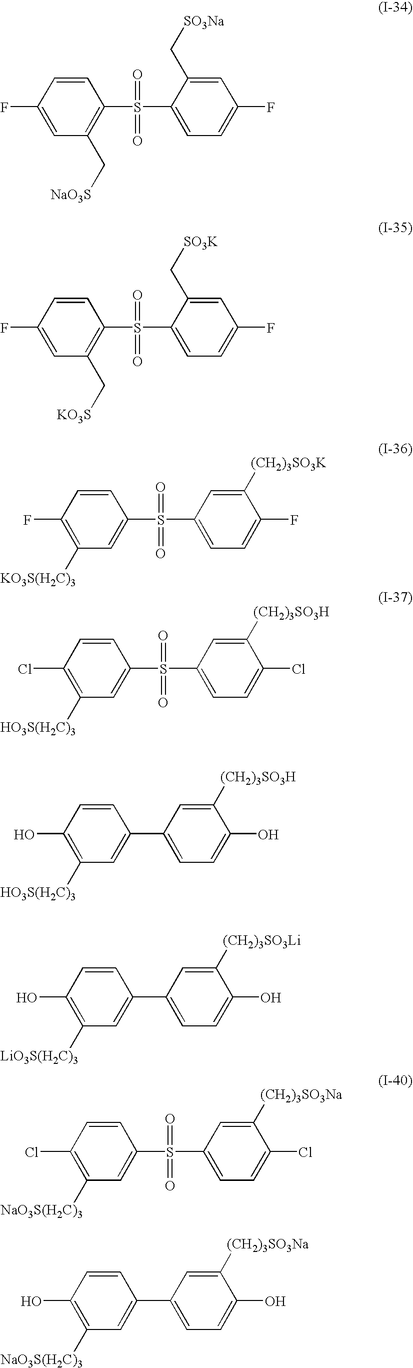

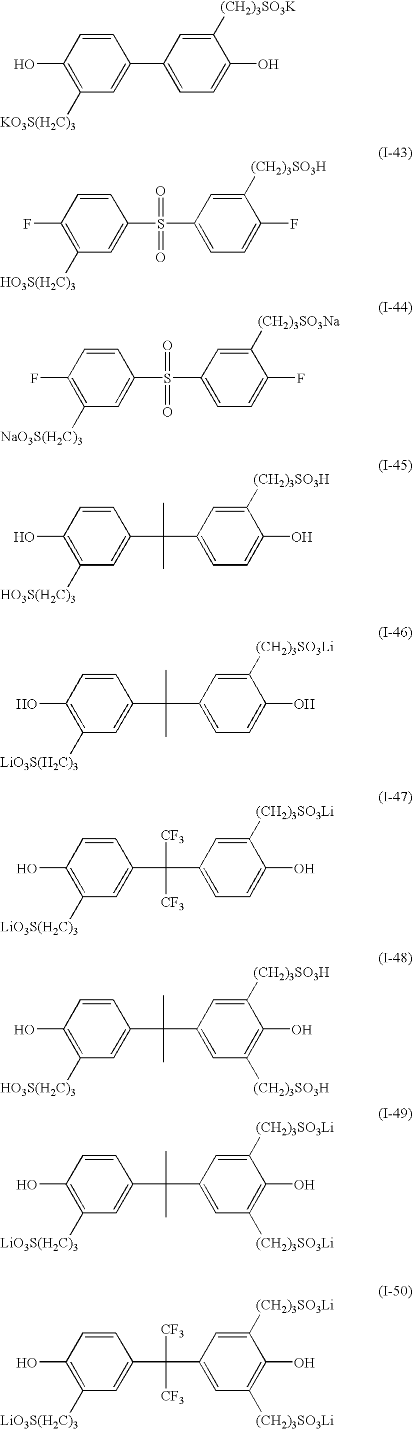

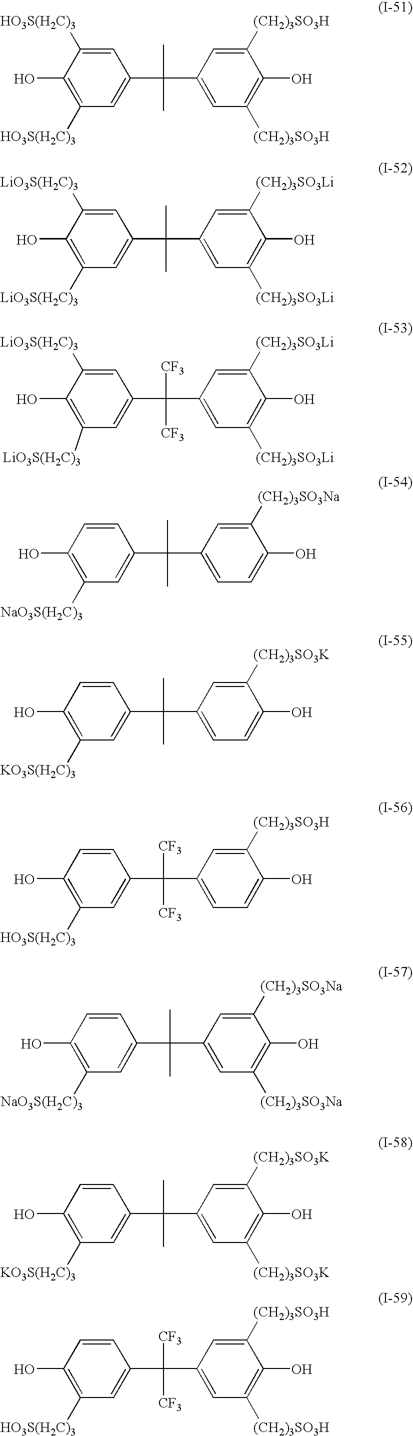

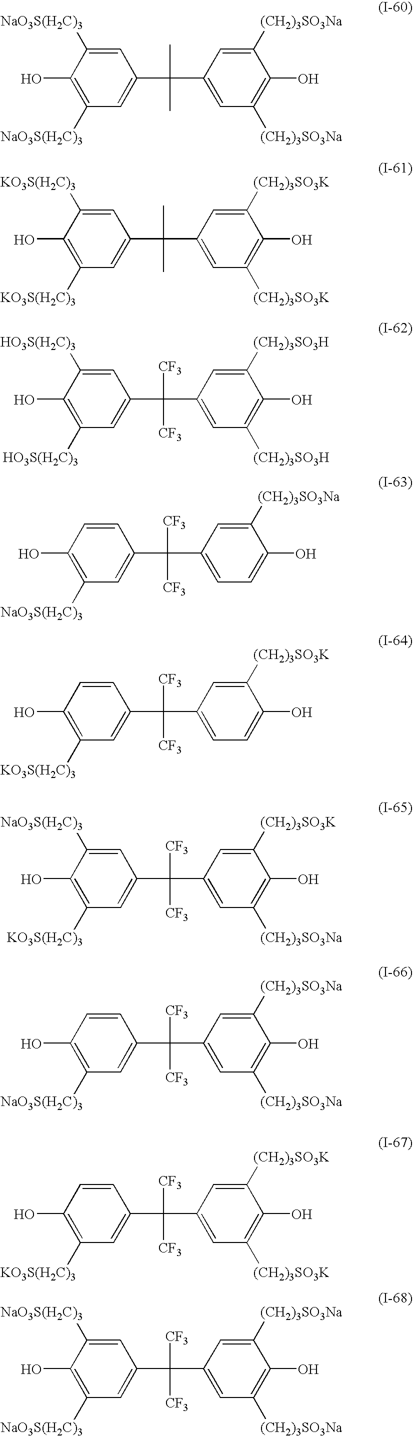

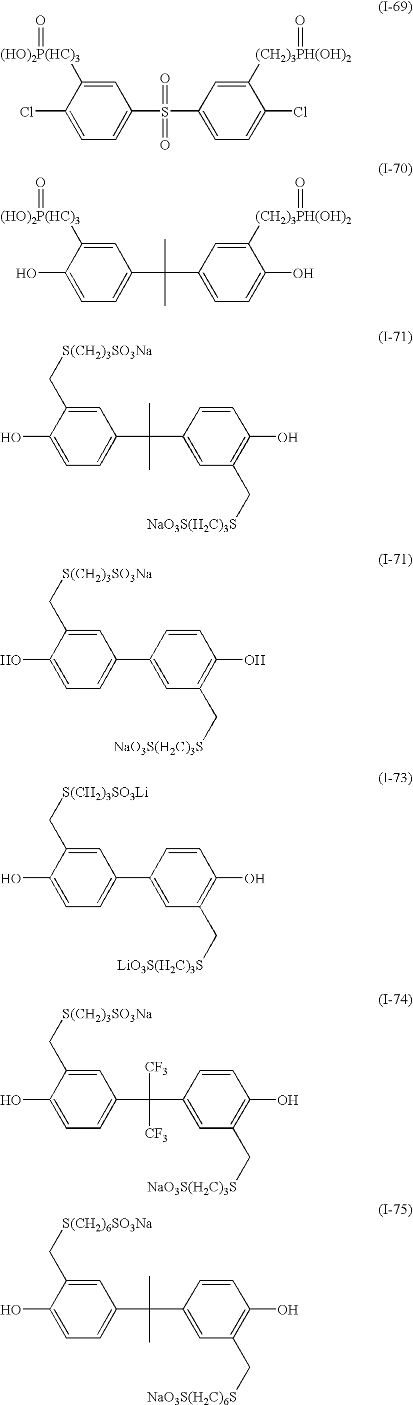

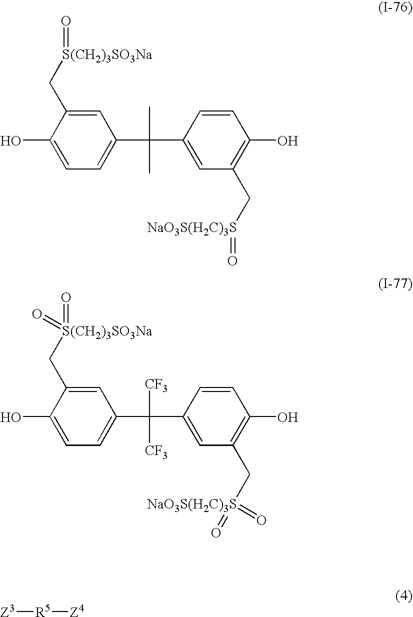

(in the formula (4), Z³ and Z⁴ each represents a hydroxyl group, halogen group, alkylsulfonate group, or nitro group, and R⁵ represents a group comprising an aromatic ring).

In the formula (4), R⁵ represents preferably a group comprising an aromatic ring, which has the same meanings as R¹ in the formula (1) and a preferred range also has same meanings.

Z³ and Z⁴ each represents, preferably, a hydroxyl group, fluorine atom, chlorine atom, methanesulfonate group, p-toluenesulfonate group, and the hydroxyl group, the fluorine atom and the chlorine atom are more preferred.

Specific examples of the compound represented by the formula (4) include, for example, hydroquinone, resorcin,
2-methylhydroquinone, 2-ethylhydroquinone,
2-propylhydroquinone, 2-butylhydroquinone,
2-hexylhydroquinone, 2-octylhydroquinone,
2-decanylhydroquinone, 2,3-dimethylhydroquinone,
2,3-diethylhydroquinone, 2,5-dimethylhydroguinone,
2,5-diethylhydroquinone, 2,6-dimethylhydroquinone,
2,3,5-trimethylhydroquinone,
2,3,5,6-tetramethylhydroquinone, 4,4′-dihydroxybiphenyl,
2,2′-dihydroxybiphenyl,
3,3′-dimethyl-4,4′-dihydroxybiphenyl,
3,3′,5,5′-teramethyl-4,4′-dihydroxybiphenyl,
3,3′-dichloro-4,4′-dihydroxybiphenyl,
3,3′,5,5′-tetrachloro-4,4′-dihydroxybiphenyl,
3,3′-dibromo-4,4′-dihydroxybiphenyl,
3,3′,5,5′-tetrabromo-4,4′-dihydroxybiphenyl,
3,3′-difluoro-4,4′-dihydroxybiphenyl,
3,3′,5,5′-tetrafluoro-4,4′-dihydroxybiphenyl,
4,4′-dihydroxydiphenylmethane,
2,2′-dihydroxydiphenylmethane,
3,3′-dimethyl-4,4′-dihydroxydiphenylmethane,
3,3′,5,5′-tetramethyl-4,4′-dihydroxydiphenylmethane,
3,3′-dichloro-4,4′-dihydroxydiphenylmethane,
3,3′,5,5′-tetrachloro-4,4′-dihycroxydiphenylmethane,
3,3′-dibromo-4,4′-dihydroxydiphenylmethane,
3,3′,5,5′-tetrabromo-4,4′-dihydroxydiphenymethane,
3,3′-difluoro-4,4′-dihydroxydiphenylmethane,
3,3′,5,5′-tetrafluoro-4,4′-dihydroxydiphenylmethane,
4,4′-dihydroxydiphenylether, 2,2′-dihydroxydiphenylether,
3,3′-dimethyl-4,4′-dihydroxydiphenylether,
3,3′,5,5′-tetramethyl-4,4′-dihydroxydiphenylether,
3,3′-dichloro-4,4′-dihydroxydiphenylether,
3,3′,5,5′-tetrachloro-4,4′-dihydroxydiphenylether,
3,3′-dibromo-4,4′-dihydroxydiphenylether,
3,3′,5,5′-tetrabromo-4,4′-dthydroxydiphenylether,
3,3′-difluoro-4,4′-dihydroxydiphenylether,
3,3′,5,5′-tetrafluoro-4,4′-dihydroxydiphenylether,
4,4′-dihydroxydiphenylsulfide,
2,2′-dihydroxydiphenylsulfide,
3,3′-dimethyl-4,4′-dihydroxydiphenylsulfide,
3,3′,5,5′-tetramethyl-4,4′-dihydroxydiphenylsulfide,
3,3′-dichloro-4,4′-dihydroxydiphenylsulfide,
3,3′,5,5′-tetrachloro-4,4′-dihydroxydiphenylsulfide,
3,3′-dibromo-4,4′-dihydroxydiphenylsulfide,
3,3′,5,5′-tetrabromo-4,4′-dihydroxydiphenylsulfide,
3,3′difluoro-4,4′-dihydroxydiphenylsulfide,
3,3′,5,5′-tetrafluoro-4,4′-dihydroxydiphenylsulfide,
4,4′-dihydroxydiphenylsulfone,
2,2′-dihydroxydiphenylsulfone,
3,3′-dimethyl-4,4′-dihydroxydiphenylsulfone,
3,3′,5,5′-tetramethyl-4,4′-dihydroxydiphenylsulfone,
3,3′-dichloro-4,4′-dihydroxydiphenylsulfone,
3,3′,5,5′-tetrachloro-4,4′-dihydroxydiphenylsulfone,
3,3′-dibromo-4,4′-dihydroxydiphenylsulfone,
3,3′,5,5′-tetrabromo-4,4′-dihydroxydiphenylsulfone,
3,3′-difluoro-4,4,′-dihydroxydiphenylsulfone,
3,3′,5,5′-tetrafluoro-4,4′-dihydroxydiphenylsulfone,
2,2-bis(4-hydroxyphenyl)propane,
2,2-bis(2-hydroxyphenyl)propane,
2,2-bis(3-methyl-4-hydroxyphenyl)propane,
2,2-bis(3-chloro-4-hydroxyphenyl)propane,
2,2-bis(3,5-dichloro-4-hydroxyphenyl)propane,
2,2-bis(3-bromo-4-hydroxyphenyl)propane,
2,2-bis(3,5-dibromo-4-hydroxyphenyl)propane,
2,2-bis(3-fluoro-4-hydroxyphenyl)propane,
2,2bis(3,5-difluoro-4-hydroxyphenyl)propane,
2,2-bis(3,5-dimethyl-4-hydoxyphenyl)propane,
α,α′-bis(4-hydroxyphenyl)-1,4-diisopropylbenzene,
α,α′-bis(2-hydroxyphenyl)-1,4-diisopropylbenzene,
α,α′-bis(4-hydroxyphenyl)-1,3-diisopropylbenzene,
α,α′-bis(2-hydroxyphenyl)-1,3-diisopropylbenzene,
α,α′-bis(3-methyl-4-hydroxyphenyl)-1,4-diisopropylbenene,
α,α′-bis(3,5-dimethyl-4-hydroxyphenyl)-1,4-diisopropylbenzene,
α,α′-bis(3-methyl-4-hydroxyphenyl)-1,3-diisopropylbenzene,
α,α′-bis(3,5-dimethyl-4-hydroxyphenyl)-1,3-diisopropylbenzene,
4,4′-dichlorodiphenylsulfone, 2,2′-dichlorodiphenylsulfone,
3,3′-dimethyl-4,4′-dichlorodiphenylsulfone,
3,3′,5,5′-tetramethyl-4,4′-dichlorodiphenylsulfone,
3,3′-dihydroxy-4,4′-dichlorodiphenylsulfone,
3,3′-dibromo-4,4′-dichlorodiphenylsulfone,
3,3′-difluoro-4,4′-dichlorodiphenylsulfone,
3,3′,5,5′-tetrafluoro-4,4′-dichlorodiphenylsulfone,
4,4′-difluorodiphenylsulfone, 2,2′-difluorodiphenylsulfone,
3,3′-dimethyl-4,4′-fluorodiphenylsulfone,
3,3′,5,5′-tetramethyl-4,4′-diflurodiphenylsulfone,
3,3′-dihydroxy-4,4′-difluorodiphenylsulfone,
3,3′-dibromo-4,4′-difluorodiphenylsulfone,
3,3′-difluoro-4,4′-difluorodiphenylsulfone,
3,3′,5,5′-tetrafluoro-4,4′-difluorodiphenylsulfone,
perfluorobiphenyl, 4,4′-difluorobenzophenone,
4,4′-dichlorobenzophenone, 4,4′-dihydroxybenzophenone,
3,3′-difluorobenzophenone, 3,3′-dichlorobenzophenone,
3,3′-dihydroxybenzophenone,
4,4′-difluoro-3,3′-dimethylbenzophenone, and
4,4′-dichloro-3,3′-dimethylbenzophenone. 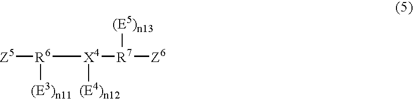
   (in the formula (5), X⁴ represents a single bond or a bivalent connection group, R⁶ and R⁷ each represents a group comprising an aromatic ring, E³, E⁴ and R⁵ each represents a substituent of high oxygen permeability, n11, n12 and n13 each represents an integer of from 0 to 4, the sum for n11, n12 and n13 is 1 or greater, Z⁵ and Z⁶ each represents a hydroxyl group, halogen group, alkylsulfonate group, or nitro group).

In the formula (5), X⁴ has the same meanings as X³ of the formula (3), and a preferred range also has the same meanings.

R⁶ and R⁷ each represents preferably a group comprising an aromatic ring, and has the same meanings as R³ and R⁴ of the formula (3), and a preferred range also has the same meanings as R³ and R⁴ except for replacing the connection portion to —B²-(A²)ₙ₇ and —B³-(A² )ₙ₈ with the connection group to E³ and E⁵.

Z⁵ and Z⁶ each preferably represents a hydroxyl group, fluorine atom, chlorine atom, methane sulfonate group, p-toluene sulfonate group, and the fluorine atom, chlorine atom, and the hydroxyl group are more preferred.

n11, n12 and n13 each represents an integer of from 0 to 4, and the sum for n11, n12, and n13 is 1 or greater.

E³, E⁴, and E⁵ each represents a substituent of high oxygen permeability, has the same meanings as E¹ and E² of the formula (2) and a preferred range also has the same meanings.

In a case where n11, n12 and n13 is 2 or greater, each of E³, E⁴ or E⁵ may be identical or different with each other.

Preferred examples for the formula (5) are shown below but the invention is not restricted to them.

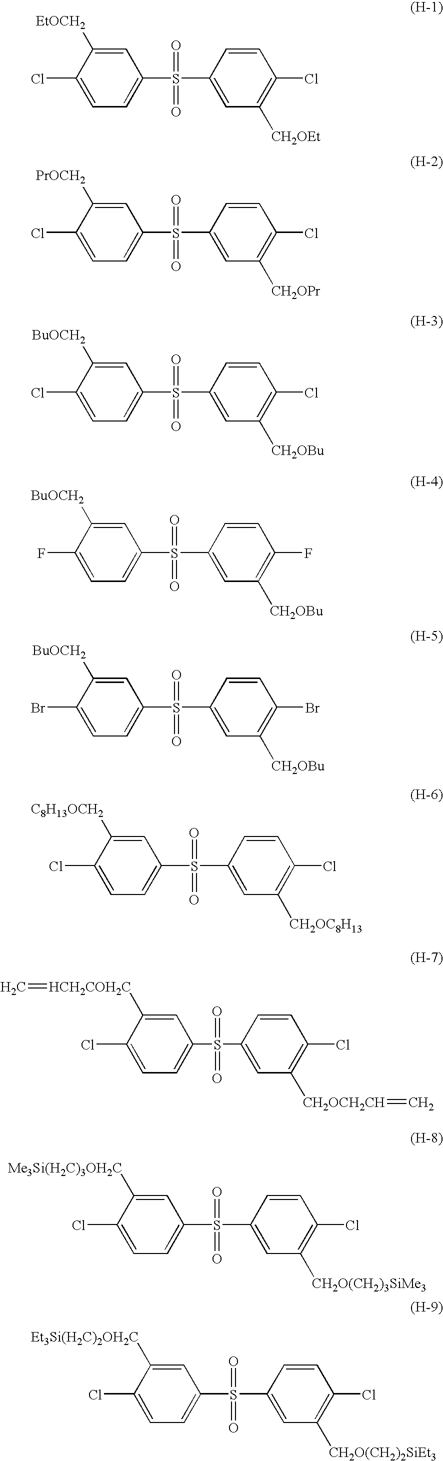

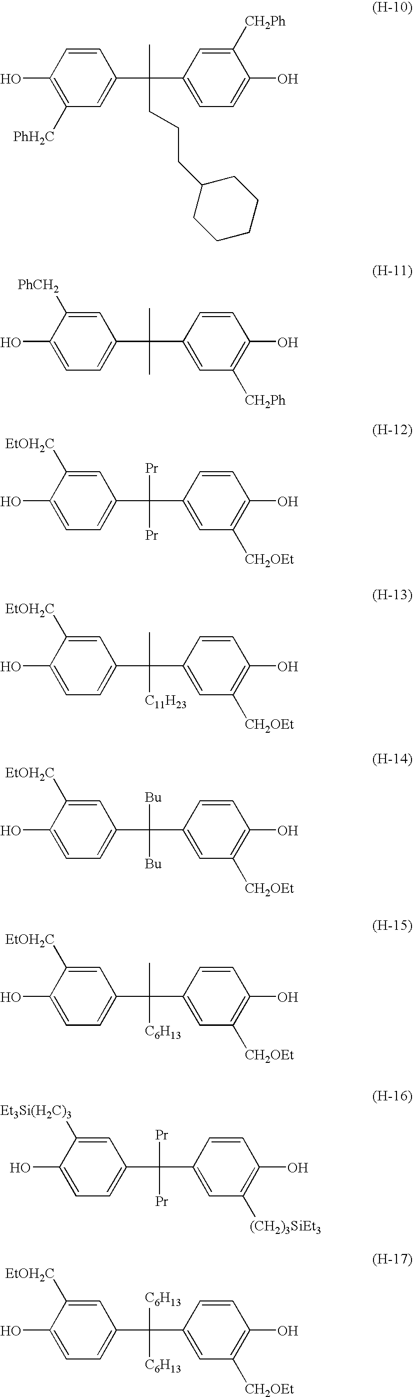

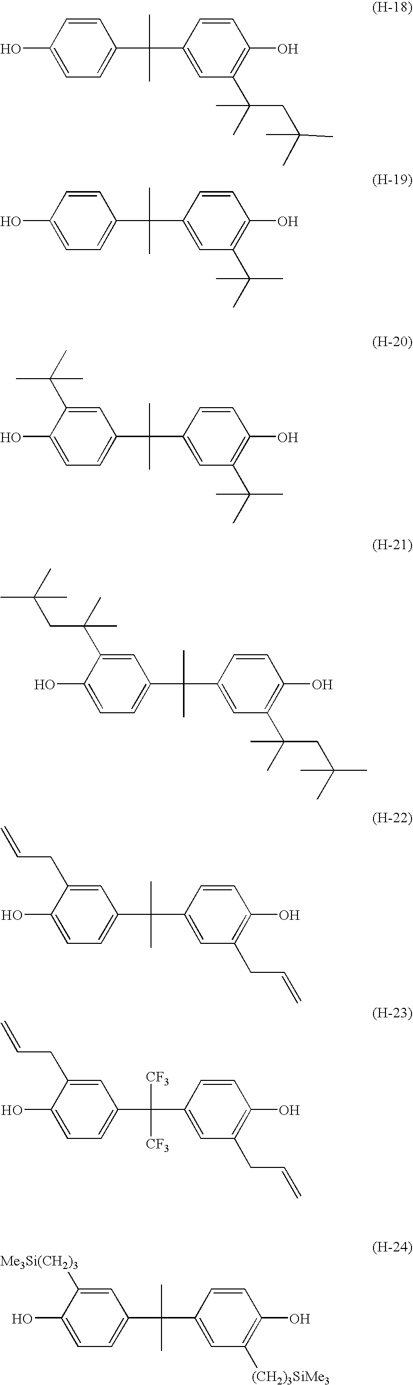

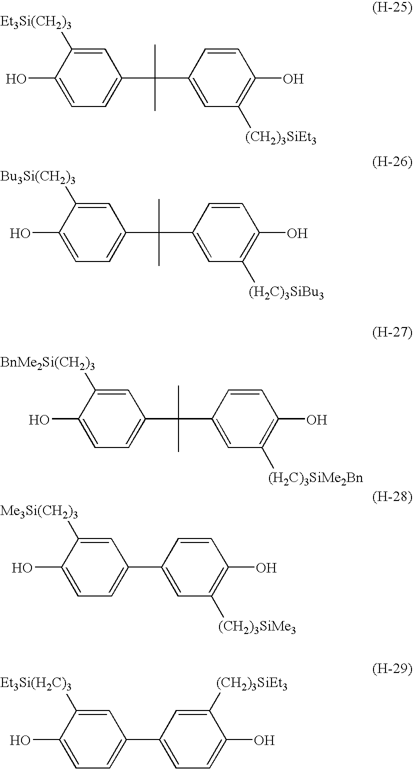

In a case of synthesizing the polymer series F by using the monomer introduction method, the method of introducing the polymer to the carbon material includes, for example, two methods represented by (method F 2-1), and (method F 2-2) and any of the methods can be used preferably. (Method F 2-1) and (method F 2-2) are described specifically.

(Method F 2-1)

The method F 2-1 is a method of connecting each of the segments obtained by the method described above to form a polymer series F and then connecting the polymer main chain to the carbon material.

(Method F 2-2)

The method F 2-2 is a method of connecting each of the segments under the presence of a carbon material thereby conducting formation of the polymer main chain and the connection to the carbon material simultaneously.

Mixing Method

The mixing method is a method of forming one of the hydrophilic segment and the hydrophilic segment by the post-addition method and forming the other of them by the monomer introduction method, in which formation of the polymer and the introduction of the polymer to the carbon material can be conducted properly in the same manner as the post-addition method and the monomer introduction method.
Structure of Polymer Series G 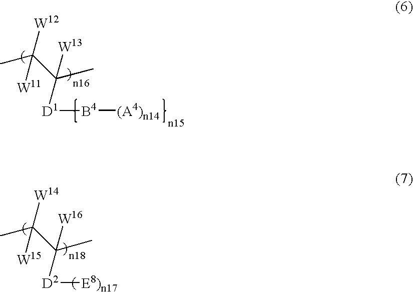
(in the formulae (6) and (7) , W¹¹, W¹² W¹³, W¹⁴, W¹⁵ and W¹⁶ each represents a hydrogen atom, halogen atom, alkyl group, aryl group, or heterocyclic ring. D¹ and D² each represents a single bond or a group comprising a substituted or not-substituted aromatic ring, B⁴ represents a single bond or a bivalent to hexavalent connection group, A⁴ represents an ionic functional group, E⁶ represents a substituent of high oxygen permeability. n16 and n18 each represents an integer of 2 or greater, and n14, n15 and n17 each represents an integer of from 1 to 5).

In the formulae (6) and (7), W¹¹, W¹², W¹³, W¹⁴, W¹⁵ and W¹⁶ each represents preferably, a hydrogen atom, a halogen atom, or alkyl group.

In a case where W¹¹, W¹², W¹³, W¹⁴, W¹⁵ and W¹⁶ each represents a halogen atom, a chlorine atom or fluorine atom is preferred, and the fluorine atom is more preferred.

In a case where W¹¹, W¹², W¹³, W¹⁴, W¹⁵ and W¹⁶ each represents an alkyl group, each of them may be linear, branched, or cyclic alkyl group and the number of carbon atoms thereof is preferably from 1 to 20 and, more preferably, from 1 to 6. Specifically, they include methyl group, ethyl group, propyl group, butyl group, 2-ethylhexyl group, decyl group, cyclopropyl group, cyclohexyl group, and cyclododecyl group.

In a case where W¹¹, W¹², W¹³, W¹⁴, W¹⁵ and W¹⁶ each represents an aryl group, they include respectively, substituted or not substituted phenyl groups and naphthyl groups of 6 to 20 carbon atoms.

In a case where W¹¹, W¹², W¹³, W¹⁴, W¹⁵ and W¹⁶ each represents a hetero-cyclic ring group, they include, substituted or not-substituted 6-membered heterocyclic ring, for example, piridyl group and morpholino group, substituted or not-substituted 5-membered heterocyclic ring, for example, (furyl group or thiophene group) as preferred examples.

D¹ and D² each represents a single bond or a group comprising a substituted or not substituted aromatic ring. In a case where D¹ and D² are groups comprising substituted or not-substituted aromatic rings, the aromatic ring is, preferably, a benzene ring, naphthalene ring, anthracene ring, and pyrene group, and the benzene group is more preferred.

B⁴ represents a single bond or a bivalent to hexavalent connection group, has the same meanings as B¹ of the formula (1), and preferred examples also have the same meanings. A⁵ represents an ionic functional group, has the same meanings as A¹ of (1), and preferred examples also have the same meanings. E⁶ is a substituent of high oxygen permeability, has the same meanings as E¹ of the formula (2), and preferred examples also have the same meanings. n16 and n18 each represents an integer of 2 or greater, preferably, from 2 to 150, more preferably, from 2 to 100 and, further preferably, from 5 to 50. n14, n15, and n17 each represents an integer of from 1 to 5.

In the hydrophilic segment, the introduction amount of the ionic functional group to the polymer main chain is preferably such an amount that the content of the introduced ionic functional groups is from 0.1 meq/g to 7 meq/g, more preferably, from 0.5 meq/g to 4 meq/g and, further preferably, from 1 meq/g to 3 meq/g. Accordingly, n14 and n15 are properly set such that the content of the ionic functional groups is within the range described above.

The permacall value of the hydrophobic segment is preferably within a range from 0 to 20, more preferably, from 0 to 15 and, particularly preferably, from 0 to 10. Accordingly, n17 is preferably set such that the permacall value of the hydrophobic segment is within the range described above.

The hydrophilic segment comprising the formula (6) and the hydrophobic segment comprising the formula (7) may be contained each alone or two or more of them may be contained.

The hydrophilic segment comprising the formula (6) and the hydrophobic segment comprising the formula (7) are constituted each preferably by from 2 to 250 repetitive units, more preferably, by 2 to 150 repetitive units and, further preferably, by from 4 to 100 repetitive units.

The weight average molecular weight of the polymer of the polymer series G is, preferably, from 500 to 200,000, more preferably, from 1,000 to 100,000 and, particularly, from 1500 to 50,000.

Method of Producing Polymer Series G and Method of Introduction to Carbon Material

A method of producing polymer series G and a method of introducing the polymer series G to the carbon material include:
1. A method of introducing a connection group having an initiation point of radical polymerization to the carbon material and simultaneously conducting formation of the polymer series G having a hydrophilic segment comprising a polymer of the compound represented by the formula (8) and a hydrophobic segment comprising a polymer of the compound represented by the formula (9) by atom transfer radical polymerization or stable free radical polymerization utilizing the initiation point and connection of the polymer series G to the carbon material (hereinafter the method is referred to as method G-1), and
2. A method of forming a polymer series G having a hydrophilic segment comprising a polymer of the compound represented by the formula (8) and a hydrophobic segment comprising a polymer of the compound represented by the formula (9) by stable free radical polymerization and connecting the same with a carbon material (hereinafter the method is referred to as method G-2). The compound represented by the formula (8) and the compound represented by the formula (9), and the method G-1 and the method G-2 are to be described specifically. 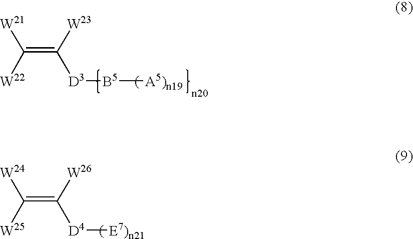
   (in the formulae (8) and (9), W²¹, W²², W²³, W²⁴, W²⁵, and W²⁶ each represents a hydrogen atom, a halogen atom, alkyl group, aryl group, or heterocyclic ring. D³ and D⁴ each represents a single bond or a group comprising a substituted or not-substituted aromatic ring, B⁵ represents a single bond or a bivalent to hexavalent connection group. A⁵ represents an ionic functional group or ionic functional group precursor. E⁷ represents a substituent of high oxygen permeability. n19, n20, and n21 each represents an integer of from 1 to 5).

In the formula (8) and the formula (9) , W²¹, W²², W²³, W²⁴, W²⁵, and W²⁶ each has the same meanings as W¹¹, W¹², W¹³, W¹⁴, W¹⁵ and W¹⁶ of the formula (6) and a preferred range also has the same meanings.

B⁵ has the same meanings as B⁴ of the formula (6) and a preferred range also has the same meanings.

A⁵ represents an ionic functional group or an ionic functional group precursor. In a case where A⁵ is the ionic functional group, it has the same meanings as A⁴ of the formula (6) and a preferred range also has the same meanings. In a case where A⁵ is the ionic functional group precursor, A⁵ per se is not the ionic functional group but this is a group transformed into the ionic functional group after polymerization by way of a modifying step or the like. Specifically, as the ionic functional group precursor, an ester group or amide group is preferred and the ester group is particularly preferred. Further, the modifying step in this case is preferably hydrolyzing reaction of the ester group or the amide group.

D³ and D⁴each represents a group comprising a substituted or not-substituted aromatic ring or a single bond and it has the same meanings as D¹ of the formula (6), and a preferred range also has the same meanings.

E⁷ represents a substituent of high oxygen permeability, and has the same meanings as E⁶ of the formula (6), and a preferred range also has the same meanings.

n19, n20, and n21 each preferably is an integer of from 1 to 5.

In a case where n19, n20, and n21 each represents 2 or greater, and A⁵, B⁵ and/or E⁷ are present by two or more, each of A⁵, B⁵and/or E⁷ may be identical or different with each other.

Preferred Examples of the formula (8) and the formula (9) are shown below but the invention is not restricted to them.
Exemplified Compounds for the Compound Represented by the Formula (8) 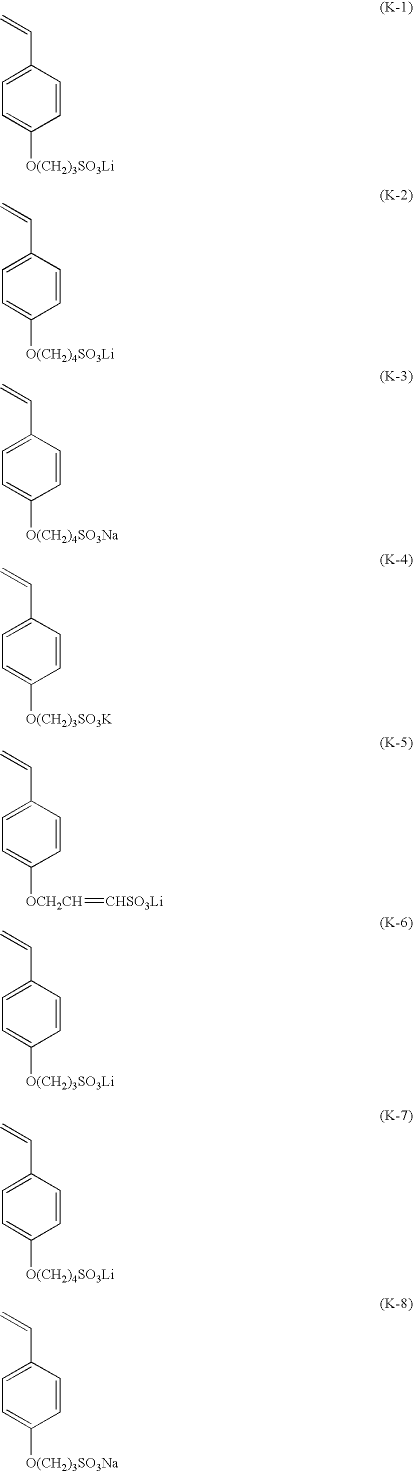 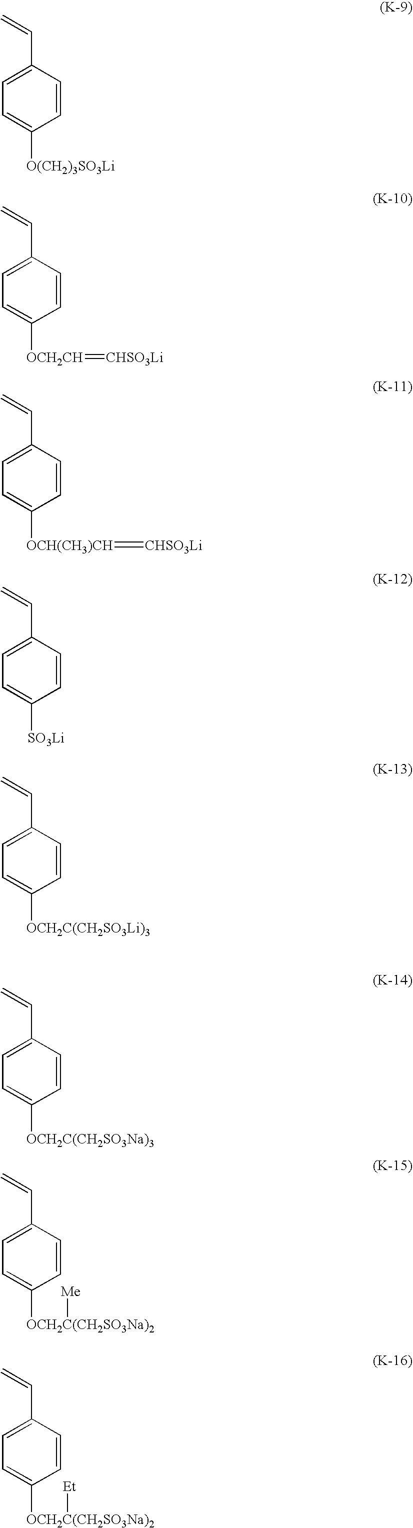 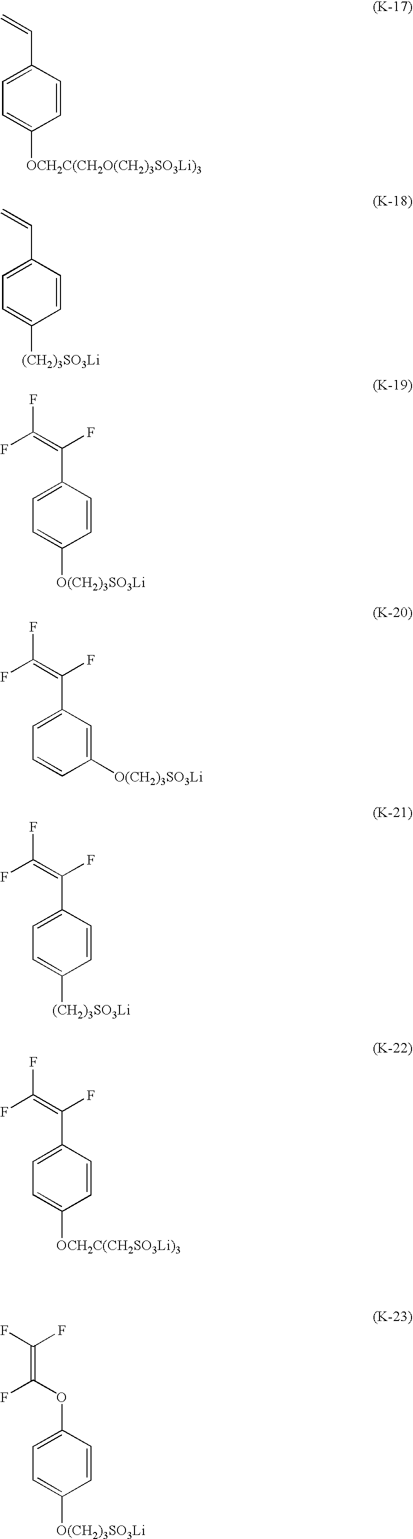 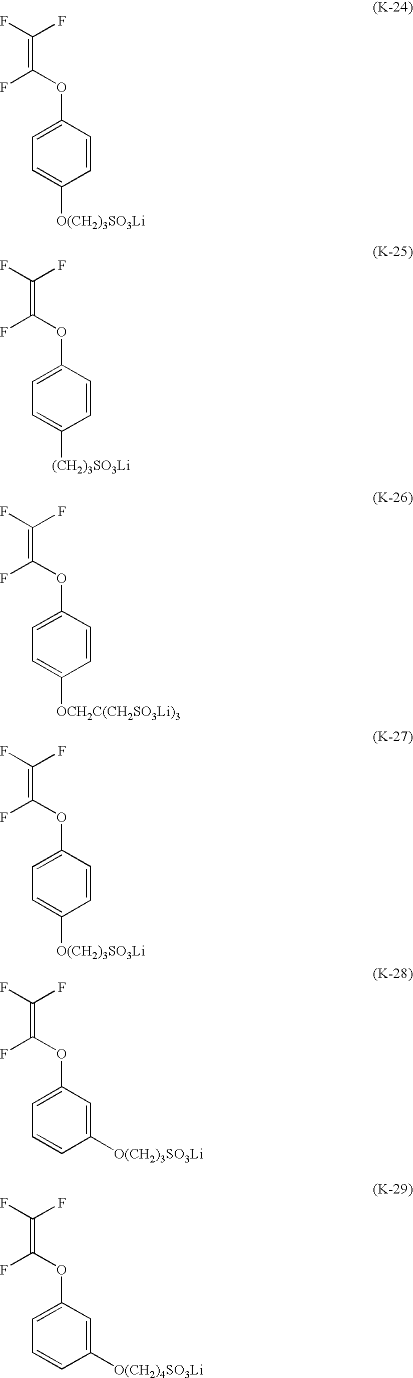 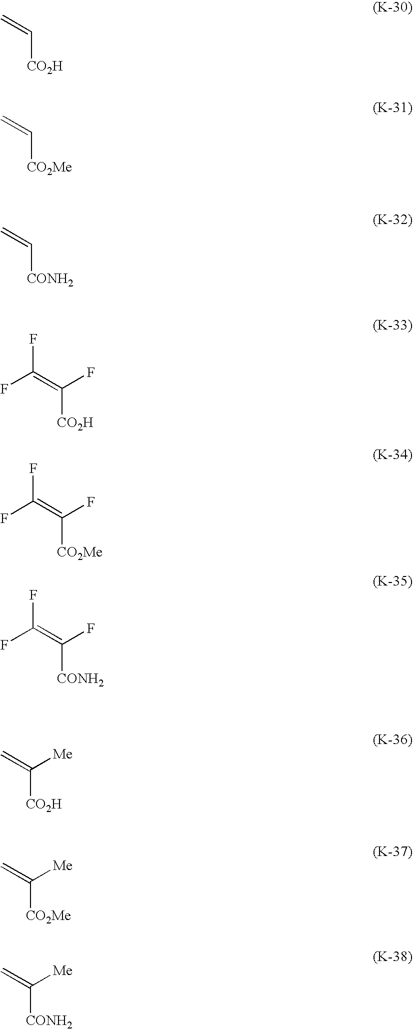
Exemplified Compounds for the Compound Represented by the Formula (9) 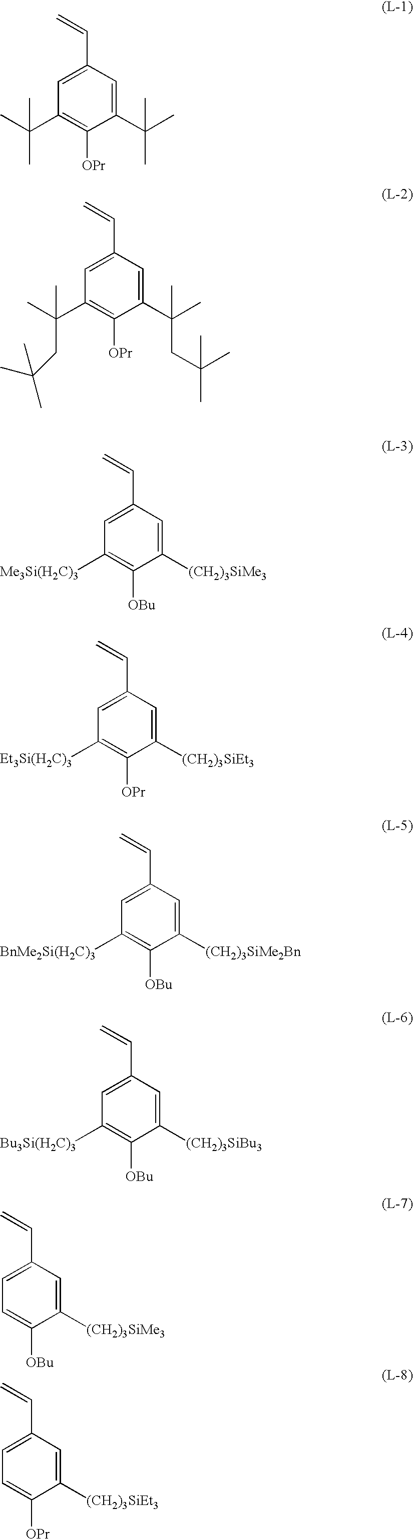 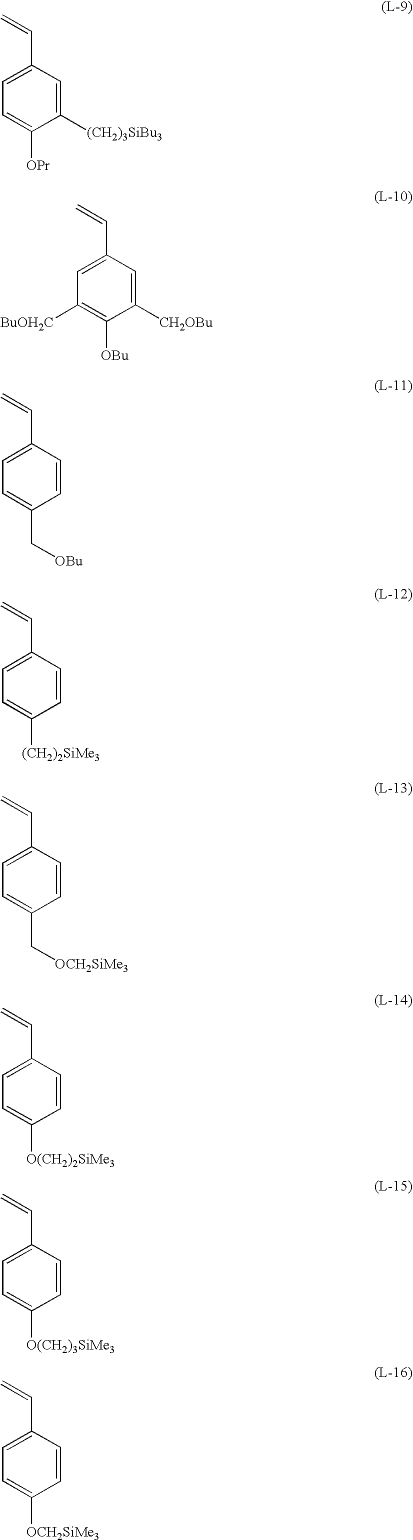 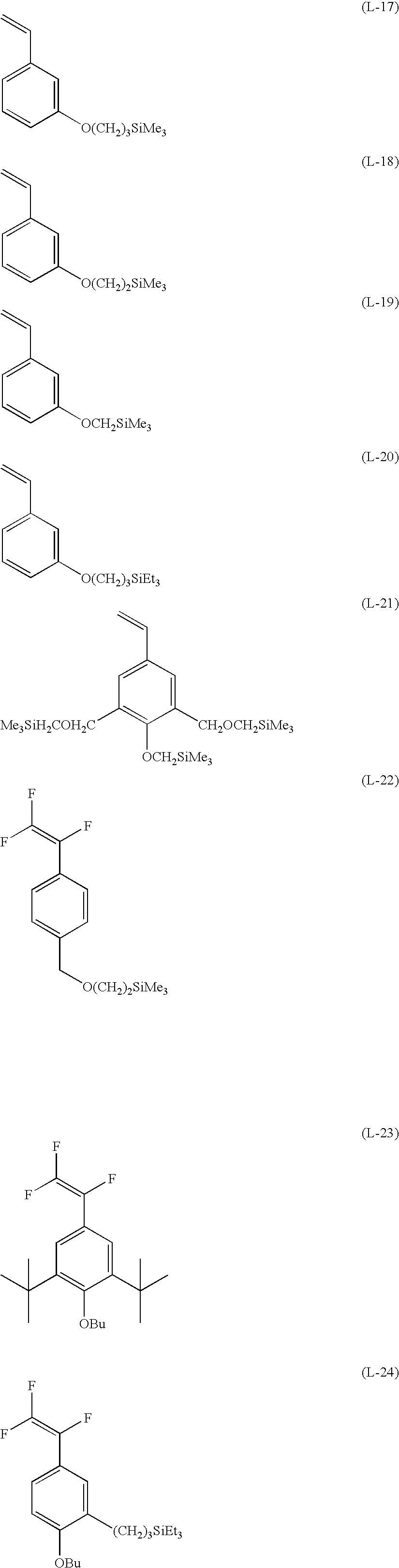 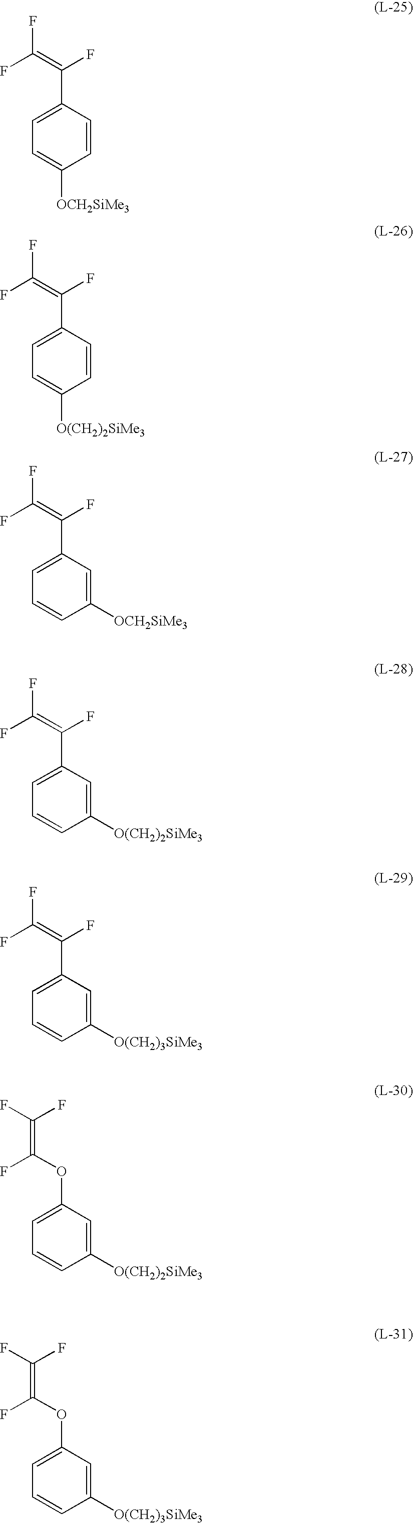 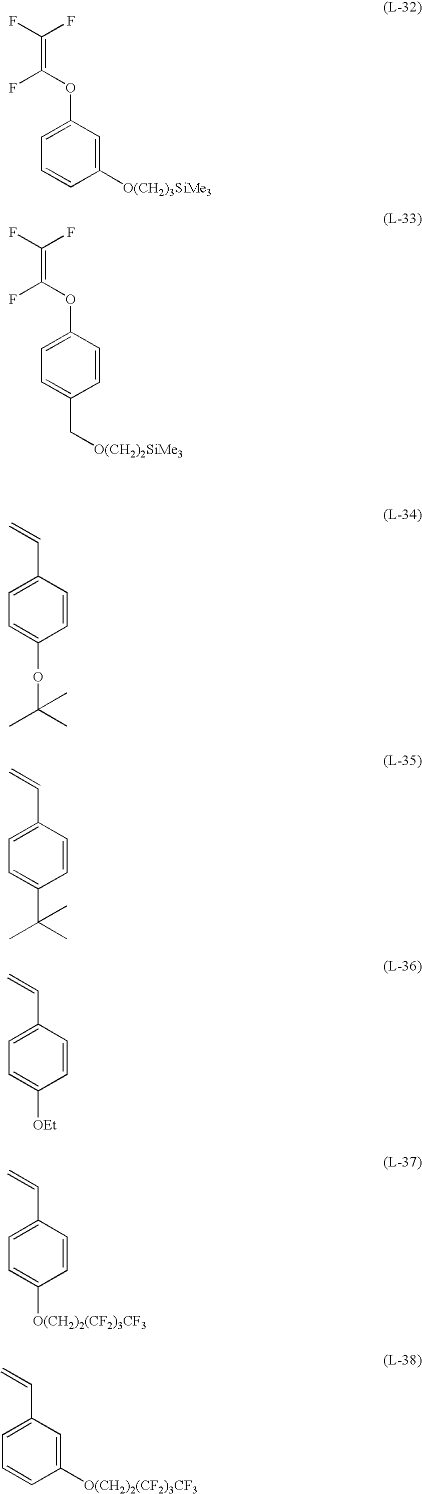
Method G-1

The method G-1 is a method of introducing a connection group having a polymerization initiation point to a carbon material, simultaneously conducting formulation of a polymer series G having a hydrophilic segment comprising a polymer of the compound represented by the formula (8) and a hydrophobic segment comprising a polymer of the compound represented by the formula (9) by atom transfer radical polymerization, stable free radical polymerization, etc. by utilizing the initiation point and connection of the polymer series G to the carbon material. The compound represented by the formula (8) and the compound represented by the formula (9) may be used each alone or two or more of them may be used.

The connection group and the polymerization initiation point can be formed by using a known method such as halogeno alkylation of the aromatic ring described previously.

The initiation point for the atom transfer radical polymerization includes, for example, halogenoalkyl, halogenobenzyl, α-haloketone, α-halonitrile, and sulfonylhalide, and sulfonylhalide and halogenobenzyl are particularly preferred. The initiation point for the stable free radical polymerization includes,
2,2,6,6-tetramethylpiperidinyloxyalkyl,
4-oxo-2,2,6,6-tetramethylpiperidinyloxyalkyl,
4-hydroxy-2,2,6,6-tetramethylpiperidinyloxyalkyl,
4-amino-2,2,6,6-tetramethylpiperidinyloxyalkyl,
2,2,5,5-tetramethylpyrrolidinyloxyalkyl,
N,N-di-tert-butylaminooxyalkyl,
1,1,3,3-tetramethylisoindoline-oxyalkyl, and
N-tert-butyl-N-(2-methyl-1-phenylpropyl)aminooxyalkyl, and
2,2,6,6-tetramethylpiperidinyloxyalkyl and
4-oxo-2,2,6,6-tetramethylpiperidinyloxyalkyl are particularly preferred.

Preferred examples of the initiation point for radical polymerization formed to the carbon material and the connection group with the carbon material are shown below, but the invention is not restricted to them. Lc in compounds represents the connection portion with the carbon material.

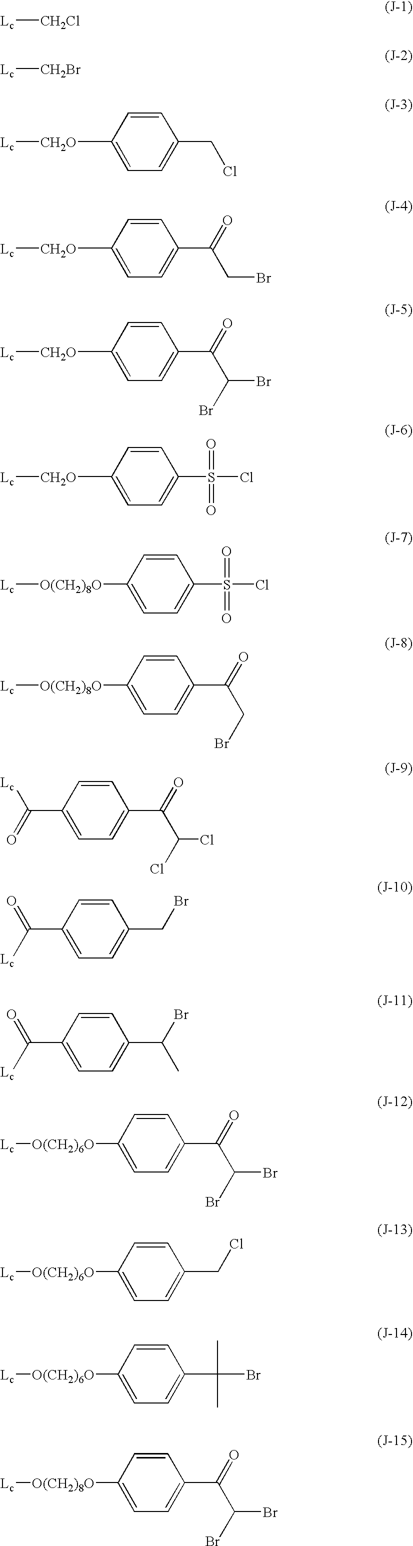

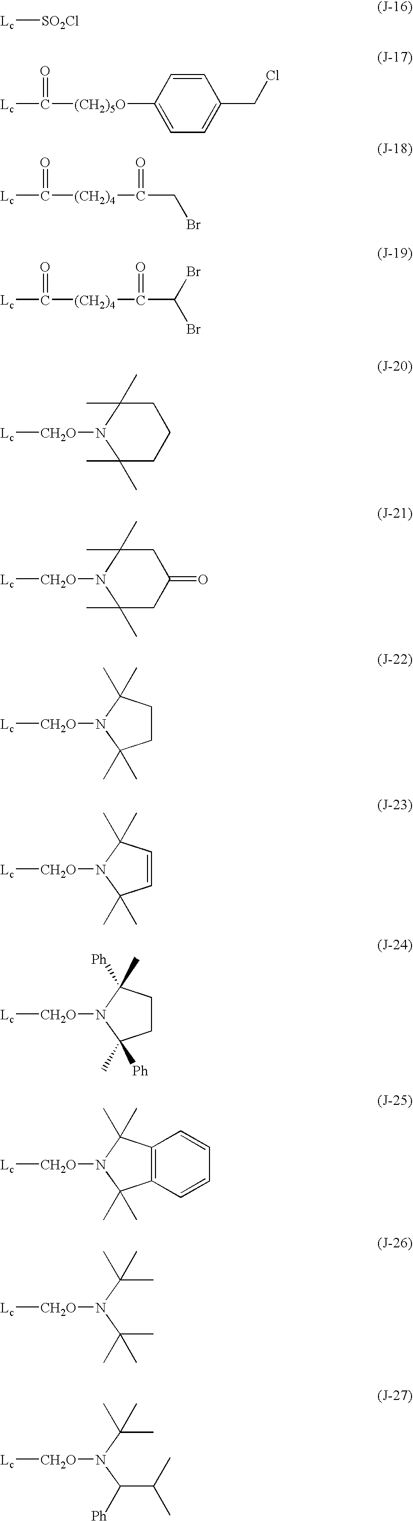

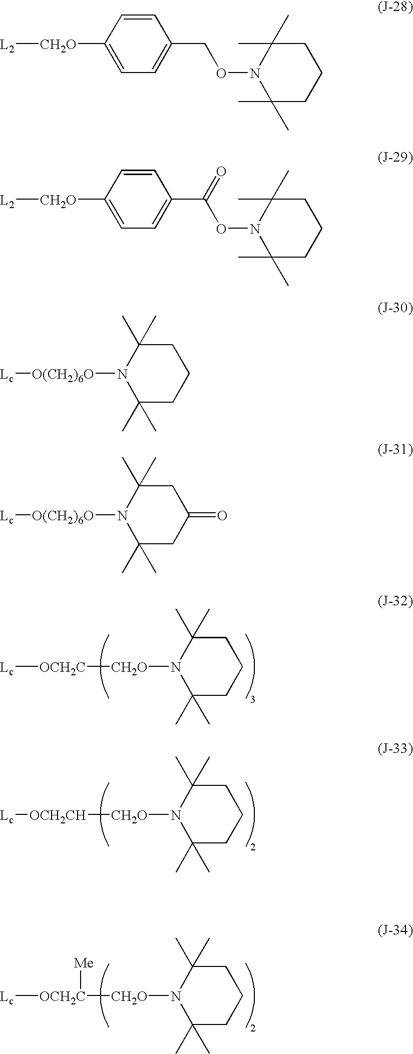

In the reaction of forming each of the segments by atom transfer radical polymerization or stable free radical polymerization, in a case where both of the compound represented by the formula (8) and the compound represented by the formula (9) are present in the reaction system, since the respective compounds are copolymerized at random, segments are not formed. Accordingly, it is preferred to form a polymer series G by conducting the reaction of forming the hydrophilic segment and the reaction of forming the hydrophobic segment alternately thereby increasing the number of segments each by one. The number of segments in the polymer series G upon using the method G-1 is, preferably, from 2 to 20, more preferably, from 2 to 10 and, particularly preferably, from 2 to 5.

Method G-2

The method G-2 is a method of forming a polymer series G having hydrophilic segments comprising a polymer of the compound represented by the formula (8) and hydrophobic segments comprising a polymer of the compound represented by the formula (9) by stable free radical polymerization and connecting the same with a carbon material. In the stable free radical polymerization, initiators include azo-type initiators such as 2,2′-azobis(isobutylonitrile), 2,2′-azobis(2,4-dimethylvaleronitrile), and dimethyl 2,2′-azobis(2-methylpropionate), and peroxide type initiators such as benzoylperoxide and 1,1-bis(tert-butyldioxy)cyclohexane, and the peroxide type initiators are used more preferably. Further, stable free radicals added to the reaction system include, for example, 2,2,6,6-tetramethylpiperidine-1-oxyl(TEMPO), 4-oxo-TEMPO, 4-hycroxy-TEMPO, 4-amino-TEMPO, 4-carboxy-TEMPO, 4-cyano-TEMPO, 2,2,5,5-tetramethylpyrrolidine-1-oxyl, 3-carboxy-2,2,5,5-tetramethylpyrrolidine-1-oxyl, and di-tert-butylnitroxide.

Upon forming the polymer series G, in a case where both of the compound represented by the formula (8) and the compound represented by the formula (9) are present in the reaction system, since the respective compounds are copolymerized at random, segments are not formed. Accordingly, it is preferred to form a polymer series G by conducting the reaction of forming the hydrophilic segment and the reaction of forming the hydrophobic segment alternately thereby increasing the number of segments each by one. The number of segments in the polymer series G upon using the method G-2 is, preferably, from 2 to 100, more preferably, from 2 to 50 and, particularly preferably, from 2 to 20.

As the method of connecting the polymer series G to the carbon material, it is preferred that a stable radical precursor introduced to the polymer terminal end is transformed by heating into a radical and connecting the same by utilizing a radical scavenging performance of the carbon black.

Method D

The method D is a method of connecting a graft polymerized polymer in which at least side chains comprising a hydrophilic segment are grafted to a main chain at least comprising a hydrophobic segment by way of a connection group on the surface of a carbon material. The main chain at least comprising the hydrophobic segment is preferably a segment represented by formula (2). n4 in the formula (2) is, preferably, from 8 to 1,600, more preferably, from 12 to 1,000 and, particularly preferably, from 16 to 800 in the method D. Other structures regarding the formula (2) have the same meanings as the structure of the formula (2) in the method C and a preferred range also has the same meanings.

As the hydrophilic segment grafted to the main chain comprising the formula (2), a hydrophilic segment comprising the formula (6) is preferred. In this case, while only the hydrophilic segments may be grafted, both the hydrophilic segments and the hydrophobic segment may be grafted. As the hydrophobic segment in this case, the hydrophobic segment comprising the formula (7) is preferred. In a case of grafting both the hydrophilic segments and the hydrophobic segments, they may be grafted from different graft initiation points respectively or both of the segments may be grafted in the form of a block copolymer from an identical graft initiation point.

The number of grafted chains is, preferably, from 0.1 to 1, more preferably, from 0.10 to 0.5 and particularly preferably, from 0.25 to 5 per one main chain comprising the formula (2). Further, the ratio X of the hydrophilic segment and the hydrophobic segments to be grafted is, preferably, from 0 to 1, more preferably, from 0 to 0.5 and, particularly preferably, from 0 to 0.4.
X=Number of hydrophobic segments/Number of hydrophilic segments.

In this method, each of n11 in the formula (6) and n18 in the formula (7) is, preferably from 2 to 100, more preferably, from 2 to 50 and, further preferably, from 2 to 20. Other structures regarding the formula (6) and the formula (7) have the same meanings as the structure in the method C and a preferred range also has the same meanings.

The method of forming the graft polymer and connecting the graft polymer to the carbon material includes three kinds of methods, i.e., methods D-1 to D-3, any of which is used preferably

Method D-1

The method D-1 is a method of forming a hydrophobic segment main chain comprising the formula (2), then halogenomethylating the aromatic ring of the main chain, grafting at least the hydrophobic segment comprising the formula (7) to the main chain by atom transfer radical polymerization with the halogenomethyl portion being as a polymerization initiation point and then connecting the polymer to a carbon material.

Method D-2

The method D-2 is a method of forming a hydrophobic segment main chain comprising the formula (2), connecting the same with a carbon material, halogenomethylating the aromatic ring of the polymer main chain connected on the carbon material and grafting at least the hydrophobic segment comprising the formula (7) to the main chain by atom transfer radical polymerization.

Method D-3

The method D-3 is a method of conducting a reaction of forming hydrophobic segments comprising the formula (2) under the presence of a carbon material thereby conducting formation of the hydrophobic segment main chain and the connection of the main chain to the carbon material simultaneously, halogenomethylating the aromatic ring of the main chain and grafting at least the hydrophobic segment comprising the formula (7) to the main chain by atom transfer radical polymerization.

Method E

The method E is a method of connecting a graft polymerized polymer in which side chains at least having hydrophobic segments are grafted to the main chain having hydrophilic segments by way of a connection group on the surface of a carbon material. The main chain at least having the hydrophilic segments preferably comprises the formula (1). In the method E, n3 in the formula (1) is, preferably, from a to 1,600, more preferably, from 12 to 1,000 and, further preferably, from 16 to 800. Other structures concerning the formula (1) has the same meanings as the structures of the formula (1) in the method C and a preferred range also has the same meanings.

As the hydrophobic segment grafted to the main chain comprising the formula (1), the hydrophobic segment comprising the formula (7) is preferred. Only the hydrophobic segment may be grafted or both the hydrophilic segment and the hydrophobic segment may be grafted. In a case of grafting also the hydrophilic segment, the hydrophilic segment comprising the formula (6) is preferred. In a case of grafting both the hydrophilic segment and the hydrophobic segment, they may be grafted from different graft initiation points respectively, or both segments may be grafted in the form of a block copolymerized polymer from an identical graft initiation point.

The number of the grafted chains is, preferably, from 0.1 to 1, more preferably, from 0.1 to 0.5 and, particularly preferably, from 0.25 to 0.5 per one repetitive unit in the formula (1). Further, the ratio Y of the hydrophilic segments and the hydrophobic segments to be grafted is, preferably, from 0 to 1, more preferably, from 0 to 0.5 and, particularly preferably, from 0 to 0.4.
Y=Number of hydrophilic segments/Number of hydrophobic segments

In this method, each of n16 in the formula (6) and n18 in the formula (7) is, preferably from2 to 100, more preferably, 2 to 50 and, further preferably, from 2 to 20. Other structures regarding the formula (6) and the formula (7) have the same meanings as the structure in the method A-1 and a preferred range also has the same meanings.

The method of forming the graft polymer and connecting the graft polymer to the carbon material includes three kinds of methods, i.e., methods E-1 to E-3, any of which is used preferably.

Method E-1

The method E-1 is a method of forming a hydrophilic segment main chain comprising the formula (1), then halogenomethylating the aromatic ring of the main chain, grafting at least the hydrophobic segment comprising the formula (7) to the main chain by the atom transfer radical polymerization with the halogenomethyl portion being as a polymerization initiation point and then connecting the polymer to a carbon material.

Method E-2

The method E-2 is a method of forming a hydrophilic segment main chain comprising the formula (1), connecting the same with a carbon material, halogenomethylating an aromatic ring of a polymer main chain connected on the carbon material and grafting at least the hydrophobic segment comprising the formula (7) onto the main chain by atom transfer radical polymerization.

Method E-3

The method E-3 is a method of conducting a reaction of forming hydrophilic segments comprising the formula (1) under the presence of a carbon material thereby conducting formation of the hydrophilic segment main chain and the connection of the main chain to the carbon material simultaneously, halogenomethylating the aromatic ring of the main chain and grafting at least the hydrophobic segments comprising the formula (7) to the main chain by atom transfer radical polymerization.

Method B

The method B is a method of connecting hydrophilic segments and hydrophobic segments by way of different connection groups to the surface of a carbon material (at different connection points respectively). That is, this means that only one of the hydrophilic segments and hydrophobic segments is connected at a connection point on the carbon surface. For example, this is the structure as described in 2 above. The structures of the hydrophilic segments and the hydrophobic segments introduced to the carbon material by the method B and the method of introducing the segments to the carbon material are to be described specifically.

Structure of Hydrophilic Segment

The hydrophilic segment includes, for example, a segment comprising the formula (1), a segment comprising the formula (6) and a segment comprising the formula (10) each of which can be used preferably. In this case, the segment comprising the formula (1), the segment comprising the formula (6), and the segment comprising the formula (10) may be contained each alone or two or more of them may be contained. The compounds are to be described.

Formula (1)

In the formula (1), n1 is, preferably, from 8 to 3,200, more preferably, from 16 to 1,600 and, particularly preferably, from 32 to 800 in the method B. Other structures regarding the formula (1) have the same meanings as the structure of the formula (1) in the method C and a preferred range also has the same meanings.

Formula (6)

In the formula (6), n16 is, preferably from 8 to 3,200, more preferably, from 16 to 1,600 and, particularly preferably, from 32 to 900 in the method B. Other structures regarding the formula (6) have the same meanings as the structure of the formula (6) in the method C and a preferred range also has the same meanings. 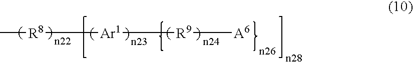
(in the formula (10), R⁸ and R⁹ each represents a bivalent to tetravalent connection group, Ar¹ represents a bivalent to hexavalent connection group comprising an aromatic hydrocarbon group or heterocyclic group. A⁶ represents an ionic functional group, n22, n23, and n24 each represents an integer of 0 or greater, the sum of n22, n23, and n24, is an integer of 1 or greater, n25 is an integer of from 1 to 10, and n26 is an integer of from 1 to 3).

Further, in the formula (10) , the groups described above are determined so as to have solvolysis resistance and heat resistance.

In the formula (10), R⁸ and R⁹ each represents a bivalent to tetravalent connection group and the structure is preferably an aliphatic hydrocarbon group, or a combination of the aliphatic hydrocarbon group and one or more of members selected from the group consisting of functional groups represented by:

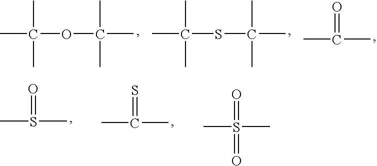

Preferred examples of R⁸ and R⁹include a methylene group, ethylene group, propylene group, butylenes group, hexylene group, octylene group, decylene group, isobutylene group, —CH₂—O—(CH₂)ₙ— (n is an integer of 1 or greater and, preferably, an integer of from 1 to 6), —CH₂CH₂OCH₂CH₂—, —(CH₂CH₂O)₂CH₂CH₂—, —CH₂CH═CH—, —CH₂CH₂CH═CH—, C((CH₂—)ₙ—)₄ (n is an integer of 1 or greater, preferably, each is an integer of from 1 to 6), CH((CH₂)ₙ—)₃ (n is an integer of 1 or greater, preferably, each is an integer of from 1 to 6), CH₃C((CH₂)ₙ—)₃ (n is an integer of 1 or greater, preferably, each is an integer of from 1 to 6), EtC((CH₂)ₙ—)₃ (n is an integer of 1 or greater, preferably, an integer of from 1 to 6), —C((CH₂)ₙ—)₃, (n is an integer of 1 or greater, preferably, each is an integer of 1 to 6), —CH((CH₂)ₙ—)₂ (n is an integer of 1 or greater, preferably, each is an integer of 1 to 6), as well as a combination of them (including a group comprising two or more of the groups in combination) and one or more of the members of —CO—, —SO—, —CS—, —SO₂—, and 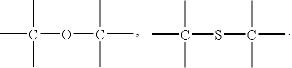
A hydrogen atom may be substituted for a substituent (for example, halogen atom, preferably, fluorine atom) within a range not departing from the gist of the invention.

In the formula (10) , Ar¹ is a bivalent to hexavalent connection group comprising an aromatic hydrocarbon group or a heterocyclic group and, preferably, a group constituted with a combination of the aromatic hydrocarbon group or the heterocyclic group with one or more of —O—, —CO—, —S—, —SO—, —CS—, and —SO₂—.

The number of carbon atoms of the aromatic hydrocarbon group is, preferably, from 6 to 25, more preferably, from 6 to 16 and, further preferably, from 6 to 12. A hydrogen atom on the ring of the aromatic hydrocarbon group may be substituted for a substituent (for example, halogen atom, preferably, fluorine atom, etc.) within a range not departing from the gist of the invention.

The heterocyclic group preferably contains any of sulfur atom, nitrogen atom or oxygen atom, and those comprising the sulfur atom or nitrogen atom are preferred. Further, the number of carbon atoms of the heterocyclic group is, preferably, from 2 to 12 and, more preferably, from 3 to 8. A hydrogen atom on the ring of the heterocyclic group may be substituted for a substituent, (for example, halogen atom, preferably, fluorine atom, etc.), within a range not departing from the gist of the invention.

As Ar¹, specifically, a group comprising a triphenylene ring, pyrene ring, anthracene ring, naphthalene ring, biphenylene ring, or benzene ring, as well as a combination of them with one or more of —O—, —CO—, —S—, —SO—, —CS—, and —SO₂— are preferred, those groups comprising a pyridine ring, furan ring, or thiophene ring, triazine ring, as well as a combination of them with one or more of —O—, —CO—, —S—, —SO—, —CS—, and —SO₂— are preferred. The benzene ring or a group comprising a combination of the benzene ring with one or more of —O—, —CO—, —S—, —CS—, and —SO₂—, or a group comprising a triazine ring is most preferred.

A⁶ represents an ionic functional group, and has the same meanings as A¹ in the formula (1), and a preferred range also has the same meanings.

n22, n23, and n24 each represents an integer of 0 or greater, and the sum for n22, n23, and n24 is an integer of 1 or greater, n22, n23, and n24 each is preferably an integer of 0 to 5, more preferably, an integer from 0 to 2, and, further preferably, an integer of 0 or 1, the sum for n22, n23, and n24 is preferably an integer of from 1 to 10 and, more preferably, an integer of from 1 to 5 and, further preferably, an integer of from 1 to 3. n25 is an integer of from 1 to 10, and, more preferably, an integer of from 1 to 5 and, further preferably, an integer of from 1 to 3, n26 is an integer of from 1 to 3, and, preferably, 1 or 3.

In a case where n22 is 2 or greater, each R⁸ may be identical or different with each other. In a case where n23 is 2 or greater, each Ar¹ may be identical or different with each other. In a case where n24 is 2 or greater, R⁹ may be identical or different with each other. In a case where n25 is 2 or greater, R⁹, n24 and A⁶ may be identical or different with each other, in a case where n26 is 2 or greater, Ar¹, n23, R⁹, n24, A⁶, and n25 may be identical or different with each other.

The total number of carbon atoms in the structure comprising the formula (10) is, preferably, from 2 to 50, more preferably, from 2 to 40 and, further preferably, from 2 to 30.

The formula (10) may be a hydrophilic segment and, at the same time, may function as a connection portion with the carbon material (that is, a role as a connection group). Accordingly, the connection group shown by the compound group B may or may not be interposed between the formula (10) and the carbon material.

Structures comprising the formula (10) are shown below but the invention is not restricted to them. 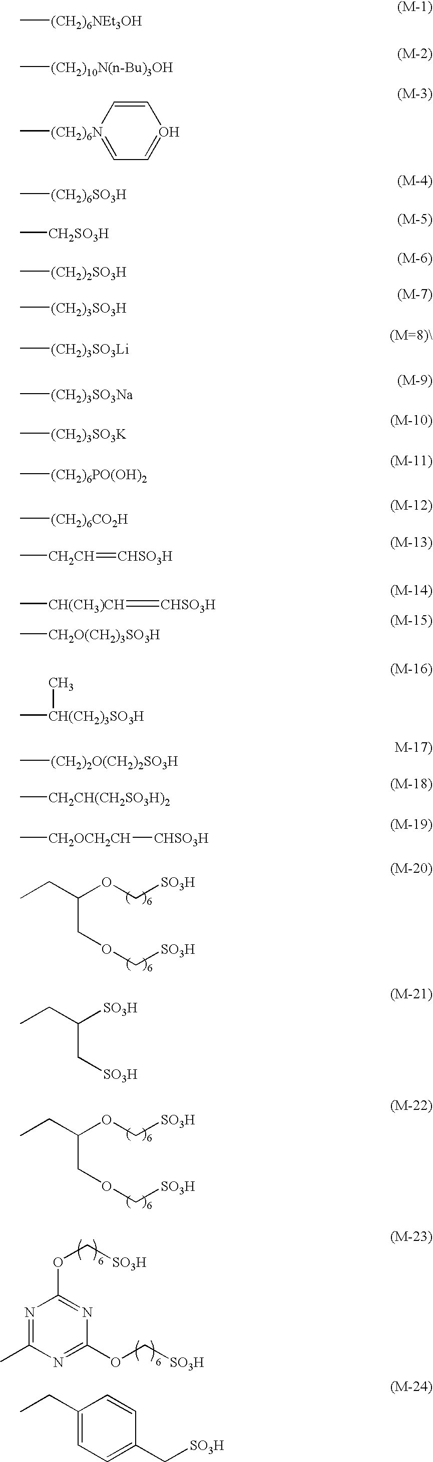 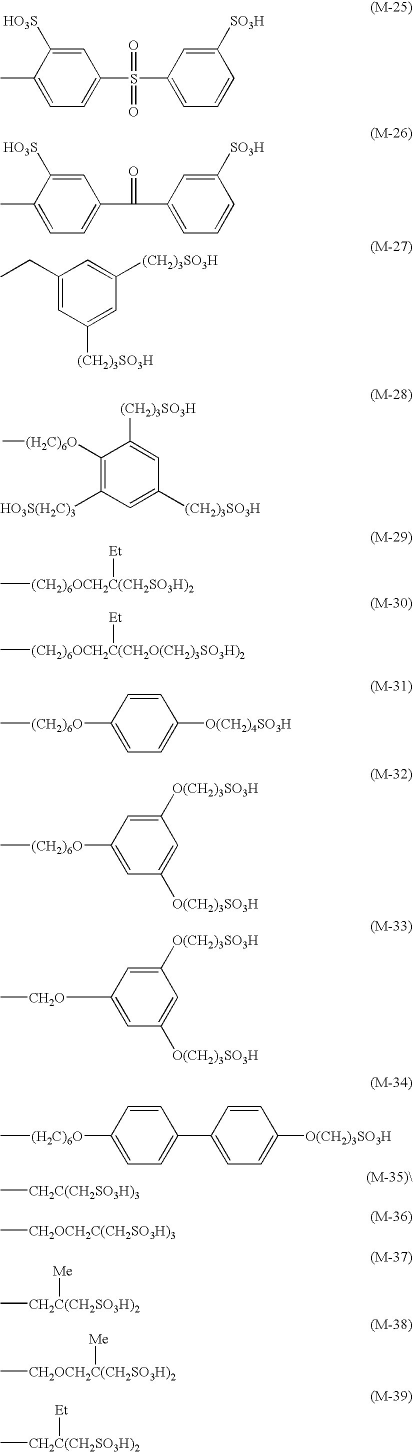 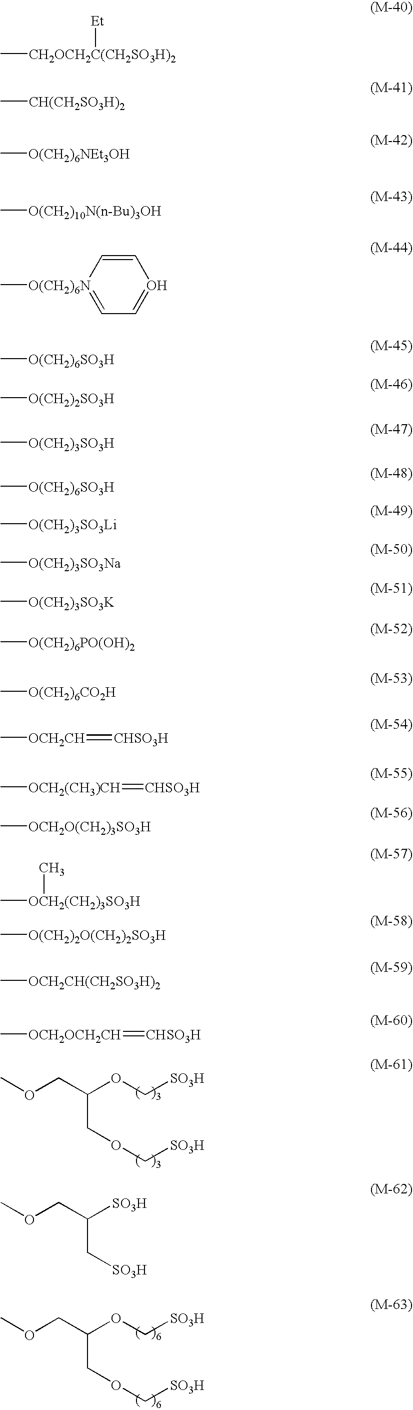 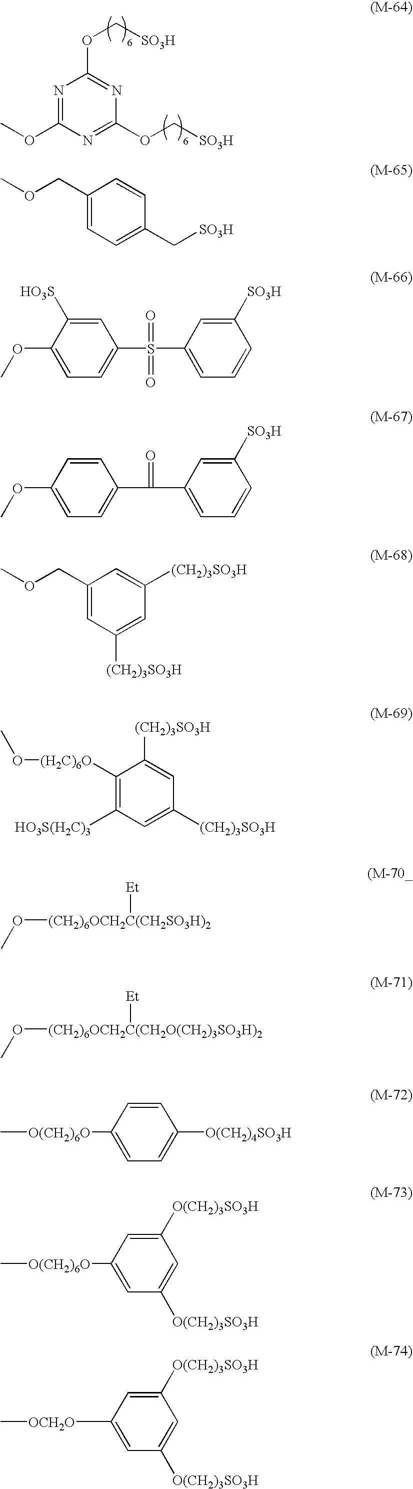 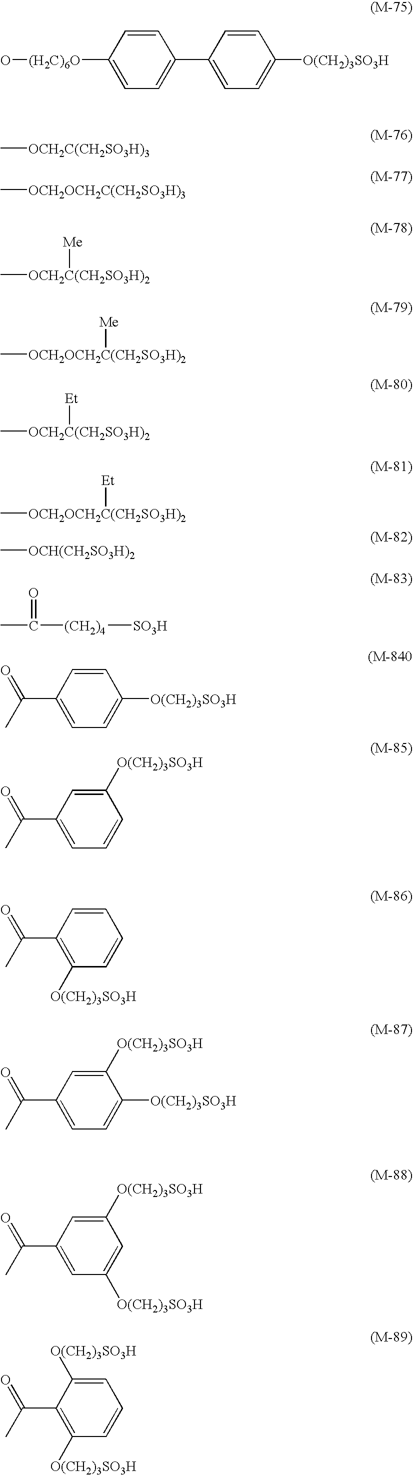
Structure of Hydrophobic Segment

The hydrophobic segment includes the hydrophobic segment comprising the formula (2), the hydrophobic segment comprising the formula (7), and the hydrophobic segment comprising the formula (11), each of which can be used preferably. The hydrophobic segment comprising the formula (2), the hydrophobic segment comprising the formula (7), and the hydrophobic segment comprising the formula (11) may be used each alone or two or more kinds of them may be used. The compounds are to be described.

Formula (2)

In the method B, n4 in the formula (2) is preferably from 8 to 3200, more preferably, from 16 to 1600 and, particularly preferably, from 32 to 800. Other structures regarding the formula (2) have the same meanings as the structure of the formula (2) in the method C and a preferred range also has the same meanings.

Formula (7)

In the method B, n18 in the formula (7) is preferably from 8 to 3200, more preferably, from 16 to 1600 and, particularly preferably, from 32 to 800. Other structures regarding the formula (7) have the same meanings as the structure of the formula (7) in the method C and a preferred range also has the same meanings. 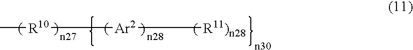
(in the formula (11), R¹⁰ each represents a bivalent to tetravalent connection group, R¹¹ represents a monovalent group not comprising an aromatic ring, Ar² represents a bivalent to hexavalent connection group comprising an aromatic hydrocarbon group or heterocyclic group. n27 represents an integer of 1 or greater, n28 and n29 each represents an integer of 0 or greater and n30 represents an integer of 1 to 3).

Further, in the formula (11), the groups are determined so as to have solvolysis resistance and heat resistance.

In the formula (11), R¹⁰ has the same meanings for R⁸ and R⁹ in the formula (10), and a preferred range also has the same meanings. Ar² has the same meanings as Ar¹ of the formula (10) and a preferred range also has the same meanings. R¹¹ represents a monovalent group not comprising the aromatic ring and the structure is, preferably, an aliphatic hydrocarbon group or a combination of the aliphatic hydrocarbon group with one or more members selected from the group consisting of groups represented by 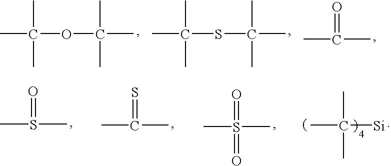
In the aliphatic hydrocarbon carbon group, a hydrogen atom may be substituted for a halogen atom (fluorine atom, chlorine atom, etc., chlorine atom being preferred).

Preferred examples of R¹¹ include methyl group, trifluoromethyl group, ethyl group, propyl group, butyl group, pentyl group, hexyl group, octyl group, decyl group, isobutyl group, tert-butyl group, methylene group, ethylene group, propylene group, butylene group, hexylene group, octylene group, —CH₂—O—(CH₂)ₙ— (n is an integer of from 1 or greater, preferably, an integer of 1 to 6), —CH₂CH₂OCH₂CH₂—, —(CH₂CH₂O)₂CH₂CH₂—, —CH₂CH═CH—, —CH₂CH₂CH—CH—, C((CH₂)ₙ—)₄ (n is an integer of 1 or greater, preferably, an integer from of 1 to 6) , CH((CH₂)ₙ—)₂ (n is an integer of 1 or greater, preferably, an integer of from 1 to 6), CH₃C((CH₂)ₙ—)₃ (n is an integer of 1 or greater, preferably, an integer of from 1 to 6), EtC((CH₂)ₙ—)₃ (n is an integer of 1 or greater, preferably, an integer of from 1 to 6) , —C((CH₂)ₙ—)₃ (n is an integer of 1 or greater, preferably, an integer of from 1 to 6), —CH((CH₂)ₙ—)₂ (n is an integer of 1 or greater, preferably, an integer of from 1 to 6), as well as a combination of them (comprising groups comprising two or more combinations of the groups), and one or more of —CO—, —SO—, —CS—, —SO₂—, 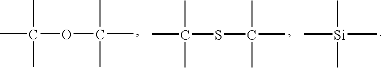
Hydrogen atoms in them may be substituted for halogen atoms (fluorine atom, chlorine atom, etc. with the fluorine atom being preferred).

More specifically, R¹¹ is preferably a methyl group, ethyl group, trifluoromethyl group, and a substituent of high oxygen permeability. The substituent of high oxygen permeability means a substituent having a negative permacall value of the substituent and having three or more carbon atoms.

n27 and n28 each represents an integer of 0 or greater and n29 represents an integer of 1 or greater. n27 and n28 represents preferably an integer of from 0 to 5, more preferably, an integer of from 0 to 3 and, further preferably, an integer of from 0 to 2. n29 represents, preferably, from 1 to 5 and, more preferably, 1 to 3 and, further preferably, 1 to 2. The sum for n27, n28 and n29 represents preferably an integer of from 1 to 10, and, more preferably, an integer of from 1 to 8 and, further preferably, an integer of from 1 to 5. n30 represents an integer of from 1 to 3 and, more preferably, 1 or 3.

In a case where n27 represents 2 or greater, R¹⁰ each may be identical or different with each other. In a case where n28 is 2 or greater, Ar² may be identical or different with each other. In a case where n29 is 2 or greater, R¹¹ each may be identical or different with each other. In a case where n30 is 2 or greater, Ar², n28, R¹¹, and n29 may be identical or different with each other.

The number of total carbon atoms in the structure comprising the formula (11) is, preferably, from 2 to 50, more preferably, from 2 to 40 and, further preferably, from 2 to 30.

Structures comprising the formula (11) are shown below but the invention is not restricted to them. 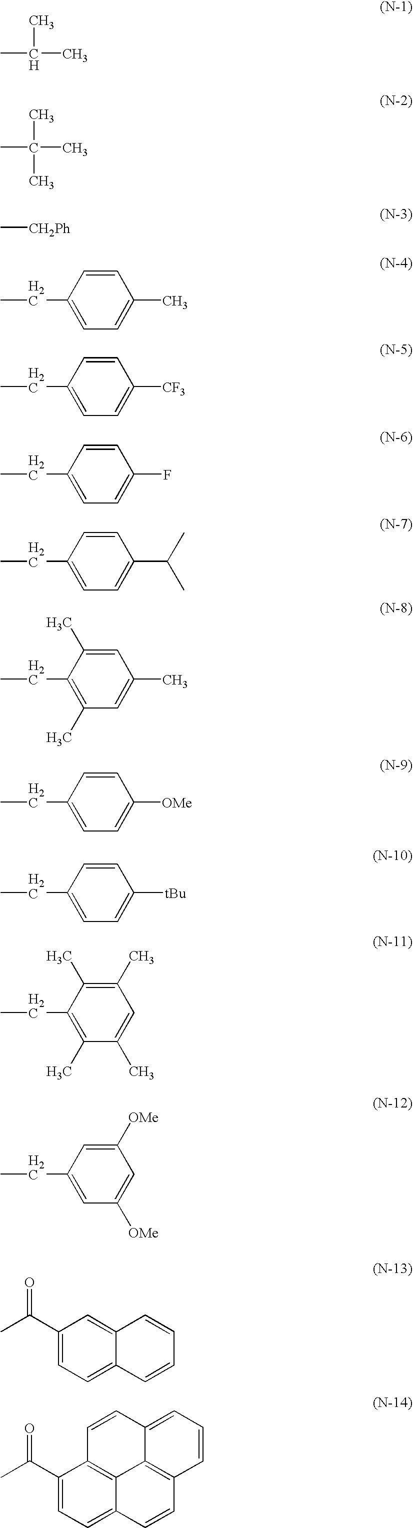 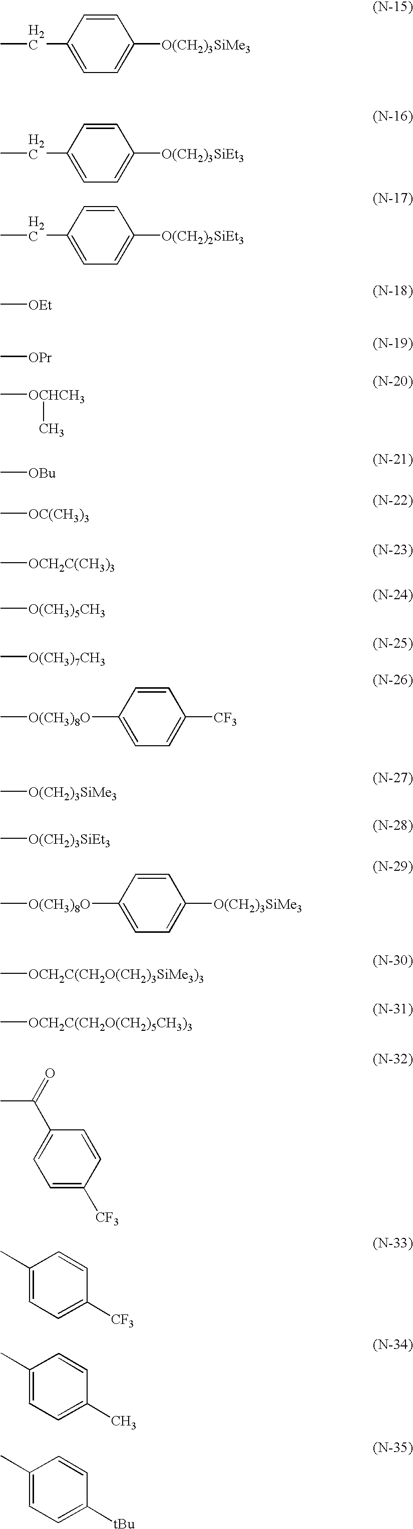 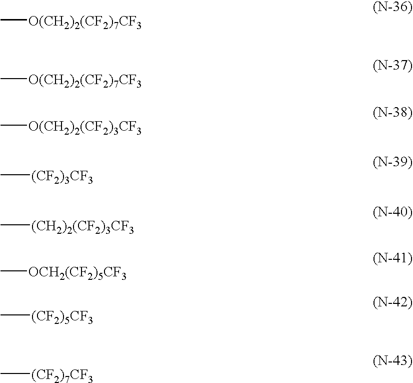
Method of Introducing Hydrophilic Segment and Hydrophobic Segment to Carbon Material

Upon introduction of hydrophilic segments and hydrophobic segments to a carbon material, the method can be classified in the three introduction methods depending on the functional groups of the carbon material concerning the introduction reaction.

### INTRODUCTION METHOD 1

A method of introducing each of segments by way of a phenolic hydroxyl group on the surface of carbon material.

### INTRODUCTION METHOD 2

A method of introducing each of segments by substituting hydrogen atoms on the aromatic ring at the carbon surface by an electron attracting substitution reaction.

### INTRODUCTION METHOD 3

A method of scavenging carbon radicals generated in each of the segments utilizing the radical scavenging property of the carbon material thereby connecting and introducing each of the segments by a carbon-carbon bond or carbon-oxygen bond.

The three types of introduction methods can be used preferably to any of the hydrophilic segment and the hydrophobic segment. Further, when each of the segments is introduced to the carbon material, the three types of the introduction methods may be used in plurality. Further, both of the hydrophilic segment and the hydrophobic segment may be introduced by an identical introduction method (hereinafter, the introduction method is referred to as introduction method 4), or they may be introduced respectively by different introduction methods (hereinafter the introduction method is referred to as introduction method 5). The introduction methods 4 and 5 are to be described specifically.

### INTRODUCTION METHOD 4

The introduction method 4 is a method of introducing the hydrophilic segment and the hydrophobic segment by an identical introduction method to a carbon material. In this case, functional groups of an identical type on the carbon material surface are used upon introduction of the hydrophilic segment and upon introduction of the hydrophobic segment, and the introduction reactions for the respective segments are reaction of an identical type. Accordingly, by the use of the introduction method 4, both the hydrophilic segment and the hydrophobic segment can be introduced into the carbon material by the reaction for once.

### INTRODUCTION METHOD 5

The introduction method 5 is a method of introducing the hydrophilic segment and the hydrophobic segment by different introduction methods respectively. In this case, reaction is necessary at least twice for introducing both of the segments to the carbon material but this is preferred since the introduction amount of both of the segments to the carbon material is increased compared with the introduction method 4.

Supporting Method for Catalyst Particle

The catalyst material for use in the fuel cell of the invention is used preferably as a support for a catalyst metal (electrode catalyst) such as platinum particles. The method of supporting the catalyst metal includes a heat reducing method, sputtering method, pulse laser deposition method, vacuum vapor deposition method, etc. (for example, refer to WO2002/054514).

In the invention, the method of manufacturing a catalyst material for use in the fuel cell includes a method of introducing an ionic functional group to a carbon material and then supporting the catalyst metal, and a method of supporting the catalyst metal on the carbon material and then introducing the ionic functional group, each of which can be used preferably. Further, the material is obtained also by introducing ionic functional groups to commercially available catalyst supporting carbon material (for example, platinum supporting ketchen black, manufactured by Tanaka Kikinzolu Kogyo Co., or platinum supporting XC-72, manufactured by E-TEK Co.).

In a case of introducing the ionic functional group after supporting the catalyst metal to the catalyst material for use in the fuel cell, or in a case of introducing the ionic functional group to the commercially available carbon material supporting catalyst, a method of conducting reaction under oxygen free condition, a method of conducting reaction in a flame retardant solvent, or a method of adding a flame retardant in the reaction system is preferred in view of safety. The method of conducting the reaction under the oxygen-free condition includes a method of conducting the reaction in an inert gas atmosphere, and the inert gas includes, for example, helium, argon, neon, and nitrogen, argon and nitrogen being particularly preferred.

The flame retardant solvent includes dichloromethane, chloroform, carbon tetrachloride, 1,1,1-trichloroethane, 1,1,2-trichloroethane, 1,1,1,2-tetrachloroethane, 1,1,2,2-tetrachloriethane, water, etc. They are properly selected and used while considering the solubility of the reaction reagents, temperature of the reaction, boiling point of the solvent, etc. Further, the solvents may be used each alone or a plurality of them may be used in admixture.

The frame retardant includes those phosphate ester type flame retardants such as hexamethyl phosphor amide, trimethyl phosphate, triethyl phosphate, tricresyl phosphate, trixylenyl phosphate, cresyldiphenyl phosphate, bisphenol A bis(diphenyl)phosphate, hydroquinol bis(diphenyl)phosphate, phenyldixylenyl phosphate, xylenyldiphenyl phosphate, resorciyl bis(diphenyl)phosphate, 2-ethylhexyldiphenyl phosphate, etc. They may be used each alone or a plurality of them may be used in admixture. The ratio of adding the flame retardant to the reaction solvent is, preferably, 5% or more, more preferably, 10% or more and, particularly preferably, 15% or more. Further, among the flame retardants described above, liquid flame retardants may be used as a reaction solvent.

The catalyst material for use in the fuel cell of the invention may be constituted only with a catalyst material in which both the hydrophilic segment and the hydrophobic segment are introduced to the surface (hereinafter, such catalyst material is described as catalyst material X), or a mixture of the catalyst material X and a catalyst material having neither the hydrophilic segment nor the hydrophobic segment on the surface (hereinafter, such catalyst material is described as catalyst material Y) may also be used. In a case of utilizing the mixture of the catalyst material X and the catalyst material Y, it is known that corrosion of the catalyst material X is suppressed by the sacrificial corrosion of the catalyst material Y to provide excellent durability (JP-A No. 2005-190724). In a case of utilizing the mixture of the catalyst material X and the catalyst material Y, the content of the catalyst material X is, preferably, from 50 to 95% by weight, more preferably, from 70 to 95% by weight and, particularly preferably, from 80 to 95% by weight.

The catalyst material for use in the fuel cell of the invention can be used as electrodes for use in the fuel cells, as membrane and electrode assemblies (hereinafter referred to as MEA), and fuel cells using the MEA.

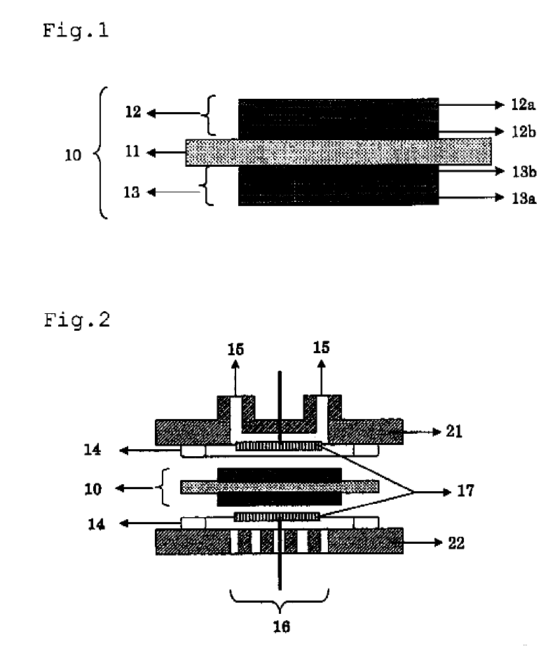

FIG. 1 shows an example of a schematic cross sectional view of a membrane and electrode assembly of the invention. MEA 10 has a solid electrolyte film 11, and an anode electrode 12 and a cathode electrode 13 which are opposed to each other while sandwiching the electrolyte membrane. The solid electrolyte membrane referred to herein includes films of perfluorocarbon sulfonic acid polymers typically represented by Nafion (registered trade mark), heat resistant aromatic polymers such as poly(meta)acrylate comprising phosphonic acid groups on the side chains, sulfonated polyether ether ketone, sulfonated polyether ketone, sulfonated polyether sulfone, sulfonated polysulfone, and sulfonated polybenzimidazole, sulfonated polystyrene, sulfonated polyoxetane, sulfonated polyimide, sulfonated polyphenylene sulfide, sulfonated polyphenylene oxide, and sulfonated polyphenylene and they include, specifically, those described in JP-A Nos. 2002-110174, 2002-105200, 2004-10677, 2003-132908, 2004-179154, 2004-175997, 2004-247182, 2003-147074, 2004-234931, 2002-289222, and 2003-208816.

The anode electrode 12 and the cathode electrode 13 comprise porous conductive sheets (for example, carbon paper) 12a, 13a, and catalyst membranes 12b, 13b. For the catalyst membranes 12b, 13b, the catalyst membrane of the invention can be used. The catalyst membrane of the invention comprises a dispersion formed by dispersing the catalyst material for use in the fuel cell of the invention that supports a catalyst metal such as platinum particles dispersed in a solid electrolyte.

A method of manufacturing the electrode is to be described. A solid electrolyte typically represented by Nafion is dissolved in a solvent and a liquid dispersion mixed with a catalyst material for use in the fuel cell of the invention that supports a catalyst metal is dispersed. For the solvent of the liquid dispersion, heterocyclic compounds (3-methyl-2-oxazolidinone, N-methylpyrrolidone, etc.), cyclic ethers (such as dioxane, tetrahydrofuran, etc.), linear ethers (such as diethylether, ethyleneglycol dialkylether, propyleneglycol dialkylether, polyethyleneglycol dialkylether, polypropyleneglycol dialkylether, etc.), alcohols (such as methanol, ethanol, isopropanol, ethyleneglycol monoalkylether, propyleneglycol monoalkylether, polyethyleneglycol monoalkylether, polypropyleneglycol monoalkylether, etc.), polyhydric alcohols (such as ethyleneglycol, propylene glycol, polyethylene glycol, polypropylene glycol, glycerin, etc.), nitrile compounds (such as acetonitrile, glutalodinitrile, methoxyacetonitrile, propionitrile, benzonitrile, etc.), non-polar solvents (such as toluene, xylene, etc.), chlorine type solvents (such as methylene chloride, ethylene chloride, etc.), amides (such as N,N-dimethylformamide, N,N-dimethylacetoamide, acetamide, etc.), water, etc. are used preferably. Among them, the heterocyclic compounds, alcohols, polyhydric alcohols, and amides are used preferably.

The dispersion method may be a method by stirring but ultrasonic dispersion, ball mill, etc. can also be used. The obtained liquid dispersion can be coated by using a coating method such as a curtain coating method, extrusion coating method, roll coating method, spin coating method, dip coating method, bar coating method, spray coating method, slide coating method, or printing coating method.

Coating of the liquid dispersion is to be described. In the coating step, a film maybe formed by extrusion molding using the liquid dispersion described above, or the film may also be formed by casting or coating the liquid dispersion described above. While the support in this case is not particularly restricted, preferred examples include, for example, a glass substrate, metal substrate, polymer film, and reflection plate. The polymer film includes cellulosic polymer films such as of triacetyl cellulose (TAC), ester type polymer films such as of polyethylene terephthalate (PET), polyethylene naphthalate (PEN), etc., fluoropolymer films such as of polytrifluoroethylene (PTFE), and polyimide film. The coating system may be a known method and, for example, curtain coating method, extrusion coating method, roll coating method, spin coating method, dip coating method, bar coating method, spray coating method, slide coating method, printing coating method, etc. can be used. Particularly, in a case of using a conductive porous body (carbon paper, carbon cloth) as the support, a catalyst electrode can be manufactured directly.

The operations described above can also be conducted by a film molding machine using rolls such as calender rolls, or cast rolls, or T dies, or may be conducted by press molding using a press equipment. Further, a stretching step may be added for controlling the film thickness and improving the film property.

The drying temperature for the coating step is concerned with the drying speed and can be selected in accordance with the property of the material. It is, preferably, from −20° C. to 150° C., more preferably, from 20° C. to 120° C. and, further preferably, from 50° C. to 100° C. While a shorter drying time is preferred in view of the productivity, in a case where the time is excessively short, it causes defects such as bubbles and surface unevenness. Accordingly, the drying time is, preferably, from 1 min to 48 hr, more preferably, from 5 min to 10 hrs and, further preferably, from 10 min to 5 hrs. Further, control for the humidity is also important and it is preferably from 25 to 100% RH and, more preferably, from 50 to 95% RH.

For the coating solution (liquid dispersion) in the coating step, those with less content of metal ions are preferred and, particularly, those with less transition metal ions, among all, iron ions, nickel ions and cobalt ions are preferred. The content of the transition metal ions is, preferably, 500 ppm or less and, more preferably, 100 ppm or less. Accordingly, also for the solvent used in the step described above, those with less content of such ions are preferred.

Further, a surface treatment may be applied after the coating step. As the surface treatment, surface roughening treatment, surface cutting treatment, surface removing treatment, and coating treatment may be conducted and they can sometimes improve the adhesion with the solid electrolyte membrane or the porous conductor.

The thickness of the catalyst membrane in the electrode assembly of the invention is, preferably, from 5 to 200 μm and, particularly preferably, from 10 to 100 μm.

For closely adhering the catalyst membranes 12b, 13b to the solid electrolyte membrane 11, a method of press bonding the catalyst membranes 12b, 13b coated on the porous conductive sheets 12a, 13a to the solid electrolyte membrane 11 by hot pressing (preferably at 120 to 130° C., 2 to 100 kg/cm²) or press bonding the catalyst membranes 12b, 13b coated on an appropriate support to the solid electrolyte 11 while transferring them and then sandwiching the same between the porous conductive sheets 12a and 13a is generally used preferably.

FIG. 2 shows an example of a fuel cell structure. The fuel cell has MEA 10, a pair of separators 21 and 22 sandwiching the MEA 10, and collectors 17 each comprising a stainless steel nets and packings 14 attached to separators 21, 22. Openings 15 on the side of the anode electrode are formed in the separator 21 on the anode side, and openings 16 on the cathode sides are formed in the separator 22 on the cathode side. A gas fuel such as hydrogen or alcohols (methanol, etc.) or a liquid fuel such as an aqueous alcohol solution is supplied from the openings 15 on the anode side, and an oxidizer gas such as an oxygen gas or air is supplied from the openings 16 on the cathode side.

For the anode electrode and the cathode electrode, the catalyst material for use in the fuel cell of the invention is used. The particle size of the active metal used usually is within a range preferably from 2 to 10 nm. By decreasing the particle size, the surface area per unit mass can be increased and the activity is increased further and this is advantageous. On the other hand, by increasing the particle size to some extent, agglomeration of particles that make them less dispersible can be prevented more effectively.

The activity polarization in the hydrogen-oxygen type fuel cell is larger at the cathode electrode (air electrode) compared with that al the anode electrode (hydrogen electrode). This is because the reaction on the cathode electrode (reaction of oxygen) is slower compared with that on the anode electrode. With an aim of improving the activity of the oxygen electrode, various platinum based binary metals such as Pt—Cr, Pt—Ni, Pt—Co, Pt—Cu, and Pt—Fe can be used preferably. In a direct methanol fuel cell of using an aqueous methanol solution for the anode fuel, it is important to suppress the catalyst poisoning due to CO evolved in the oxidizing process of methanol. For this purpose, platinum-based binary metals such as Pt—Ru, Pt—Fe, Pt—Ni, Pt—Co, and Pt—Mo, and platinum-based ternary metals such as Pt—Ru—Mo, Pt—Ru—W, Pt—Ru—Co, Pt—Ru—Fe, Pt—Ru—Ni, Pt—Ru—Cu, Pt—Ru—Sn, and Pt—Ru—Au can be used preferably.

As the carbon material for supporting the active metal, the catalyst material for use in the fuel cell of the invention is used preferably.

The function of the catalyst membrane resides in (1) transporting a fuel to an active metal, (2) providing reaction sites for oxidation (anode) and reduction (cathode) of the fuel, (3) conducting electrons generated by oxidation/reduction to the collector, (4) transporting protons generated by reaction to the solid electrolyte. For the function (1), it is necessary that the catalyst membrane is porous so that liquid and the gas fuels can permeate deeply. The active metal catalyst described above serves for the function (2) and the catalyst material for use in the fuel cell of the invention serves for the function (3). While the catalyst material for use in the fuel cell of the invention serves for the function (4), it is preferred that the solid electrolyte is present together in the catalyst membrane in order to provide sufficient function.

The solid electrolytes for the catalyst membrane has no particular restriction so long as they are solids comprising the proton donating groups and polymer compounds comprising acid residual groups used for the solid electrolytes (for example, perfluorocarbon sulfonic acid typically represented by Nation, and heat resistant aromatic polymers such as (poly(meth)acrylate comprising phosphoric acid groups on the side chain, sulfonated polyether ether ketone, and sulfonated polybenzimidazole) are used preferably. Use of the same kind of material as that of the solid electrolyte membrane 11 is more advantageous since the electrochemical adhesion between the solid electrolyte membrane and the catalyst membrane is enhanced.

The amount of the active metal used is suitably within a range from 0.03 to 10 mg/cm² with the view point of the cell power and the economicity. The amount of the catalyst material for use in the fuel cell supporting the active metal is suitably from 1 to 10 times the mass of the active metal. The amount of the solid electrolyte is, preferably, from 0.1 to 7 times and, more preferably, from 0.3 to 3 times the mass of the catalyst material for use in the fuel cell of the invention.

Member referred to as an electrode substrate, permeation layer or backing material and having a function of preventing worsening of the collection function and permeation of gas caused by water deposition may be disposed. Usually, carbon paper or carbon cloth is used and those applied with a PTFE treatment can also be used for the purpose of water repellency.

For the manufacture of MEA, the following four methods are preferred.

(1) Catalyst Layer Coating Method:

A catalyst membrane coating solution (ink) comprising a catalyst material for use in the fuel cell of the invention, a solid electrolyte, and a solvent is directly coated on both sides of a solid electrolyte membrane, to which porous conductive sheets are (hot) pressed to manufacture an MEA of 5-layered structure.

(2) Porous Conductive Sheet Coating Method:

After coating a catalyst membrane coating solution to the surface of a porous conductive sheet to form a catalyst membrane, which is then press bonded with a solid electrolyte membrane to manufacture an MEA of 5-layered structure.

(3) Decal Method:

After coating a catalyst membrane coating solution on PTFE to form a catalyst membrane, and then only the catalyst membrane is transferred to a solid electrolyte membrane to form an MEA of 3-layered structure, to which porous conductive sheets are press bonded to manufacture an MEA of 5-layered structure.

(4) Catalyst Post-Supporting Method:

After coating a catalyst membrane coating solution formed by mixing a catalyst material for use in the fuel cell of the invention not supporting platinum with a solid electrolyte on a solid electrolyte membrane, porous conductive sheet, or PTFE to form a film, and then platinum ions are impregnated in the solid electrolyte membrane and platinum particles are precipitated by reduction in the film to form a catalyst membrane. After forming the catalyst membrane, an MEA is manufactured by the methods (1) to (3) described above.

Fuels usable for fuel cells that use the catalyst material for use in the fuel cell of the invention include, as anode fuels, hydrogen, alcohols (methanol, ethanol isopropanol, ethyleneglycol, etc.), ethers (dimethylether, dimethoxymethane, trimethoxymethane, etc.), formic acid, hydrogenated boron complex, and ascorbic acid. Hydrogen and methanol are particularly preferred. The cathode fuel includes, for example, oxygen (also including oxygen in atmospheric air), and hydrogen peroxide.

The method of supplying the anode fuel and the cathode fuel to the respective catalyst membranes includes two methods, that is, (1) a method of compulsorily circulation by using an auxiliary equipment such as a pump (active type), and (2) a method of not using the auxiliary equipment (passive type, for example, by capillary phenomenon or spontaneous dropping in a case of a liquid, or exposing the catalyst membrane to an atmospheric air thereby supplying a gas in a case of the gas). The methods can also be combined. The active type capable of obtaining high power is preferred.

Since the unit cell voltage of the fuel cell is generally 1 V or lower, unit cells are stacked in series upon use in accordance with the necessary voltage of a load. As a stacking method, “planar stacking” of arranging the unit cells on a plane and “bipolar stacking” of stacking the unit cells by way of separators formed with fuel flow channels on both sides are used. The latter is suitable to a fuel cell since the heat efficiency is high and the cell becomes compact. In addition, a method of conducting fine fabrication on a silicon wafer by applying an MEMS technique and stacking them has also been proposed.

For fuel cells, various uses have been considered such as for transportation use, domestic use, and portable equipment use. For example, transportation use that is applicable preferably includes automobiles (passenger cars, wagon cars, auto bicycle, personal beagles) and ships. Domestic use includes cogeneration systems, vacuum cleaners, and robots. Portable equipments include mobile telephones, notebook type personal computers, electronic still cameras, PDAs, video cameras, portable game machines, etc. Further, the fuel cells can be used also for portable power generators and outdoor illumination equipments. Further they can be used preferably as power sources for industrial or domestic robots or other toys. Further, they are also useful as charging power sources for secondary batteries and capacitors mounted in the equipments described above.

### EXAMPLES

The present invention is to be described further specifically with reference to examples. Materials, amounts of use, ratios, contents of treatment, and procedures of treatment shown in the following examples can be properly changed unless they do not depart from the gist of the invention. Accordingly, the scope of the invention is not restricted to specific examples shown below.

### Example 1

Manufacture of Catalyst Material for use in Fuel Cell (1)

[Manufacture of Catalyst Material for use in Fuel Cell M-1] (1-1 Type)

(Modification of Carbon Material)

As the carbon material, a carbon black (trade name of products: Carbon ECP, manufactured by Ketchen Black International Co.) (a) was used and reaction was conducted in accordance with the following scheme (1) (in the following scheme 1, CB shows a portion of the carbon black. CB has identical meaning here and hereinafter)

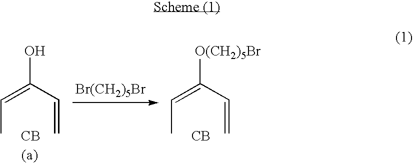

Reaction was conducted in accordance with the scheme (1). That is, 20 g of the carbon black (a), 180 mL of N,N-dimethyl formamide, 60 g of dibromopentane, and 24 g of potassium carbonate were added and reacted at 110° C. for 24 hours while stirring in a nitrogen gas stream. After the reaction, the product was washed with water and then with dichloromethane, and dried under a reduced pressure to obtain 19.9 g of a carbon material (c-1A), introduced with bromopentyl groups. As the result of elemental analysis, 0.4 mmol of bromopentyl groups were introduced per 1 g of the carbon material c-1A.

(Introduction of Hydrophilic Segment Precursor to Carbon Surface)

Reaction was conducted in accordance with the scheme (2). That is, 4.4 g of bisphenol A and 5.5 g of 4,4′-dichloro diphenyl sulfone were added to 2.5 g of the carbon material c-1A, 9.9 g of potassium carbonate, 64 mL of N-methyl-2-pyrrolidone, and 16 mL of toluene and stirred in an oil bath at 200° C. for 4 hours under a nitrogen gas stream. After the reaction, the product was washed with water and then with N-methyl-2-pyrrolidone and dried under a reduced pressure to obtain 2.4 g of a carbon material c-1B introduced with the hydrophilic segment precursor.

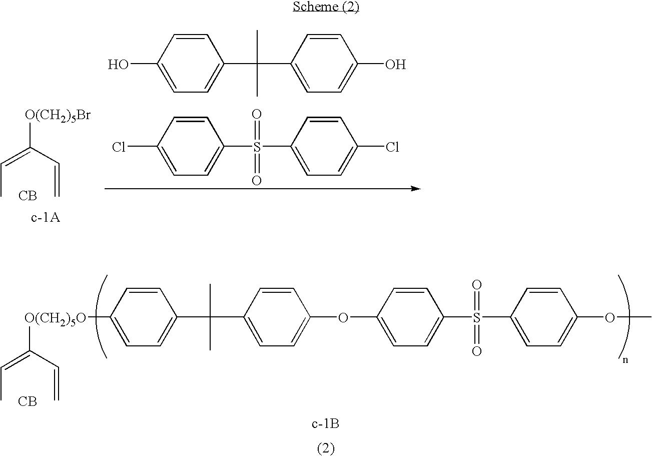

In the scheme, n represents the number of repetitive units of the hydrophilic segment precursor and it was found that n is from 5 to 6 based on the result of the elemental analysis.

(Introduction of Hydrophobic Segment to Carbon Surface)

Reaction was conducted in accordance with the scheme (3). That is, 5.5 g of 4,4′-isopropylidene bis-(2,6-dimethylphenol) and 5.5 g of 4,4′-dichloro diphenyl sulfone were added to 2.0 g of the carbon material c-1B, 9.9 g of potassium carbonate, 64 mL of N-methyl-2-pyrrolidone, and 16 mL of toluene and stirred in an oil bath at 200° C. for 3 hours under a nitrogen gas stream. After the reaction, the product was washed with water and then with N-methyl-2-pyrrolidone and dried under a reduced pressure to obtain 1.8 g of a carbon material c-1C introduced with the hydrophobic segment.

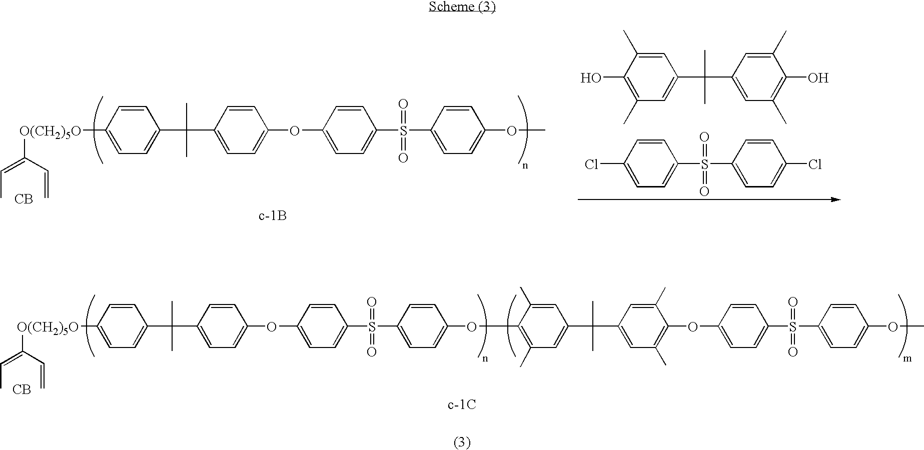

In the scheme, m represents the number of repetitive units of the hydrophobic segment and it was found that m is from 4 to 5 based on the result of the elemental analysis.

(Introduction of Sulfo Group to Hydrophilic Segment Precursor)

Reaction was conducted in accordance with the scheme (4). That is, 142 mg of tin chloride, 8.74 g of chloromethyl methyl ether, and 50 mL of 1,1,2,2-tetrachloroethane were added to 1.5 g of a carbon material c-1C and stirred at 110° C. for 8 hours under a nitrogen gas stream. After the reaction, the product was washed with chloroform, acetonitrile, and water and dried at a reduced pressure.

3.6 g of sodium 3-mercaptopropane-1-sulfonate, 2.3 g of potassium tert-butoxide, and 50 mL of N,N-dimethyl acetoamide were added to the obtained powder and stirred at 40° C. for 8 hours under a nitrogen gas stream. After the reaction, the product was washed with water and then immersed in an aqueous 1N sulfuric acid solution at a room temperature for 30 min. Then, the product was washed with water and dried at a reduced pressure. It was found by elemental analysis that sulfo groups were introduced by the number of 1.7 per repetitive unit of the hydrophilic segments.

Then, 1.0 g of the carbon material introduced with ionic functional groups was immersed in an aqueous solution of hexamine platinum (IV) chloride at a room temperature for one hour, cleaned, dried and then reduced in a hydrogen gas stream at 180° C. to obtain 1.9 g of a catalyst material M-1 for use in the fuel cell. 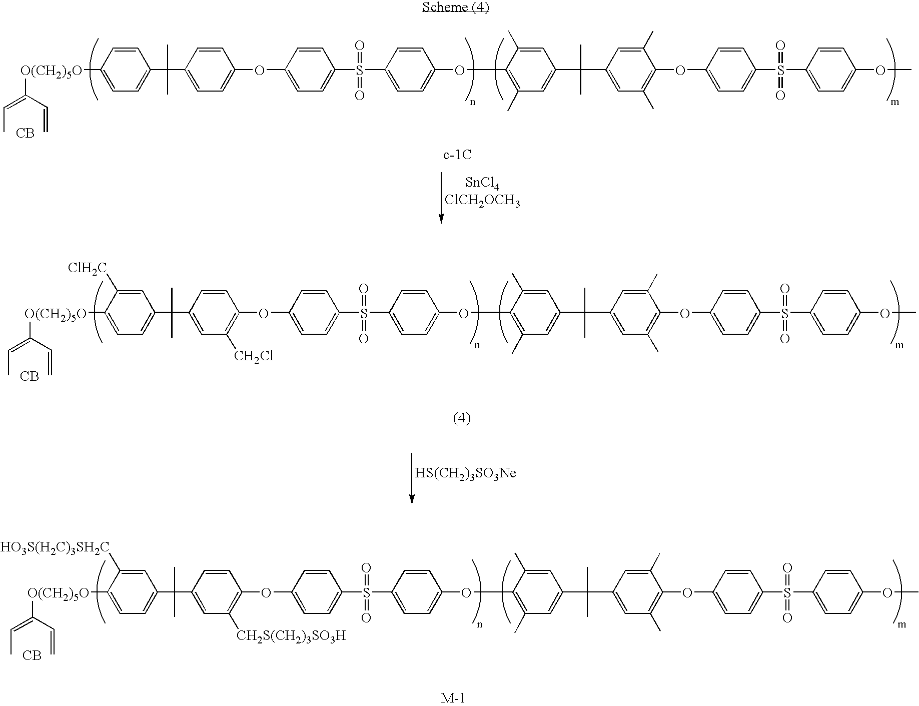
[Manufacture of Catalyst Material M-2 for use in Fuel Cell] (1-1 Type)
(Modification of Carbon Material)

As a carbon material, a carbon black (trade name of product: carbon ECP, manufactured by Ketchen Black International Co.) (a) was used, to obtain a carbon material c-2A introduced with bromopentyl groups in the same manner as in the scheme (1). Based on the result of elemental analysis, 0.4 mmol of bromopentyl groups were introduced per 1 g of the carbon material c-2A.

(Synthesis of Hydrophilic Segment Precursor)

Reaction was conducted in accordance with the scheme (5). That is, 20.0 g of bisphenol A, 25.16 g of 4,4′-dichlorophenyl sulfone, 13.9 g of potassium carbonate, 150 mL of N-methyl-2-pyrrolidone, and 75 mL of toluene were stirred in an oil bath at 200° C. for 2 hours under nitrogen gas stream. After the reaction, toluene was removed under a reduced pressure, and the reaction solution was poured into water. Supernatants were removed and the obtained precipitates were washed with water, and dried at a reduced pressure to obtain 30.2 g of a hydrophilic segment precursor p-2A. It was found by the gel permeation chromatography (GPC) that the weight average molecular weight of p-2A was about 3,000. 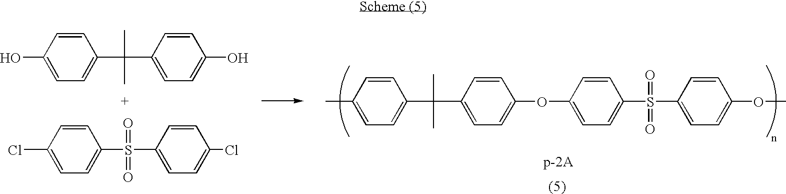
In the scheme, n is a number of repetitive units of the hydrophilic segment precursor.
(Synthesis of Hydrophobic Segment)

Reaction was conducted in accordance with the scheme (6) That is, 24.9 g of 4,4′-isopropylydene-bis-(2,6-dimethyl-phenol), 25.2 g of 4,4′-dichlorophenyl sulfone, 13.9 g of potassium carbonate, 150 mL of N-methyl-2-pyrrolidone, and 75 mL of toluene were stirred in an oil bath at 200° C. for 2 hours under a nitrogen gas stream. After the reaction, toluene was removed under a reduced pressure, and the reaction solution was poured into water. Supernatants were removed and the obtained precipitates were washed with water, and dried at a reduced pressure to obtain 33.3 g of a hydrophobic segment p-2B. It was found by the gel permeation chromatography (GPC) that the weight average molecular weight of p-2B was about 3,000. 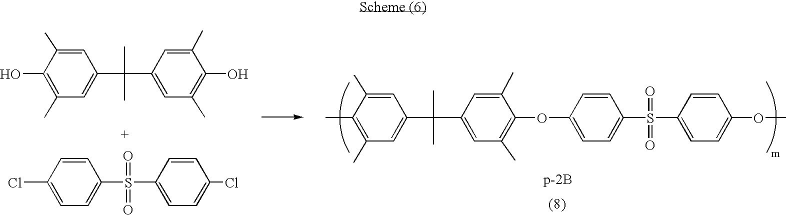
In the scheme, m is a number of repetitive units of the hydrophobic segment.
(Synthesis of Block Copolymer)

Reaction was conducted in accordance with the scheme (7) That is, 9.9 g of p-2A, 10.0 g of p-2B, 13.9 g of potassium carbonate, 150 mL of N-methyl-2-pyrrolidone, and 75 mL of toluene were stirred in an oil bath at 200° C. for 2 hours under a nitrogen gas stream. After the reaction, toluene was removed under a reduced pressure, and the reaction solution was poured into water. Supernatants were removed and the obtained precipitates were washed with water, and dried at a reduced pressure to obtain 15.1 g of a block copolymer p-2C. It was found by the gel permeation chromatography (GPC) that the weight average molecular weight of p-2C was about 10,000. 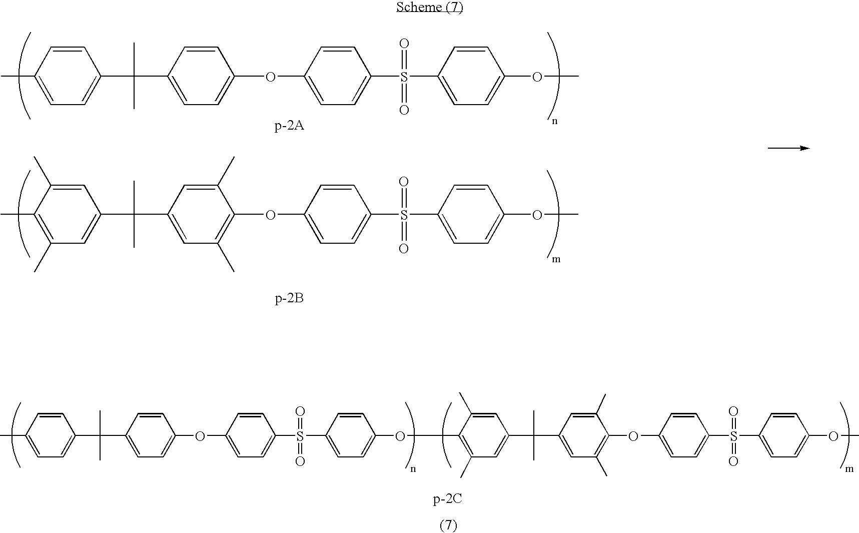
(Introduction of Block Copolymer to Carbon Surface)

Reaction was conducted in accordance with the scheme (8). That is, 2.0 g of c-2A, 30 mL of N,N-dimethyl formamide, 2.5 g of p-2C, and 1.4 g of potassium carbonate were added and reacted at 130° C. for 8 hours while stirring in a nitrogen gas stream. After the reaction, the product was washed with water and then with N,N-dimethyl formamide, dried under a reduced pressure to obtain 1.8 g of carbon material c-2B introduced with the block copolymer. 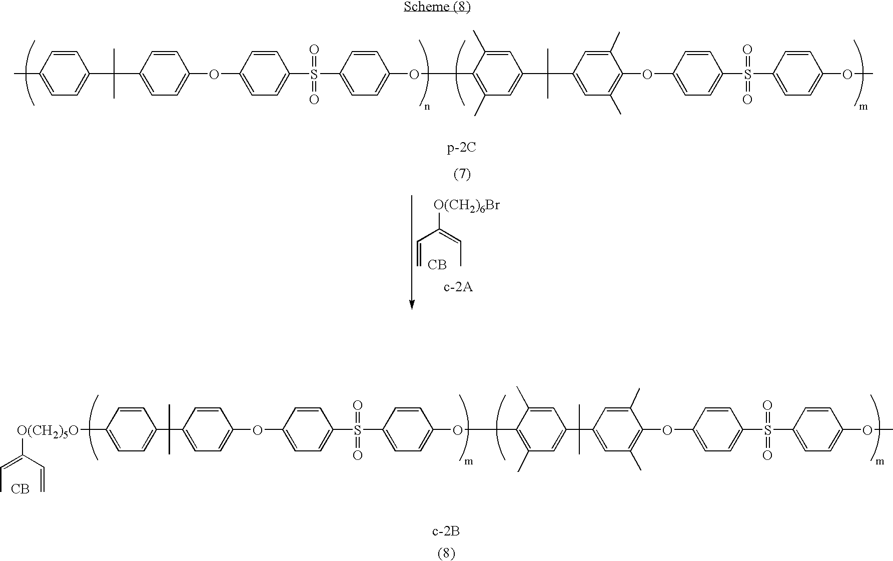
(Introduction of Sulfo Group to Hydrophilic Segment Precursor)

Reaction was conducted in the same manner as in the scheme (4) except for replacing the carbon material c-1C with a carbon material c-2B, to obtain a catalyst material M-2 for use in the fuel cell. It was found by elemental analysis that sulfo groups were introduced by the number of 1.5 per one repetitive unit of the hydrophilic segment. 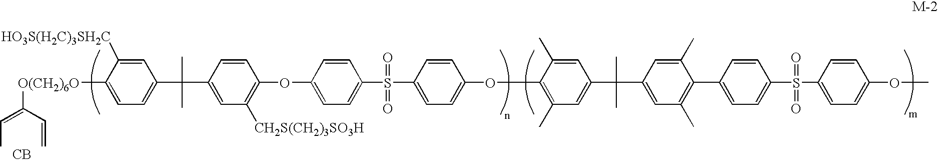
[Manufacture of Catalyst Material M-3 for use in Fuel Cell] (1-1 Type)
(Modification of Carbon Material)

As the catalyst supporting carbon material, a platinum supporting carbon black (trade name of product: TEC 10E50E, manufactured by Tanaka Kikinzoku Co.) was used, to obtain a carbon material c-3A introduced with bromopentyl groups in the same manner as in the scheme (1). As the result of elemental analysis, 0.4 mmol of bromopentyl groups were introduced per 1 g of the carbon material c-3A.

(Synthesis of Hydrophilic Segment)

Reaction was conducted in accordance with the scheme (9). That is, 10.0 g of disodium salt of 4,4′-isopropylidene bis-(2-(3-sulfopropyl thiomethyl))phenol (1-73), 4.72 g of 4,4′-dichlorophenyl sulfone, 2.6 g of potassium carbonate, 40 mL of N-methyl-2-pyrrolidone, and 20 mL of toluene were stirred in an oil bath at 200° C. for 2 hours under a nitrogen gas stream. After the reaction, the reaction solution was poured in acetonitrile, supernatants were removed and the obtained precipitates were washed with acetonitrile and then dried under a reduced pressure to obtain 7.7 g of a hydrophilic segment p-3A. It was found by gel permeation chromatography (GPC) that the weight average molecular weight of p-3A was about 4,000. 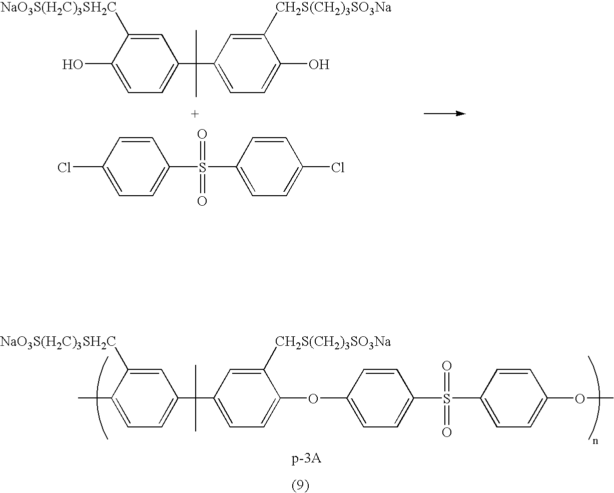
In the scheme, n is a number of repetitive units of the hydrophilic segments.
(Synthesis of Hydrophobic Segment)

Synthesis was conducted in accordance with the scheme (10). That is, 15.0 g of 4,4∴-isopropylydene-bis-(2-(3-triethylsylyl propyl))phenol(H-25), 8.0 g of 4,4′-dichlorophenyl sulfone, 4.4 g of potassium carbonate, 50 mL of N-methyl-2-pyrrolidone, and 25 mL of toluene were stirred in an oil bath at 200° C. for 2 hours under a nitrogen gas stream. After the reaction, toluene was removed under a reduced pressure, the reaction solution was poured into water, supernatants were removed and the obtained precipitates were washed with water, and dried at a reduced pressure to obtain 16.1 g of a hydrophobic segment p-3B. It was found by gel permeation chromatography (GPC) that the weight average molecular weight of p-3B was about 3,000. 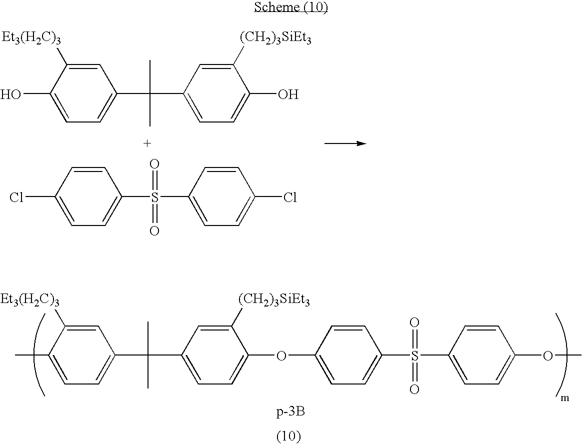
In the scheme, m is a number of repetitive units of the hydrophobic segments.
(Synthesis of Block Copolymer)

Reaction was conducted in accordance with the scheme (11). That is, 8.24 g of p-3A, 7.56 g of p-3B, 1.6 g of potassium carbonate, 40 mL of N-methyl-2-pyrrolidone, and 20 mL of toluene were stirred in an oil bath at 200° C. for 2 hours under a nitrogen gas stream. After the reaction, the reaction solution was poured into acetonitrile, supernatants were removed and the obtained precipitates were washed with acetonitrile, and then dried at a reduced pressure to obtain 12.1 g of a block copolymer p-3C. It was found by gel permeation chromatography (GPC) that the weight average molecular weight of p-3C was about 13,000. 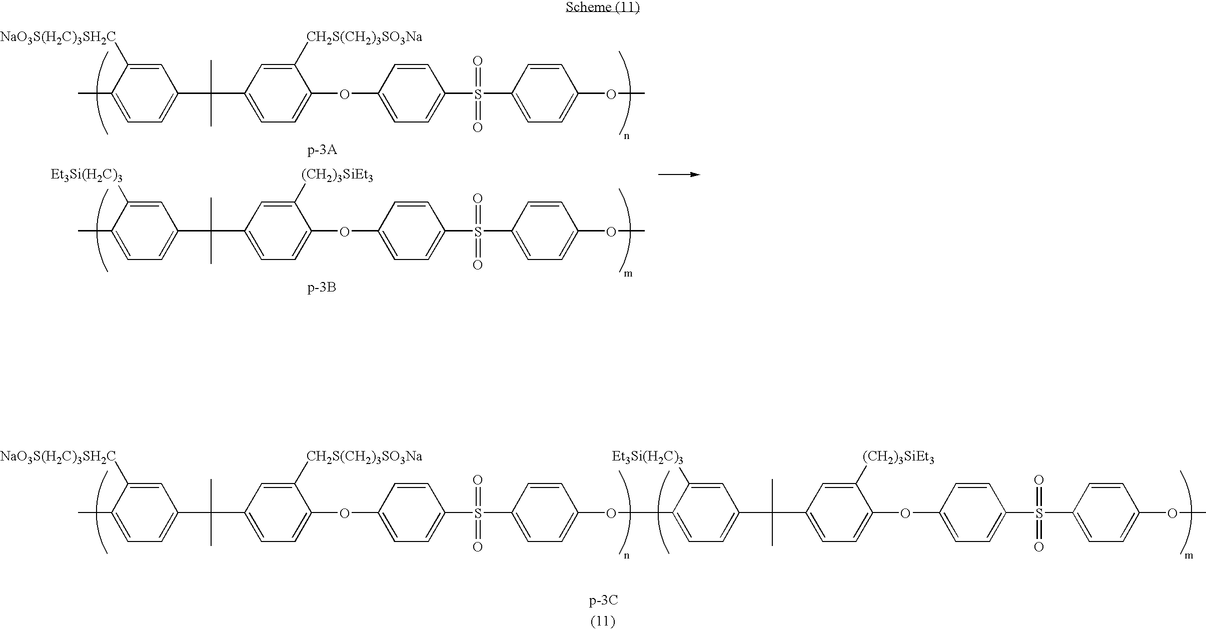
(Introduction of Block Copolymer to Carbon Surface)

Reaction was conducted in accordance with the scheme (12). That is, 2.4 g of c-3A, 50 mL of N,N-dimethyl formamide, 2.4 g of p-3C, and 3.4 g of potassium carbonate were added and reacted at 130° C. for 8 hours while stirring in a nitrogen gas stream. After the reaction, the product was washed with water and then with N,N-dimethyl formamide, dried under a reduced pressure. Then, it was immersed in an aqueous 1N sulfuric acid solution at a room temperature for 30 min. Then, the product was washed with water and dried under a reduced pressure to obtain a 2.0 g of a catalyst material M-3 for use in the fuel cell. 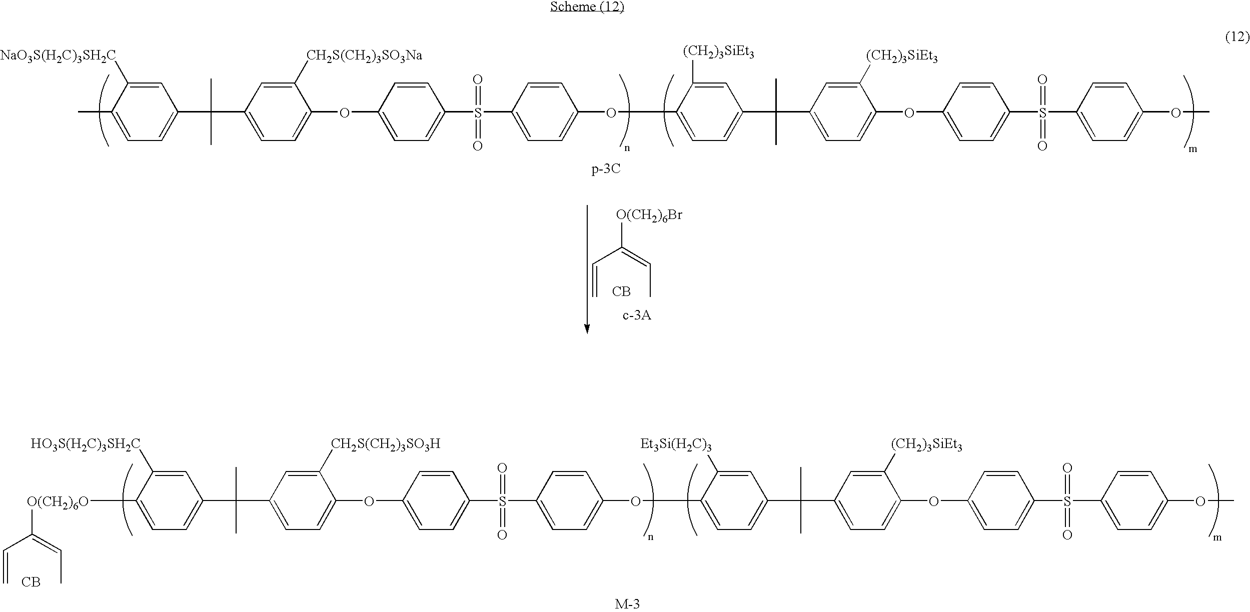
[Manufacture of Catalyst Material M-4 for use in Fuel Cell] (1-1 Type)
(Modification of Carbon Material)

As a carbon material, a carbon black (trade name of product: carbon ZCP, manufactured by Ketchen Black International Co.) (a) was used, to obtain a carbon material c-4A introduced with bromopentyl groups in the same manner as in the scheme (1). As the result of elemental analysis, 0.4 mmol of bromopentyl groups were introduced per 1 g of the carbon material c-4A.

(Synthesis of Hydrophilic Segment)

A hydrophilic segment p-4A was obtained in the same manner as in the scheme (9). It was found by gel permeation chromatography (GPC) that the weight average molecular weight of p-4A was about 4,000.

(Synthesis of Hydrophobic Segment)

In the same manner as in the scheme (10), a hydrophobic segment p-4B was obtained. It was found by gel permeation chromatography (GPC) that the weight average molecular weight of p-4B was about 3,000.

(Introduction of Block Copolymer to Carbon Surface)

Reaction was conducted in accordance with the scheme (13). That is, 3.96 g of p-4A and 3.62 g of p-4B were added to 2.5 g of a carbon material c-4A, 9.9 g of potassium carbonate, 64 mL of N-methyl-2-pyrrolidone, and 16 mL of toluene and stirred in an oil bath at 200° C. for 3 hours under a nitrogen gas stream. After the reaction, the product was washed with water and then with N-methyl-2-pyrrolidone and dried under a reduced pressure. Then, it was immersed in an aqueous 1N sulfuric acid solution at a room temperature for 30 min. Then, the product was washed with water and dried under a reduced pressure to obtain a 2.2 g of a carbon material introduced with ionic functional groups.

Then, the carbon material introduced with the ionic functional groups was immersed in aqueous solution of hexamine platinum (IV) chloride at a room temperature for one hour, washed, dried and then reduced at 180° C. in a hydrogen gas stream to obtain a catalyst material M-4 for use in the fuel cell. It was found from the result of elemental analysis that the hydrophobic segments were introduced by 2% by weight and hydrophilic segment were introduced by 3% by weight on the weight percentage to the catalyst material M-4.

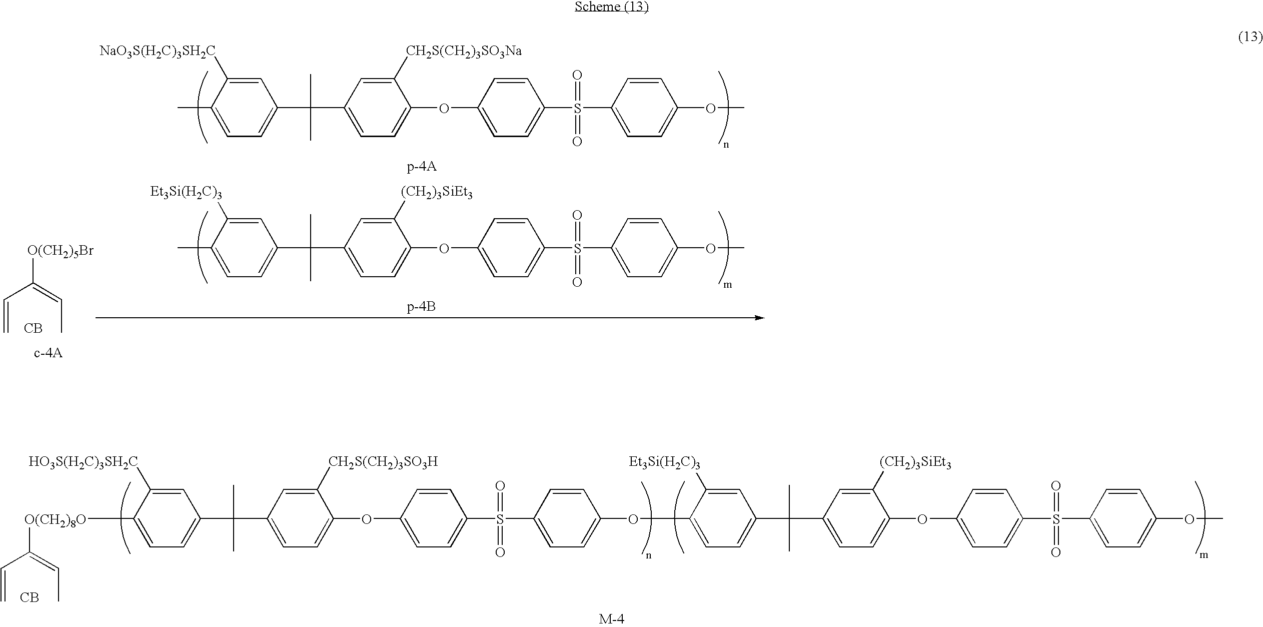

In the scheme, m is a number of repetitive units of hydrophobic segments and n is a number of repetitive units of hydrophilic segments.

[Manufacture of Catalyst Material M-5 for use in Fuel Cell] (1-1 Type)

(Modification of Carbon Material)

As a carbon material, a carbon black (trade name of product: carbon ECP, manufactured by Ketchen Black International Co.) (a) was used, to obtain a carbon material c-5A introduced with bromopentyl groups in the same manner as in the scheme (1). As the result of elemental analysis, 0.4 mmol of bromopentyl groups were introduced per 1 g of the carbon material c-5A.

(Synthesis of Hydrophilic Segment Precursor)

A hydrophilic segment precursor p-5A was obtained in the same manner as in the scheme (5). It was found by gel permeation chromatography (GPC) that the weight average molecular weight of p-5A was about 3,000.

(Synthesis of Hydrophobic Segment)

In the same manner as in the scheme (10), a hydrophobic segment p-5B was obtained. It was found by gel permeation chromatography (GPC) that the weight average molecular weight of p-SB was about 3,000.

(Introduction of Block Copolymer to Carbon Surface)

A carbon material c-5B introduced with a block copolymer was obtained in the same manner as in the scheme (13) except for replacing the carbon material c-4A with carbon material c-5A, p-4A with p-5A, and p-48 with p-5D.

(Introduction of Sulfo Group to Hydrophilic Segment Precursor)

A catalyst material M-5 for use in fuel cell was obtained in the same manner as in the scheme (4) except for replacing the carbon material c-1C with a carbon material c-5B. It was found from the result of elemental analysis that the hydrophobic segment were introduced by 2% by weight and the hydrophilic segment were introduced by 3% by weight on the weight percentage to the catalyst material M-5.

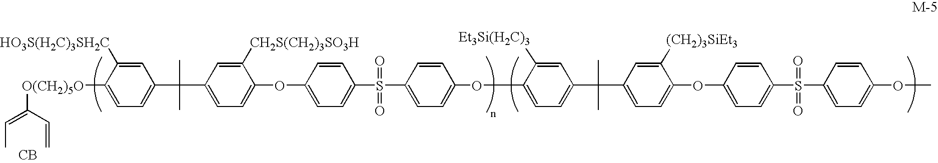

In the scheme, m is a number of repetitive units of hydrophobic segments and n is a number of repetitive units of hydrophilic segments.

[Manufacture of Catalyst Material M-6 for use in Fuel Cell] (1-2 Type)

(Modification of Carbon Material)

Reaction was conducted in accordance with the following scheme (14) using a platinum supporting carbon black (name of products: TEC10E50E manufactured by Tanaka Kikinzoku Co.) as a catalyst supporting carbon material. That is, 12.0 g of the carbon black, 6.9 g of potassium carbonate, 13.2 g of 1,4-bis(bromomethyl)benzene, and 90 mL of N-methyl-2-pyrrolidone were added and reacted at 110° C. for 8 hours while stirring under a nitrogen gas stream. After the reaction, the product was washed with water and then with chloroform and dried under a reduced pressure to obtain 11.3 g of a carbon material c-6A comprising a benzyl bromide portion. As the result of elemental analysis, 0.4 mmol of benzyl bromide portion was introduced per 1 g of the carbon material c-6A. 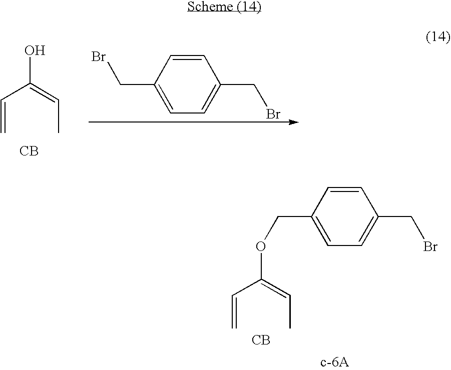
(Introduction of Hydrophilic Segment to Carbon Material)

Reaction was conducted in accordance with the scheme (15). That is, 2.4 g of the carbon c-6A, 600 mg of copper chloride (I), 1.89 g of 2,2′-bipyridine, 50 mL of N-methyl-2-pyrrolidone, and 7.2 g of lithium salt of 3-sulfo propyl oxystyrene (K-6) were added and stirred in an oil bath at 160° C. for 4 hours under a nitrogen gas stream. After the reaction, the product was washed with N,N-dimethylformamide, acetonitrile and water to obtain 2.4 g of a carbon material c-6B introduced with hydrophilic segments.

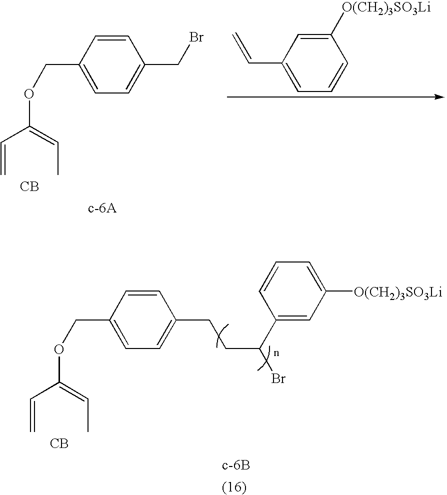

In the scheme, n is a number of repetitive units of the hydrophilic segments and it was found from the result of elemental analysis that n is from 5 to 6.

(Introduction of Hydrophobic Segment to Carbon Material)

Reaction was conducted in accordance with the scheme (16). That is, 2.0 g of the carbon c-6B, 600 mg of copper chloride (I), 1.89 g of 2,2′-bipyridine, 50 mL of N-methyl-2-pyrrolidone, and 6.75 g of 3-trimethylsylyl propyloxystyrene (L-17) were added and stirred in an oil bath at 160° C. for 3 hours under a nitrogen gas stream. Then, hydroquinone was added and stirred for further 2 hours. After the reaction, the product was washed with N,N-dimethylformamide, acetonitrile, and water to obtain a carbon material c-6C introduced with hydrophobic segments. Then, it was immersed in an aqueous 1N sulfuric acid solution at a room temperature for 30 min. Then, the product was washed with water and dried under a reduced pressure to obtain 1.9 g of a catalyst material M-6 for use in the fuel cell.

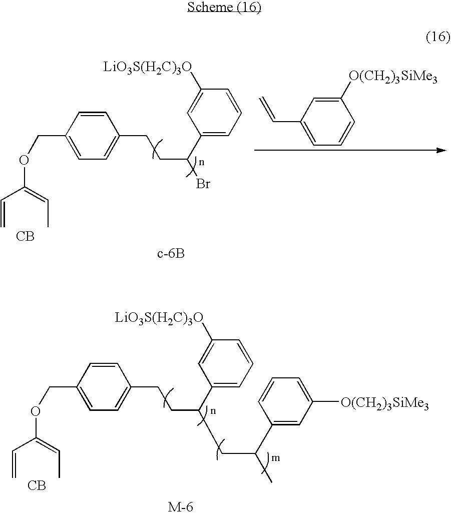

In the scheme, m is a number of repetitive units of the hydrophobic segments and it was found from the result of elemental analysis that m is from 1 to 2.

[Manufacture of Catalyst Material M-7 for use in Fuel Cell] (1-1 Type)

(Synthesis of Block Copolymer)

Reaction was conducted in accordance with the scheme (17). That is, 2.0 g of lithium salt of 3-sulfopropyloxystyrene (K-6), 20 mL of N-methyl-2-pyrrolidone, 240 mg of benzoyl peroxide, and 320 mg of 2,2,6,6-tetramethylpyperidine-1-oxyl were added and stirred in an oil bath at 160° C. under a nitrogen gas stream. After confirming that all (K-6) in the reaction solution were reacted by NMR, 1.4 g of 3-trimethylsylyl propyloxystyrene (L-17) in an N-methyl-2-pyrrolidone solution (10 mL) was added under a degasssed condition and further stirred. After confirming elimination of (1-17) by NMR, 2.0 g of (K-6) in an N-methyl-2-pyrrolidone solution (10 mL) was added under degassed condition and stirred further. Subsequently, reaction was conducted by alternately adding (L-17) and (K-6) in the same method and the temperature was returned to the room temperature at the instance the fourth (K-6) reaction was ended to complete the reaction. The reaction solution was poured into ethyl acetate, supernatants were removed and after washing the obtained precipitates with acetonitrile, it were dried under a reduced pressure to obtain 9.6 g of a block copolymer p-7A. It was found from gel permeation chromatography (GPC) that the weight average molecular weight of p-7A was about 7,000.

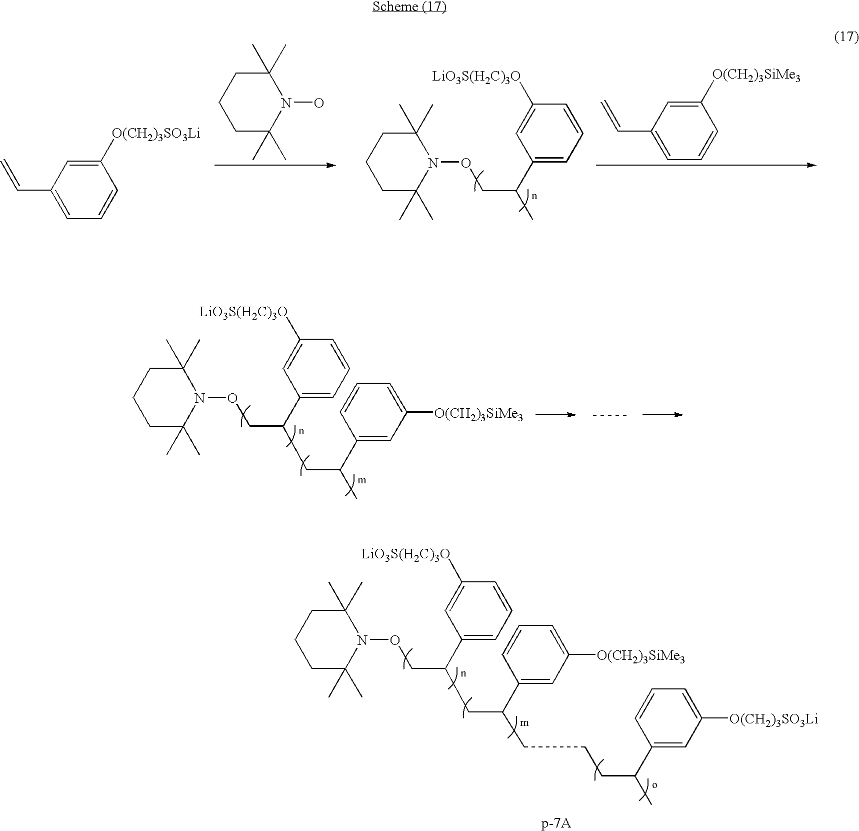

In the scheme, m is a number of repetitive units of the hydrophobic segments and n and o are numbers of repetitive units of the hydrophilic segments.

(Introduction of Block Copolymer to Carbon Surface)

Reaction was conducted in accordance with the following scheme (18) by using a platinum supporting carbon black (trade name of product: TEC10E50E manufactured by Tanaka Kikinzoku Co.) as the catalyst supporting carbon material (in the following scheme (18), (b) specifies a quinone portion of the carbon black and (c) specifies a hydrogen atom-containing portion of the carbon black and they represent an identical carbon black (TEC10E50E)).

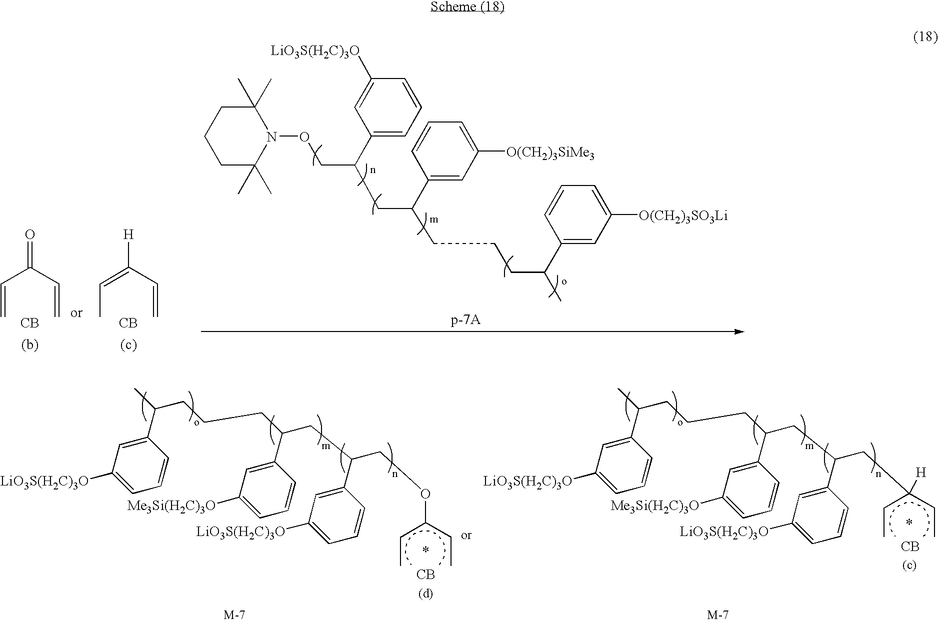

That is, 2.4 g of TEC10E50E, 3.0 g of p-7A, 30 mL of N-methyl-2-pyrrolidone were added and reacted in an oil bath at 160° C. for 3 hours under a nitrogen gas stream. After the reaction, the product was washed with N-methyl-2-pyrrolidone and then with acetonitrile and dried under a reduced pressure. Then, it was immersed in an aqueous 1N sulfuric acid solution at a room temperature for 30 min. Then, the product was washed with water and dried under a reduced pressure to obtain a catalyst material M-7 for use in the fuel cell.

[Manufacture of Catalyst Material M-8 for use in the Fuel Cell] (1-2 Type)

(Modification of Carbon Material)

As a carbon material, a carbon black (trade name of product: carbon ECP, manufactured by Ketchen Black International Co.) (a) was used, to obtain a carbon material c-8A introduced with bromopentyl groups in the same manner as in the scheme (1). As the result of elemental analysis, 0.4 mmol of bromopentyl groups were introduced per 1 g of the carbon material c-8A.

(Introduction of Hydrophobic Segment Main Chain to Carbon Surface)

Reaction was conducted in accordance with the scheme (19). That is, 2.2 g of bisphenol A, 5.2 g of 4,4′-isopropylidene-bis-(2-(3-triethylsylil propyl))phenol (H-25) and 5.5 g of 4,4′-dichlorodiphenyl sulfone were added to 2.5 g of carbon material c-8A, 10.0 g of potassium carbonate, 80 mL of N-methyl-2-pyrrolidone and 20 mL of toluene and stirred in an oil bath at 200° C. for 5 hours under a nitrogen gas stream. After the reaction, the reaction solution was separated by filtration, precipitates were washed with N-methyl-2-pyrrolidone and then with water, and then dried under a reduced pressure to obtain 2.4 g of a carbon material c-8B introduced with hydrophobic segment main chain. As the result of elemental analysis, the introduced hydrophobic segment main chain was 4% by weight to the carbon material c-8B.

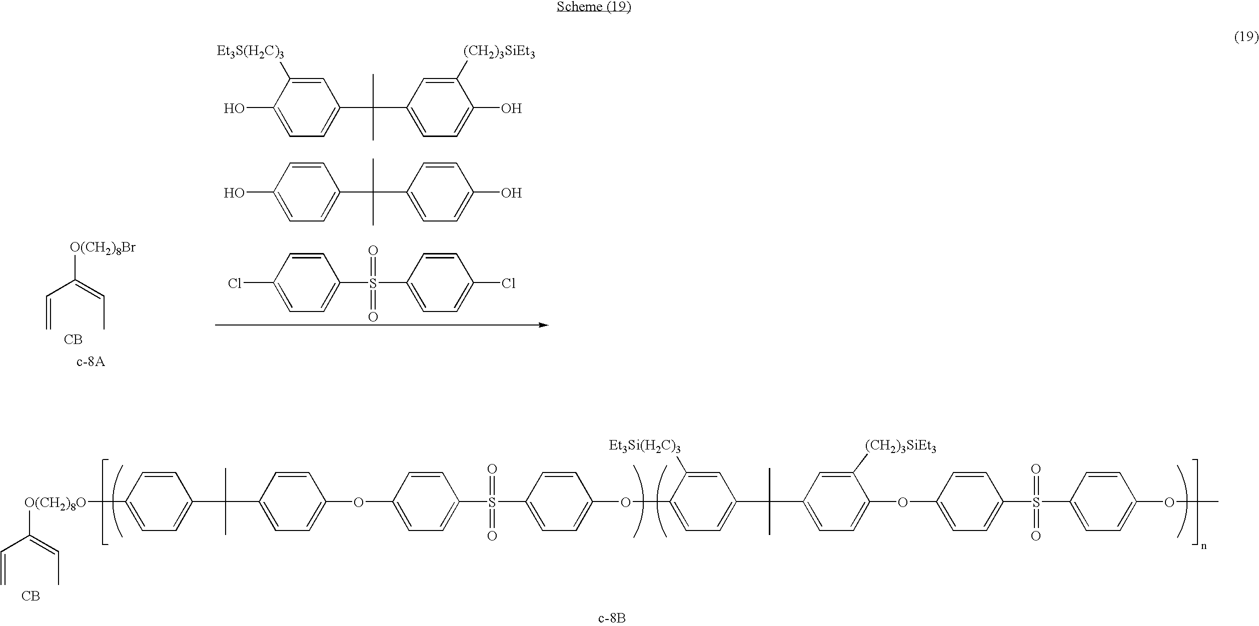

In the scheme, n is a number of repetitive units of the hydrophobic segments.

(Introduction of Hydrophilic Segment Side Chain)

Reaction was conducted in accordance with the scheme (20). That is, 1.5 g of c-8B, 150 mg of tin chloride, 8.75 g of chloromethyl methyl ether, and 50 mL of 1,1,2,2-tetrachloroethane were added and stirred at 110° C. for 8 hours under a nitrogen gas stream. After the reaction, the product was washed with chloroform, acetonitrile, and water, and dried under a reduced pressure.

400 mg of copper chloride (I), 1.26 g of 2,2′-bipyridine, 40 mL of N-methyl-2-pyrrolidone, 4.5 g of a lithium salt of 3-sulfo propyl oxystyrene (K-6) and 120 mg of methyl methacrylate (K-25) were added to the obtained powder and stirred in an oil bath at 60° C. for 8 hours under a nitrogen gas stream. Then, 1.0 g of hydroquinone was added and stirred further for 2 hours. After the reaction, the temperature was returned to a room temperature, 20 mL of an aqueous 2M sodium hydroxide solution was added and stirred for 2 hours. After the reaction, the product was separated by filtration, washed with N,N-dimethylformamide, acetonitrile, and water and then immersed in an aqueous 1N sulfuric acid solution at a room temperature for 30 min. Then, the product was washed with water and dried under a reduced pressure.

Then, the carbon material introduced with the ionic functional groups was immersed in an aqueous solution of hexamine platinum (IV) chloride at a room temperature for one hour and, after washing and drying, reduced in a hydrogen gas stream at 180° C. to obtain 2.4 g of a catalyst material M-8 for use in the fuel cell introduced with hydrophilic segments to the hydrophobic segment main chain. As the result of elemental analysis, the introduced graft chain was 4% by weight relative to the catalyst material M-8.

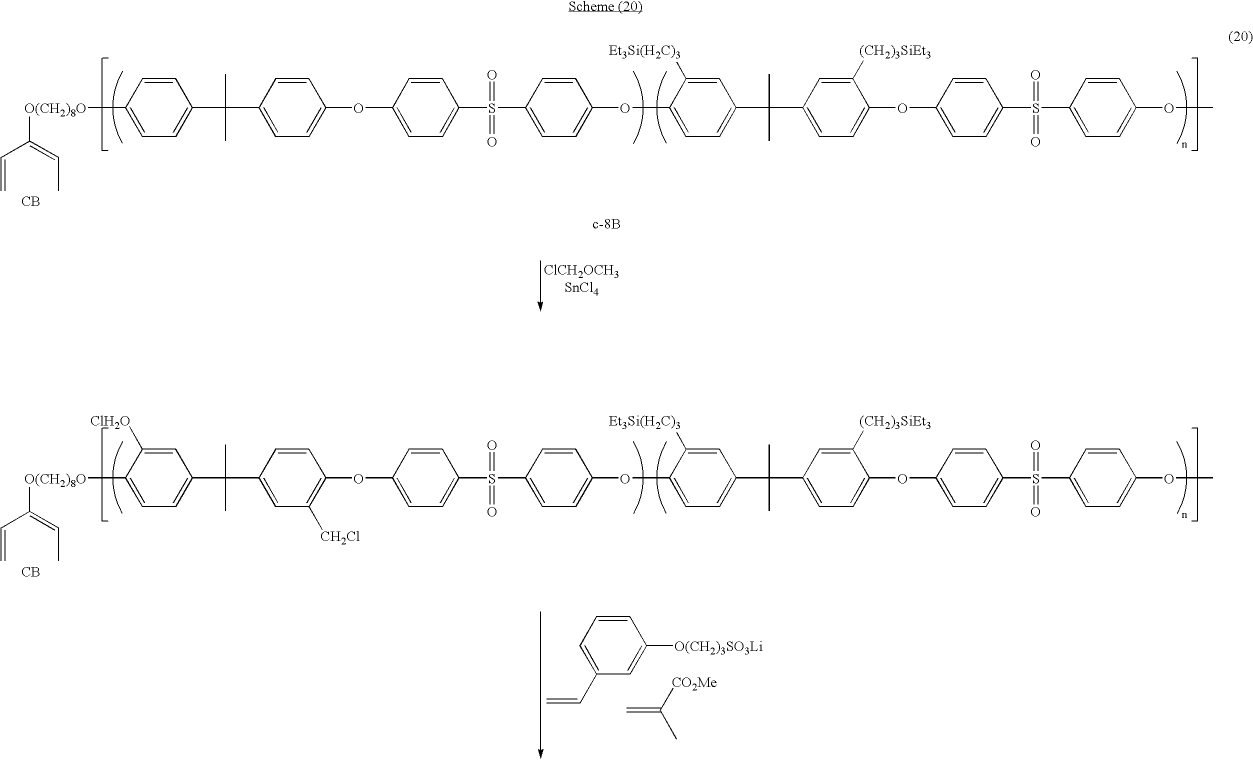

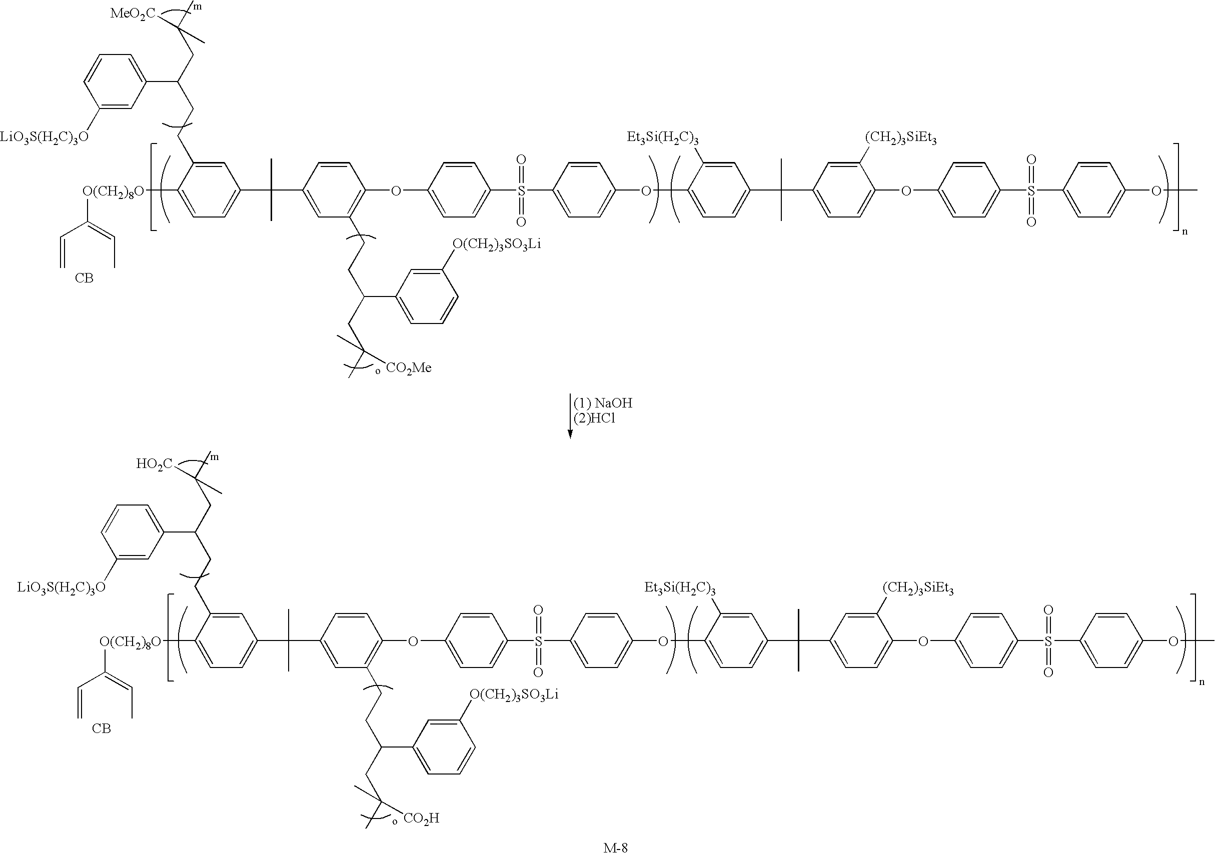

In the scheme, m and o are numbers of repetitive units of the hydrophilic segments.

[Manufacture of Catalyst Material M-9 for use in Fuel Cell] (1-2 Type)

(Modification of Carbon Material)

As a carbon material, carbon black (trade name of product: carbon ECP, manufactured by Ketchen Black International Co.) (a) was used, to obtain a carbon material c-9A introduced with bromopentyl groups in the same manner as in the scheme (1). As the result of elemental analysis, 0.4 mmol of bromopentyl groups were introduced per 1 g of the carbon material c-9A.

(Introduction of Hydrophobic Segment Main Chain to Carbon Surface)

A hydrophobic segment main chain was introduced to the carbon surface in the same manner as in the scheme (2) except for replacing the carbon material c-1A with c-9A, to obtain c-9B. The introduction amount of the hydrophobic segment main chain introduced to c-9B was identical with that of c-1B.

(Introduction of Hydrophobic Segment Side Chain and Hydrophilic Side Chain in Block Form)

Reaction was conducted in accordance with the scheme (21), That is, 1.5 g of c-9B, 150 mg of tin chloride, 8.75 g of chloromethyl methyl ether, and 50 mL of 1,1,2,2-tetrachloroethane were added and stirred at 110° C. for 8 hours under a nitrogen gas stream. After the reaction, the product was washed with chloroform, acetonitrile, and water, and dried under a reduced pressure.

400 mg of copper chloride (I), 1.26 g of 2,2′-bipyridine, 40 mL of N-methyl-2-pyrrolidone, and 2.1 g of 3-trimethylsylylpropyl oxystyrene (L-17) were added to the obtained powder and stirred in an oil bath at 160° C. for 3 hours under a nitrogen gas stream. Then, the temperature was returned to a room temperature, the product was separated by filtration, washed with N-methyl-2-pyrrolidone, and then dried under a reduced pressure. 400 mg of copper chloride (I) , 1.26 g of 2,2′-bipyridine, 40 mL of N-methyl-2-pyrrolidone, and 4.5 g of a 3-sulfopropyloxystyrene lithium salt (K-6) were added to the obtain powder and stirred in an oil bath at 160° C. for 4 hours under a nitrogen gas stream. Then, 1.0 g of hydroquinone was added and further stirred for 2 hours. After returning the temperature to a room temperature, the product was separated by filtration, washed with N,N-dimethylforamide, acetonitrile, and water, and then immersed in an aqueous 1N sulfuric acid solution at a room temperature for 30 min. Then, the product was washed with water and dried at a reduced pressure.

Then, the carbon material introduced with the ionic functional groups were immersed in an aqueous solution of hexamine platinum (IV) chloride at a room temperature for one hour and, after washing and drying, reduced in a hydrogen gas stream at 180° C., to obtain 2.4 g of a catalyst material M-9 for use in the fuel cell in which hydrophobic segment side chains and hydrophilic segment side chains were introduced in the block form to the hydrophobic segment main chain. It was found by elemental analysis that the weight ratio of the hydrophobic segment main chain, the hydrophobic segment side chain, and the hydrophilic segment side chain was 2 wt %, 1 wt %, and 1 wt % respectively based on the catalyst material M-9.

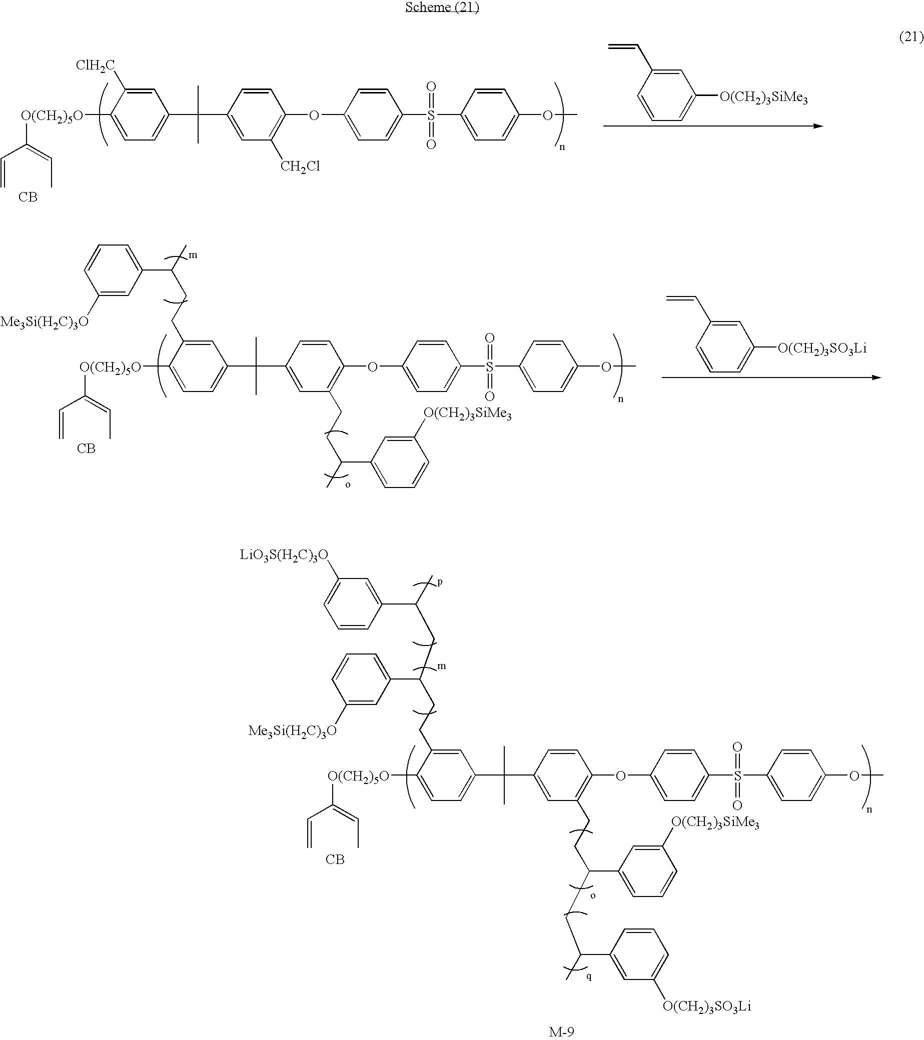

In the scheme, m, n, o each is a number of repetitive units of the hydrophobic segments respectively, and p, q each represents a number of repetitive units of the hydrophilic segment, respectively.

[Manufacture of Catalyst Material M-10 for use in Fuel Cell] (2 Type)

(Modification of Carbon Material)

Reaction was conducted in accordance with the following scheme (22) by using a carbon black (trade name of product: carbon ECP, manufactured by Ketchen Black International Co.) (d) as the carbon material, (in the following scheme (22), (d) represents two different functional groups spatially separated in one identical carbon black particle and represents the same carbon black as in (a) to (c).

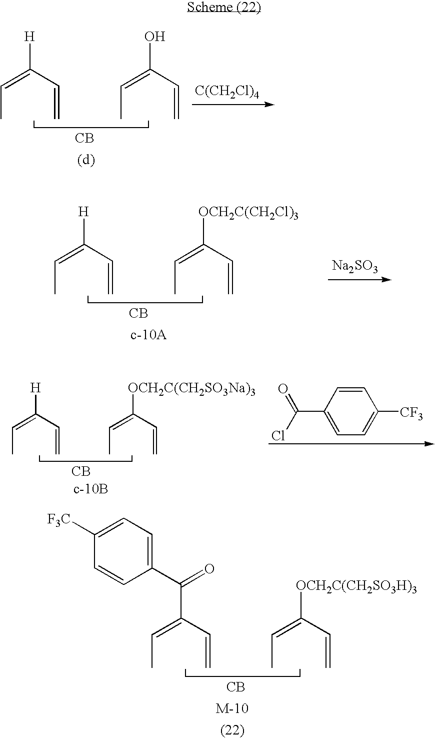

That is, 5.0 g of the carbon black (d), 50 mL of N-methyl-2-pyrrolidone, 15.0 g of tetrachloro pentaerythrityl, and 6.0 g of potassium carbonate were added and reacted at 110° C. for 9 hours while stirring under a nitrogen gas stream. After the reaction, the product was washed water, methylene chloride and then acetone and dried under a reduced pressure to obtain 4.8 g of c-10A introduced with trichloroalkyl groups. As the result of elemental analysis, 0.4 mmol of trichloroalkyl groups were introduced per 1 g of the carbon material c-10A.

Then, 4.5 g of c-10A, 7.5 g of sodium sulfite, and 50 mL of water were added and refluxed for 12 hours while stirring under a nitrogen gas stream. After the reaction, the product was washed water and dried under a reduced pressure to obtain 4.4 g of c-10B introduced with sulfo groups. As the result of elemental analysis, 0.9 mmol of sulfo groups were introduced per 1 g of the carbon material c-10B.

Then, 4.0 g of c-10B, 7.0 g of 4-trifluoromethyl benzoyl chloride, 9.0 g of aluminum chloride, and 50 mL of 1,1,2,2-tetrachloroethane were added and reacted at 110° C. for 15 hours while stirring under a nitrogen gas stream. After the reaction, the product was separated by filtration, washed with dichloromethane and water, and then immersed in an aqueous 1N sulfuric acid solution at a room temperature for 30 min. Then, the product was washed with water and dried under a reduced pressure. It was found from the result of elemental analysis that 0.6 mmol of 4-trifluoromethyl benzoyl groups were introduced per 1 g of the carbon material.

Then, the carbon material introduced with the ion function groups were immersed in an aqueous solution of hexamine platinum (IV) chloride at a room temperature for one hour and, after washing and drying, reduced in a hydrogen gas stream at 180° C. to obtain 7.3 g of a catalyst material M-10 for use in the fuel cell introduced with hydrophilic segments and hydrophobic segments.

[Manufacture of Catalyst Material M-11 for use in Fuel Cell] (2 Type)

(Modification of Carbon Material)

As a carbon material, a carbon black (trade name of product: carbon ECP, manufactured by Ketchen Black International Co.) was used, to obtain a carbon material c-11A introduced with bromopentyl groups in the same manner as in the scheme (1). As the result of elemental analysis, 0.4 mmol of bromopentyl groups were introduced per 1 g of the carbon material c-11A.

(Introduction of Hydrophilic Segment)

Reaction was conducted in accordance with the scheme (23). That is, 4.0 g of c-11A, 9.1 g of disodium salt of 4,4′-isopropylydene bis(2(3-sulfopropyl thiomethyl))phenol (I-73), 4.3 g of 4,4′-dichlorodiphenylsulfone, 15.0 g of potassium carbonate, 60 mL of N-methyl-2-pyrrolidone, and 20 mL of toluene were stirred in an oil bath at 200° C. for 6 hours under a nitrogen gas stream. After the reaction, the product was separated by filtration, washed with N-methyl-2-pyrrolidone and then dried under a reduced pressure to obtain 3.9 g of a carbon material c-11B introduced with hydrophilic segments.

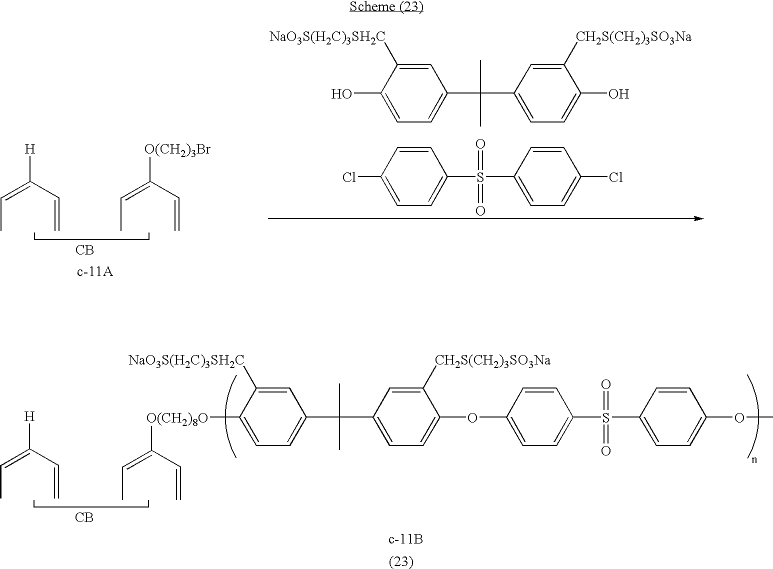

In the scheme, n is a number of repetitive units of the hydrophilic segments precursor and it is found from result of elemental analysis that n is from 5 to 6.

(Introduction of Hydrophobic Segment)

In the same manner as in the scheme (22), a hydrophobic segment comprising 4-trifluoromethyl benzoyl group was introduced. As the result of elemental analysis, it was found that 0.6 mmol of 4-trifluoromethyl benzoyl group was introduced per 1 g of the carbon material. Then, the product was immersed in an aqueous 1N sulfuric acid solution at a room temperature for 30 min and then washed with water and dried under a reduced pressure.

Then, the carbon material introduced with ionic functional groups were immersed in an aqueous solution of hexamine platinum(IV) chloride at a room temperature for one hour and, after washing and drying, reduced at 180° C. in a hydrogen gas stream to obtain 4.6 g of a catalyst material M-11 for use in the fuel cell introduced with hydrophilic segments and hydrophobic segments. 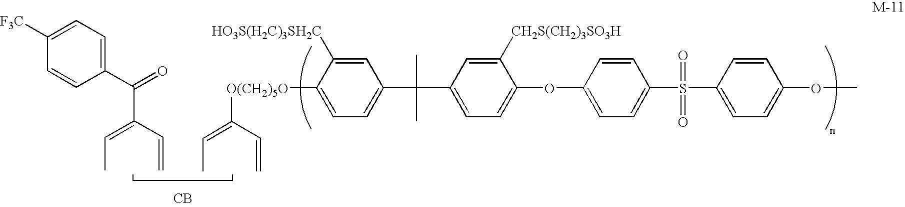
[Manufacture of Catalyst Material M-12 for use in Fuel Cell] (2 Type)
(Modification of Carbon Material)

As a catalyst supporting carbon material, a platinum supporting carbon black (trade name of product: TEC 10E50E, manufactured by Tanaka Kikinzoku Co.) was used, to obtain a carbon material c-12A introduced with bromopentyl groups in the same manner as in the scheme (1). As the result of elemental analysis, 0.4 mmol of bromopentyl groups were introduced per 1 g of the carbon material c-12A.

(Synthesis of Hydrophilic Segment and Hydrophobic Segment)

A hydrophilic segment p-12A was synthesized in the same manner as in the scheme (9) and a hydrophobic segment p-12B was synthesized in the same manner as in the scheme (10). By gel permeation chromatography (GPC), it was found that the weight average molecular weight of p-12A was about 5,000 and the weight average molecular weight of p-12B was about 4,000.

(Introduction of Hydrophilic Segment and Hydrophobic Segment to the Surface of Carbon Material)

The reaction was conducted in accordance with the scheme (24). That is, 3.3 g of p-12A and 3.0 g of p-12B were added to 2.5 g of c-12A, 9.9 g of potassium carbonate, and 50 mL of N-methyl-2-pyrrolidone and reacted at 120° C. for 7 hours under a nitrogen gas stream. After the reaction, product was separated by filtration, washed with N-methyl-2-pyrrolidone, and dried under a reduced pressure. Then, after immersing in an aqueous 1N sulfuric acid solution at a room temperature for 30 min, the product was washed with water and dried under a reduced pressure to obtain 2.5 g of a catalyst material M-12 for use in the fuel cell introduced with the hydrophilic segments and the hydrophobic segments. As the result of elemental analysis, it was found that both the hydrophilic segments and the hydrophobic segments were introduced each by 1% by weight into the catalyst material M-12.

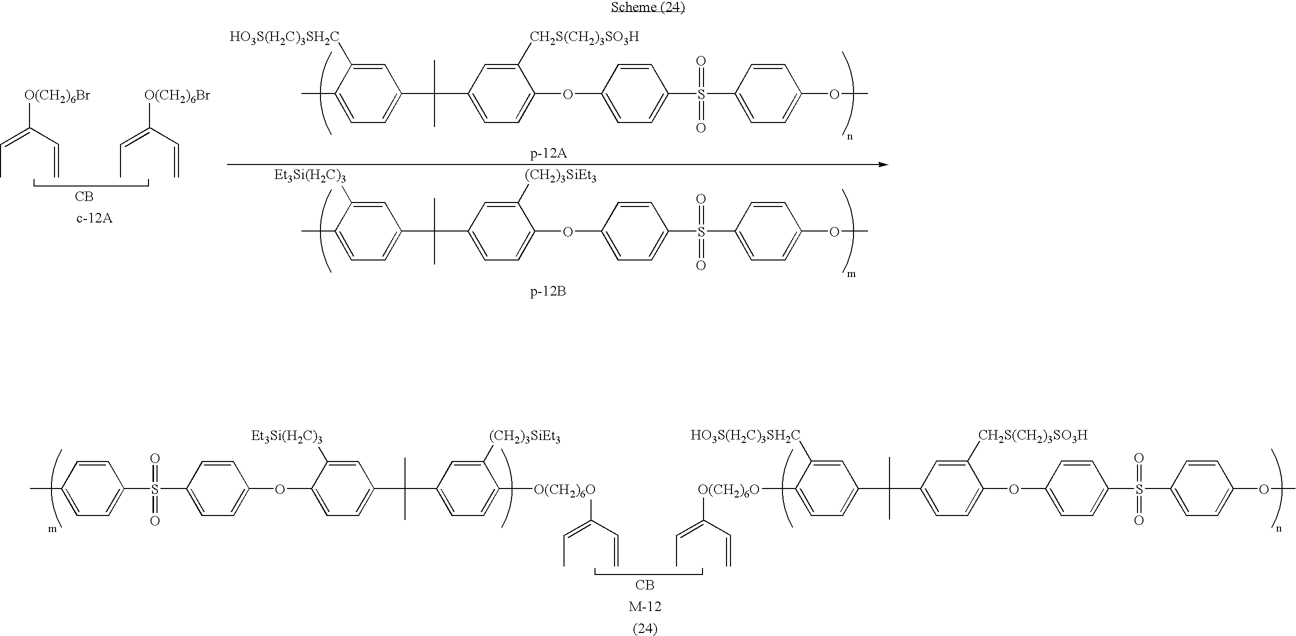

In the scheme, m is a number of repetitive units of hydrophobic segments and n is a number of repetitive units of the hydrophilic segments.

[Manufacture of Catalyst Material M-13 for use in Fuel Cell] (2 Type)

(Introduction of Hydrophilic Segment to the Surface of Carbon Material)

As a carbon material, a carbon black (trade name of product: carbon ECP, manufactured by Ketchen Black International Co.) (a) was used, to obtain a carbon material c-13A introduced with a hydrophilic segment in the same manner as in the scheme (1) and scheme (23).

(Synthesis of Hydrophobic Segment)

10.0 g of 4-trimethyl sylylpropyl oxystyrene (L-15), 430 mg of benzoyl peroxide, 30 mL of N-methyl-2-pyrrolidone, and 600 mg of 2,2,6,6-tetramethylpyperidine-N-oxyl were added and stirred in an oil bath at 160° C. for 9 hours under a nitrogen gas stream. After the reaction, the temperature was returned to a room temperature, the reaction solution was poured into methanol, obtained precipitates were separated by filtration, washed with methanol, and dried under a reduced pressure to obtain 8.7 g of a hydrophobic segment p-13A. It was found by gel permeation chromatography (GPC) that the weight average molecular weight of p-13A was about 3,000.

(Introduction of Hydrophobic Segment to the Surface of Carbon Material)

It was conducted in accordance with the scheme (25). That is, 2.5 g of c-13A, 3.8 g of p-13A, and 30 mL of N-methyl-2-pyrrolidone were added and stirred in an oil bath at 160° C. for 3 hours under a nitrogen gas stream. After the reaction, the product was separated by filtration, washed with ethyl acetate, and then dried under a reduced pressure. Then, it was immersed in an aqueous 1N sulfuric acid solution at a room temperature for 30 min and then the product was washed with water and dried under a reduced pressure. It was found by elemental analysis that the weight ratio of the hydrophobic segment was 2% by weight.

Then, the carbon material introduced with the ion function groups was immersed in an aqueous solution of hexamine platinum (IV) chloride at a room temperature for one hour and, after washing and drying, it was reduced at 180° C. in a hydrogen gas stream to obtain 4.1 g of a catalyst material M-13 for use in the fuel cell introduced with the hydrophilic segments and the hydrophobic segments.

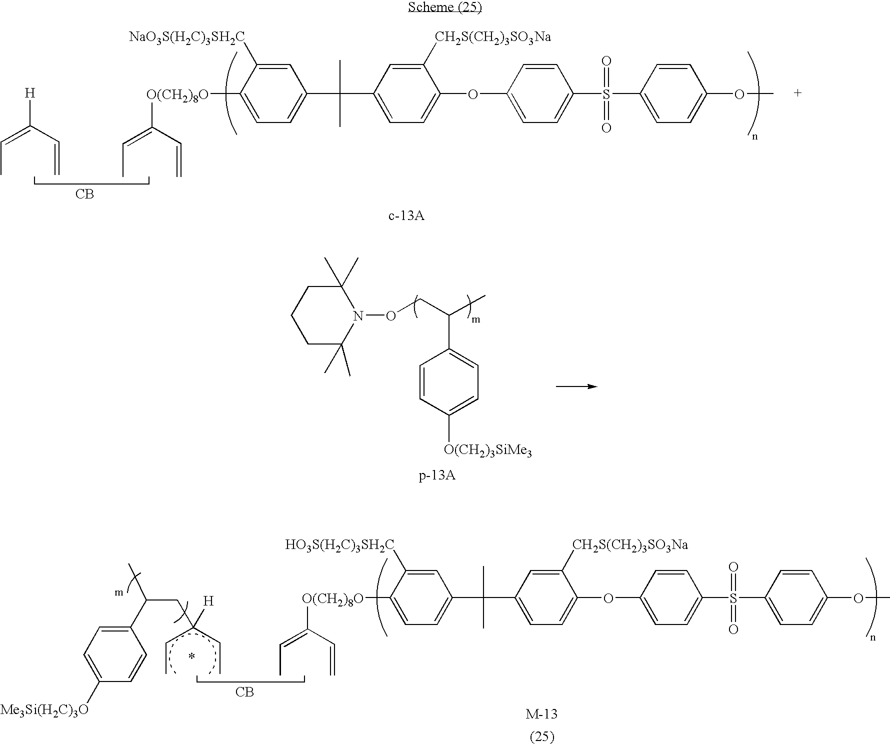

In the scheme, m is a number of repetitive units of hydrophobic segments and n is a number of repetitive units of hydrophilic segments.

[Manufacture of Catalyst Material M-14 for use in Fuel Cell]

(Introduction of Hydrophilic Segment to the Surface of Carbon Material)

As a carbon material, a carbon black (trade name of product: carbon ECP, manufactured by Ketchen Black International Co.) (d) was used, to obtain a carbon material c-14A introduced with bromopentyl groups in the same manner as in the scheme (1). From the result of elemental analysis, 0.4 mmol of bromopentyl groups were introduced per 1 g of the carbon material c-14A.

Then, 2.5 g of c-14A, 3.8 g of sodium sulfite, and 40 mL of water were added and refluxed for 10 hours under a nitrogen gas stream. After the reaction, the product was separated by filtration, washed with water, and then dried under a reduced pressure to obtain 2.4 g of a carbon material c-14B introduced with sulfopentyl groups. As the result of elemental analysis, 0.2 mmol of sulfopentyl groups were introduced per 1 g of the carbon material c-14B.

(Introduction of Hydrophobic Segment to Carbon Surface)

The reaction was conducted in accordance with the scheme (26). That is, 40 mL of aqueous 2M hydrochloric acid solution, and 860 mg of sodium nitrite were added to 2.0 g of 4-trifluoromethylaniline and stirred al 0° C. for one hour under a nitrogen gas stream. Then, 2.0 g of a carbon material c-14B was added and stirred at 60° C. for 2 hours under a nitrogen gas stream. After the reaction, the product was separated by filtration, washed with water and dried under a reduced pressure to obtain 1.7 g of carbon material c-14C introduced with 4-trifluoromethylphenyl group (hydrophobic segment). As the result of elemental analysis, 0.4 mmol of 4-trifluoromethyl phenyl groups were introduced per 1 g of the carbon material c-14C.

Then, the carbon material c-14C was immersed in an aqueous solution of hexamine platinum (IV) chloride at a room temperature for one hour and, after washing and drying, reduced in a hydrogen gas stream at 180° C. to obtain 3.0 g of a catalyst material M-14 for use in the fuel cell. 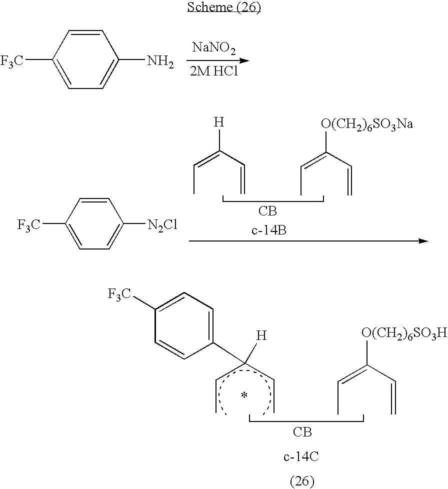
[Manufacture of Catalyst Material M-15 for use in Fuel Cell]

It was conducted by using a carbon black (trade name of product: Carbon ECP, manufactured by Ketchen Black International Co.) (d) in accordance with the scheme (27), That is, 50 mL of an aqueous 2M hydrochloric acid solution and 1.2 g of sodium nitrite were added to 2.0 g of 4-sulfopropyloxyaniline and 1.4 g of 4-trifluoromethyl aniline and stirred at 0° C. for 1.5 hours under a nitrogen gas stream. Then, 2.0 g of a carbon black (d) was added and stirred at 60° C. for 2 hours under a nitrogen gas stream. After the reaction, the product was separated by filtration, washed with water and dried under a reduced pressure to obtain 1.7 g of a carbon material c-15A introduced with a 4-sulfopropyl oxyphenyl group (hydrophilic segment) and a 4-trifluoromethyl phenyl groups (hydrophobic segment). As the result of elemental analysis, 0.3 mmol of 4-sulfopropyl oxyphenyl group and 0.2 mmol of 4-trifluoromethyl phenyl group were introduced per 1 g of the carbon material c-15A.

Then, the carbon material c-15A was immersed in an aqueous solution of hexamine platinum (IV) chloride at a room temperature for one hour, washed and dried and then reduced at 180° C. in a hydrogen gas stream to obtain 3.1 g of a catalyst material M-15 for use in the fuel cell. 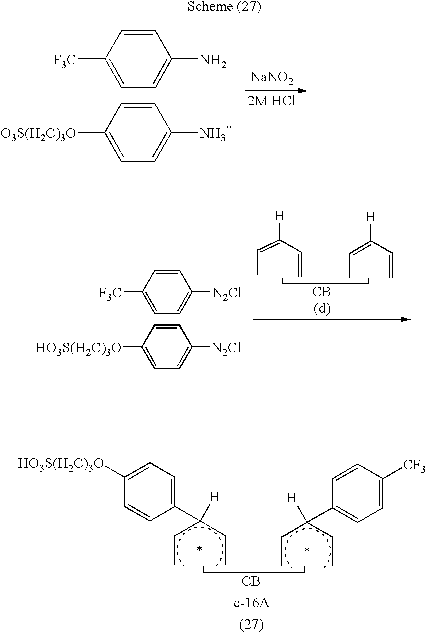
[Manufacture of Catalyst Material M-16 for use in Fuel Cell]

It was conducted by using a carbon black (trade name of product: Carbon ECP, manufactured by Ketchen Black International Co.) (d) in accordance with the scheme (28). That is, 4.0 g of potassium carbonate, 2.0 g of 1-iodo-1H,1H,2H,2H-nonafluorohexane, 50 mL of N-methyl-2-pyrrolidone were added to 3.0 g of the carbon black (d) and reacted at 110° C. for 5 hours under a nitrogen stream. After the reaction, the product was separated by filtration, washed with water and dichloromethane and dried under a reduced pressure to obtain 2.9 g of a carbon material c-26A introduced with 1H,1H,2H,2H-nonafluoronexyl groups (hydrophobic segment) From the result of elemental analysis, 0.1 mmol of 1H,1H,2H,2H-nonalfuorohexyl groups were introduced per 1 g of the carbon material c-16A.

Then, 40 mL of an aqueous 2M hydrochloric acid solution and 750 mg of sodium nitrite were added to 2.5 g of 4-sulfopropyloxyaniline, and stirred at 0° C. for 1.5 hours under a nitrogen gas stream. Then, 2.0 g of the carbon material c-16A was added and stirred at 60° C. for 2 hours under a nitrogen gas stream. After the reaction, the product was separated by filtration, washed with water and dried under a reduced pressure to obtain 1.8 g of a carbon material c-16B introduced with 4-sulfopropyloxyphenyl groups (hydrophilic segments). As the result of elemental analysis, 0.4 mmol of 4-sulfopropyl phenol groups were introduced per one g of the carbon material c-16B.

Then, the carbon material c-16B was immersed in an aqueous solution of hexamine platinum (IV) chloride at a room temperature for one hour, washed and dried and then reduced at 180° C. in a hydrogen gas stream to obtain 3.4 g of a catalyst material M-14 for use in the fuel cell. 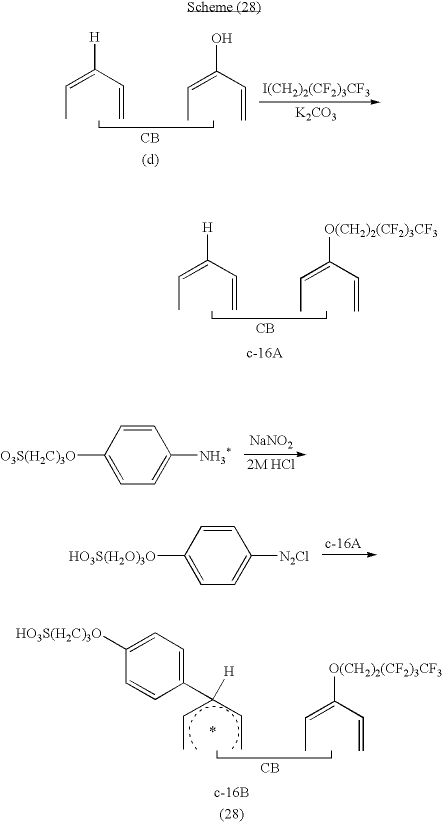
[Manufacture of Catalyst Material M-17 for use in the Fuel Cell]
(Introduction of Hydrophilic Segment to Surface of the Carbon Material)

As a carbon material, a carbon black (trade name of product: carbon ECP, manufactured by Ketchen Black International Co.) (d) was used, to obtain a carbon material c-17A introduced with sulfopentyl groups in the same manner as the manufacturing method for the catalyst material M-14 for use in the fuel cell. From the result of elemental analysis, 0.2 mmol of sulfopentyl groups were introduced per 1 g of the carbon material c-17A.

(Introduction of Hydrophobic Segment to Carbon Surface)

Reaction was conducted in accordance with the scheme (29). That is, 2.0 g of nonafluoro-n-butyl iodide, 580 mg of copper chloride (I), 1.8 g of 2,2′-bipyridine, and 30 ml of N-methyl-2-pyrrolidone were added to 2.0 g of the carbon material c-17A, and stirred in an oil bath at 120° C. for 18 hours under a nitrogen atmosphere. After the reaction, the product was separated by filtration, washed with N-methyl-2-pyrrolidone and water and then dried under a reduced pressure to obtain 1.9 g of a carbon material c-17B introduced with nonafluorobutyl groups (hydrophobic segment). As the result of elemental analysis, 0.2 mmol of nonafluorobutyl groups were introduced per 1 g of the carbon material c-17B.

Then, after immersing the carbon material c-17B into an aqueous 1N sulfuric acid solution at a room temperature for 30 min, the product was washed with water and dried under a reduced pressure. Then, it was immersed in an aqueous solution of hexamine platinum (IV) chloride at a room temperature for one hour and, after washing and drying, reduced at 180° C. in a hydrogen gas stream to obtain 3.4 g of a catalyst material M-17 for use in the fuel cell. 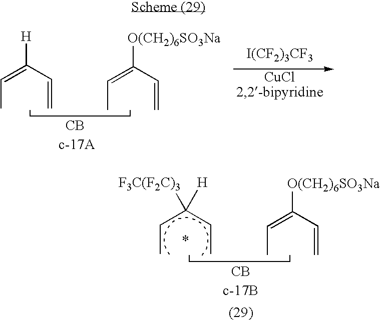
[Manufacture of Catalyst Material M-18 for use in Fuel Cell]

Carbon material M-10 and a commercially available platinum supporting carbon black (trade name product: TEC10E50E, manufactured by Tanaka Kikinzoku Co.) were mixed at a ratio of 80 wt %: 20 wt %, to obtain catalyst material M-18 for use in the fuel cell.

[Manufacture of Catalyst Material M-19 for use in the Fuel Cell]

A catalyst material M-10 for use in the fuel cell and a commercially available platinum supporting carbon black (trade name of product: TEC10E50E, manufactured by Tanaka Kikinzoku Co.) were mixed at a ratio of 90 wt %: 10 wt %, to obtain a catalyst material M-19 for use in the fuel cell.

IR Absorption Spectroscopy

For each of the catalyst materials for use in the fuel cell obtained in the steps described above, IR absorption spectroscopy was conducted and, since absorption was present near 1150 cm⁻¹ for each of the catalyst materials for use in the fuel cells, it was confirmed that each of the catalyst materials for use in the fuel cells had a sulfonic acid group.

### Comparative Example 1

Manufacture of Catalyst Material for use in Fuel Cell introduced with Ionic Functional Group-Containing Polymer

[Manufacture of Catalyst Material R-1 for use in Fuel Cell]

Reaction was conducted in accordance with scheme (30) using a platinum supporting carbon black (trade name of products: TEC10E50E, manufactured by Tanaka Kikinzoku Co.) as a catalyst supporting carbon material. That is, TEC10E50E, an aqueous solution for formaldehyde, and sodium hydroxide were added each in a predetermined amount and stirred at 70° C. for 24 hours. After the reaction, the product was separated by filtration and dried under a reduced pressure to obtain a carbon black r-1 introduced with methylol groups. Then, r-1, acrylamide-tert-butyl sulfonic acid, and ammonium cerium nitrate (IV) each in a predetermined amount were added and reacted at 30° C. for 24 hours under a nitrogen gas stream. After the reaction, the product was washed with water and then with methanol and dried under a reduced pressure to obtain a catalyst material R-1 for use in the fuel cell.

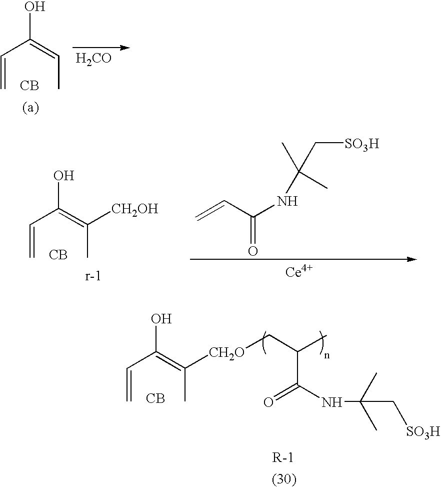

### Example 2

Manufacture of Fuel Cell

[Manufacturing Method 1]

A fuel cell was manufactured by using the catalyst material for use in the fuel cell in Example 1. 2 g of each catalyst material for use in the fuel cell, 15 g of a Nafion solution as a binder (5% aqueous alcohol solution) were mixed and dispersed by a supersonic dispersing device for 30 min. The obtained dispersion was coated on carbon paper (350 μm thickness), dried and then punched into a circular shape of 9 mm diameter to manufacture a catalyst membrane.

A Nafion 117 membrane was used as the solid electrolyte membrane and the catalyst membrane obtained as described above was bonded on both surfaces of the Nafion membrane 117 such that the coating surface was in contact with the Nafion membrane 117 and hot press bonded by hot press to manufacture an MEA.

[Manufacturing Method 2]

An MEA was manufactured in the same manner as in the preparation method 1 except for manufacturing the solid electrolyte and the binder with polymer E-1 consist of the following repetitive units.
Polymer E-1 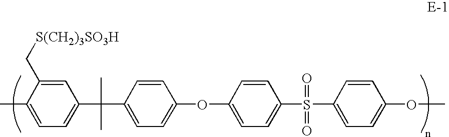
(the weight average molecular weight of the polymer E-1 when used as the binder was from 30,000 to 100,000 and the weight average molecular weight when used as the solid electrolyte membrane was from 100,000 to 300,000).

### Example 3

Evaluation for Fuel Cell

The MEA obtained in Example 2 was set to a fuel cell shown in FIG. 2, and a hydrogen gas was caused to flow in anode side openings 15. In this case, an atmospheric air was caused to flow to cathode side openings 16. A potentiostat was connected between the anode electrode 12 and the cathode electrode 13 to record a current value at 400 mV. The result is shown in Table 1.

TABLE 1

| Catalyst | Binder - solid | | |
|---|---|---|---|
| supporting | electrolyte | Current value | |
| carbon | membrane | (A/cm²) | Remarks |
| M-1 | E-1 | 2.43 | Invention |
| M-2 | E-1 | 2.26 | Invention |
| M-3 | E-1 | 2.33 | Invention |
| M-4 | E-1 | 2.53 | Invention |
| M-5 | E-1 | 2.21 | Invention |
| M-6 | Nafion 117 | 2.19 | Invention |
| M-7 | Nafion 117 | 2.36 | Invention |
| M-8 | E-1 | 2.28 | Invention |
| M-9 | E-1 | 2.33 | Invention |
| M-10 | Nafion 117 | 2.21 | Invention |
| M-11 | E-1 | 2.18 | Invention |
| M-12 | E-1 | 2.46 | Invention |
| M-13 | E-1 | 2.29 | Invention |
| M-14 | Nafion 117 | 2.11 | Invention |
| M-15 | Nafion 117 | 2.27 | Invention |
| M-16 | Nafion 117 | 2.01 | Invention |
| M-17 | Nafion 117 | 2.23 | Invention |
| M-18 | Nafion 117 | 2.23 | Invention |
| M-19 | Nafion 117 | 2.16 | Invention |
| R-1 | Nafion 117 | 1.68 | Comparative |
| | | | Example |

It is recognized that the catalyst material for use in the fuel cell of the invention has durability also under strongly acidic and high temperature conditions assumed in the starting of a fuel cell and maintains high power also in a high current density region. Such a carbon material can be utilized preferably, for example, as a catalyst supporting material for use in fuel cells. Particularly, it has been recognized that use of those materials comprising the main chain identical with the polymer main chain of the invention for the solid electrolyte as the binder is more effective.

While the present invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 084041/2006 filed on Mar. 24, 2006, which is expressly incorporated herein by reference in its entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A catalyst material for use in a fuel cell comprising;
a carbon material, and
one or more hydrophilic segments and one or more hydrophobic segments jointly or separately connected to the surface of the carbon material by a single bond or a connection group having a solvolysis resistance and a heat resistance, wherein:
the hydrophilic segment has the solvolysis resistance and the heat resistance and has an ionic functional group, and
the hydrophobic segment has the solvolysis resistance and the heat resistance and has no ionic functional group.

2. The catalyst material for use in a fuel cell according to claim 1, wherein the hydrophilic segment comprises one or more structures represented by the following formula (1), formula (6) or formula (10), and the hydrophobic segment comprises one or more structures represented by the following formula (2), formula (7) or formula (11): 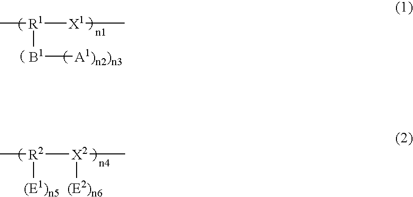
in which R¹ and R² each represents a group comprising an aromatic ring, X¹ and X² each represents a single bond or a bivalent connection group, B¹ represents a single bond or a bivalent to hexavalent connection group, A¹ represents an ionic functional group, E¹ and E² each represents a substituent of high oxygen permeability, n1 and n4 each represents an integer of 8 or greater, n2 represents an integer of from 1 to 5, n3, n5 and n6 each represents an integer of from 0 to 4, 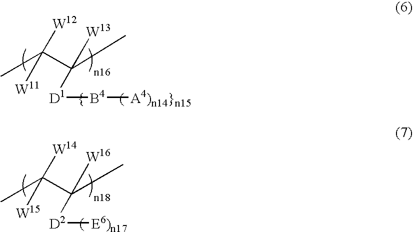
in which W¹¹, W¹², W¹³, W¹⁴, W¹⁵, and W¹⁶ each represents a hydrogen atom, halogen atom, alkyl group, aryl group, or heterocyclic ring, D¹ and D² each represents a single bond or a group comprising a substituted or not-substituted aromatic ring, B⁴ represents a single bond or a bivalent to hexavalent: connection group, A⁴ represents an ionic functional group. E⁶ each represents a substituent of high oxygen permeability, n16 and n18 each represents an integer of 2 or greater, and n14, n15, and n17 each represents an integer of from 1 to 5, 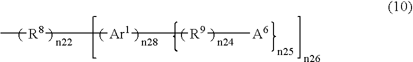
in which R⁸ and R⁹ each represents a bivalent to tetravalent connection group, Ar¹ represents a bivalent to hexavalent connection group comprising an aromatic hydrocarbon group or a heterocyclic group, A⁶ represents an ionic functional group, n22, n23, and n24 each represents an integer of 0 or greater, the sum for n22, n23, and n24 represents an integer of 1 or greater, n25 is an integer of from 1 to 10 and n26 represents an integer of from 1 to 3 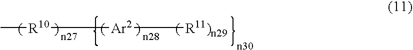
in which R¹⁰ each represents a bivalent to tetravalent connection group, R¹¹ represents a monovalent group not comprising an aromatic ring, Ar² represents a bivalent to hexavalent connection group comprising an aromatic hydrocarbon group or heterocyclic group, n27 and n28 each represents an integer of 0 or greater, n29 represents an integer of 1 or greater, and n30 represents an integer of from 1 to 3.

3. The catalyst material for use in a fuel cell according to claim 1, wherein the carbon material is a carbon black or carbon nanotube.

4. The catalyst material for use in a fuel cell according to claim 1, wherein the hydrophilic segment and the hydrophobic segment are connected by way of an identical connection group.

5. The catalyst material for use in a fuel cell according to claim 1, wherein the hydrophilic segment and hydrophobic segment form an alternately repeating block copolymer that is connected to the surface of the carbon material.

6. The catalyst material for use in a fuel cell according to claim 4, wherein the hydrophilic segment comprises a structure represented by the following formula (1) and the hydrophobic segment comprises a structure represented by the following formula (2): 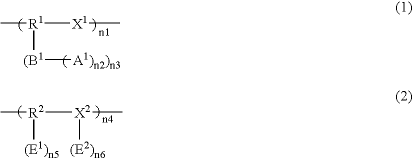
in which R¹ and R²each represents a group comprising an aromatic ring, X¹ and X² each represents a single bond or a bivalent connection group, B¹ represents a single bond or a bivalent to hexavalent connection group, A¹ represents an ionic functional group, E¹ and E² each represents a substituent of high oxygen permeability, n1 and n4 each represents an integer of 8 or greater, n2 represents an integer of from 1 to 5, n3, n5 and n6 each represents an integer of from 0 to 4.

7. A method of manufacturing a catalyst material for use in a fuel cell of claim 6, comprising forming the main chain structure represented by —(R¹—X¹)ₙ₁— and then bonding the group represented by —B¹-(A¹)ₙ₂ to the main chain structure, and forming the main chain structure represented by —(R²—X²)ₙ₄— and then bonding the group represented by -E¹ and/or -E² to the main chain structure.

8. A method of manufacturing a catalyst material for use in a fuel cell of claim 6, comprising polymerizing a compound represented by the formula (3) and a compound represented by the formula (4), and polymerizing the compound represented by the formula (4) and the compound represented by the formula (5): 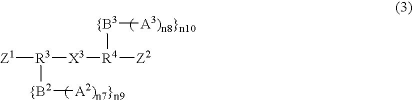
in which X³ represents a single bond or a bivalent connection group, R³ and R⁴ each represents a group comprising an aromatic ring, B² and B³ each represents a single bond or a bivalent to hexavalent connection group, A² and A³ each represents an ionic functional group, n7 and n6 each represents an integer of from 1 to 5, n9 and n10 each represents an integer of from 0 to 4, the sum for n9 and n10 is 2 or greater, Z¹ and Z² each represents a hydroxyl group, halogen group, alkyl sulfonate group, or nitro group,
Z³-R⁵-Z⁴ (4)
in which Z³ and Z⁴ each represents a hydroxyl group, halogen group, alkyl sulfonate group, or nitro group, and R⁵ represents a group comprising an aromatic ring, 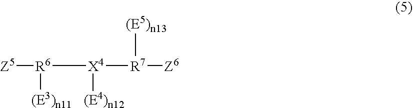
in which X⁴ represents a single bond or bivalent connection group, R⁶ and R⁷ each represents a group comprising an aromatic ring, E³, E⁴, and E⁵ each represents a substituent of high oxygen permeability, n11, n12, and n13 each represents an integer of from 0 to 4, the sum for n11, n12, and n13 is 1 or greater, Z⁵ and Z⁶ each represents a hydroxyl group, halogen group, alkyl sulfonate group, or nitro group.

9. The catalyst material for use in a fuel cell according to claim 4, wherein the hydrophilic segment comprises a structure represented by the following formula (6) and the hydrophobic segment comprises a structure represented by the following formula (7): 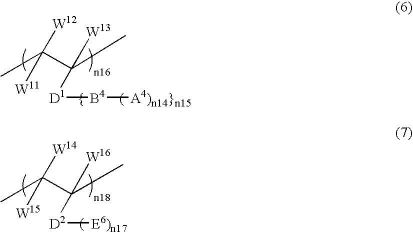
in which W¹¹, w¹², W¹³, W¹⁴, W¹⁵, and W¹⁶ each represents a hydrogen atom, halogen atom, alkyl group, aryl group, or heterocyclic ring. D¹ and D² each represents a single bond or a group comprising a substituted or not-substituted aromatic ring, B⁴ represents a single bond or a bivalent to hexavalent connection group, A⁴ represents an ionic functional group. E⁶ each represents a substituent of high oxygen permeability, n16 and n18 each represents an integer of 2 or greater, and n14, n15, and n17 each represents an integer of from 1 to 5.

10. A method of manufacturing a catalyst material for use in a fuel cell of claim 9, comprising polymerizing the compound represented by the following formula (8) and polymerizing a compound represented by the following formula (9): 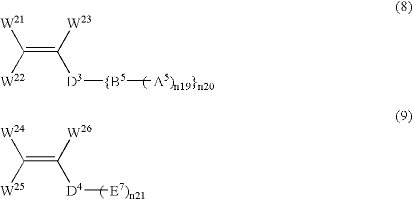
in which w²¹, w²², w²³ w²⁴, w²⁵, and w²⁶ each represents a hydrogen atom, halogen atom, alkyl group, aryl group, or heterocyclic ring. D³ and D⁴ each represents a single bond or a group comprising a substituted or not-substituted aromatic ring, B⁵ represents a single bond or a bivalent to hexavalent connection group, A⁵ represents an ionic functional group or an ionic functional group precursor, E⁷ represents a substituent of high oxygen permeability. n19, n20, and n21 each represents an integer of from 1 to 5.

11. The catalyst material for use in a fuel cell according to claim 4, wherein a side chain comprising a hydrophilic segment is grafted on a main chain comprising a hydrophobic segment.

12. The catalyst material for use in a fuel cell according to claim 11, wherein the hydrophobic segment comprises a structure represented by the following formula (2) and the hydrophilic segment comprises a structure represented by the following formula (6): 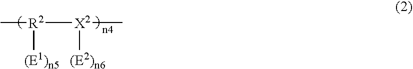
in which R² represents a group comprising an aromatic ring, X² represents a single bond or a bivalent connection group, E¹ and E² each represents a substituent of high oxygen permeability. n4 represents an integer of 8 or greater, and n5 and n6 each represents an integer of from 0 to 4, 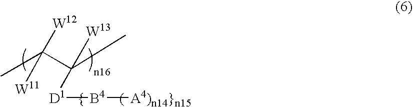
in which W¹¹, W₁₂, and W¹³ each represents a hydrogen atom, halogen atom, alkyl group, aryl group or heterocyclic ring, D¹ represents a single bond or a group comprising a substituted or not-substituted aromatic ring, B⁴ represents a single bond or a bivalent to hexavalent connection group, A⁴ represents an ionic functional group, n16 represents an integer of 2 or greater, and n14 and n15 each represents an integer of from 1 to 5.

13. A method of manufacturing a catalyst material for use in a fuel cell of claim 12, comprising chloromethylating the aromatic ring possessed by the main chain structure represented by —(R²—X² )₄— in the formula (2), and graft polymerizing at least the compound represented by the following formula (8) with the chloromethylated portion being as a polymerization initiation point: 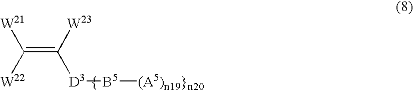
in which W²¹, W²², and W²³ each represents a hydrogen atom, halogen atom, alkyl group, aryl group, or a heterocyclic ring, D³ represents a single bond or a group comprising a substituted or not-substituted aromatic ring, B⁵ represents a single bond or a bivalent or hexavalent connection group, A⁵ represents an ionic functional group or an ionic functional group precursor, and n19 and n20 each represents an integer of 1 to 5.

14. The catalyst material for use in a fuel cell according to claim 4, wherein a side chain comprising a hydrophobic segment is grafted on a main chain comprising a hydrophilic segment.

15. The catalyst material for use in a fuel cell according to claim 14, wherein the hydrophilic segment comprises a structure represented by the following formula (1) and the hydrophobic segment comprises a structure represented by the following formula (7): 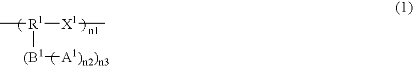
in which R¹ represents a group comprising an aromatic ring, X¹ represents a single bond or a bivalent connection group, B¹ represents a single bond or a bivalent to hexavalent connection group, A¹ represents an ionic functional group, n1 represents an integer of 8 or greater, n2 represents an integer of from 1 to 5, and n3 represents an integer of from 0 to 4, 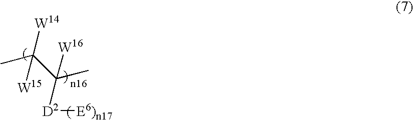
in which W¹⁴, W¹⁵, and W¹⁶ each represents a hydrogen atom, halogen atom, alkyl group, aryl group, or a heterocyclic ring. D² represents a single bond or a group comprising a substituted or not-substituted aromatic ring. E⁶ each represents a substituent of high oxygen permeability, n18 represents an integer of 2 or greater, and n17 represents an integer of from 1 to 5.

16. The method of manufacturing a catalyst material for use in a fuel cell according to claim 15, comprising chloromethylating the aromatic ring possessed by the main chain structure represented by —(R¹—X¹)ₙ₁— in the formula (1), and graft polymerizing at least the compound represented by the following formula (9) with the chloromethylated portion being as a polymerization initiation point: 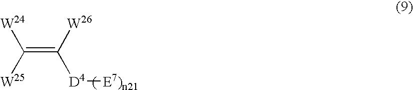
in which W²⁴, W²⁵, and W²⁶ each represents a hydrogen atom, halogen atom, alkyl group, aryl group, or a heterocyclic ring, D⁴ represents a single bond or a group comprising a substituted or not-substituted aromatic ring, E⁷ represents a substituent of high oxygen permeability and n21 represents an integer of from 1 to 5.

17. The catalyst material for use in a fuel cell of claim 1, wherein the hydrophilic segment and the hydrophobic segment are connected respectively by way of different connection groups to the surface of the carbon material.

18. A catalyst membrane comprising a catalyst material for use in a fuel cell of claim 1, and a solid electrolyte.

19. The catalyst membrane according to claim 18, further comprising a catalyst material for use in a fuel cell having neither the hydrophilic segment nor the hydrophobic segment on the carbon surface.

20. A membrane electrode assembly comprising a porous conductive sheet and a catalyst layer disposed in contact with the porous conductive sheet wherein the catalyst layer is a catalyst membrane of claim 18.

21. A fuel cell comprising the membrane electrode assembly of claim 20.
